(19) United States
(12) Patent Application Publication
(10) Pub. No.: US 2023/0282867 A1
(43) Pub. Date: Sep. 7, 2023

(54) ELECTROCHEMICAL SYSTEM AND METHOD OF INSTALLING SAME USING A SKID

(71) Applicant: BLOOM ENERGY CORPORATION, San Jose, CA (US)

(72) Inventors: Chad PEARSON, Kirkland, WA (US); Joseph TAVI, Danville, CA (US); Rueben KEMPTON, San Jose, CA (US); Charles F. WALTON, JR., Springfield, PA (US); Matthew MAHONEY, Newark, DE (US); Nicholas VINCENT, San Jose, CA (US); Jordan LARUE, Danville, CA (US); William KENNY, Sicklerville, NJ (US); Katherine FELDT, Grand Rapids, MI (US); Gururaj B. RAO, Bangalore (IN); Supreetha NLN, Bangalore (IN)

(21) Appl. No.: 18/146,238

(22) Filed: Dec. 23, 2022

Related U.S. Application Data
(63) Continuation-in-part of application No. PCT/US2022/049811, filed on Nov. 14, 2022.
(60) Provisional application No. 63/363,201, filed on Apr. 19, 2022.
(60) Provisional application No. 63/278,778, filed on Nov. 12, 2021.

(30) Foreign Application Priority Data
Nov. 12, 2022 (IN) 202244064950

(51) Int. Cl. H01M 8/249; H01M 8/04858; H01M 8/04089; H01M 8/04082; H01M 8/04828; H02J 3/38

(52) U.S. Cl. CPC H01M 8/249; H01M 8/04089; H01M 8/04201; H01M 8/04835; H01M 8/0494; H02J 3/381; H01M 2250/10; H02J 2300/30

(57) ABSTRACT

An electrochemical system includes fuel cell or electrolyzer modules, and a skid supporting the modules.

### FIELD

The present disclosure is directed generally to electrochemical systems, such as fuel cell systems and electrolyzer systems, and methods of installing thereof, using a skid.

### BACKGROUND

Rapid and inexpensive installation can help to increase the prevalence of electrochemical systems, such as fuel cell systems and electrolyzer systems. Installation costs for pour in place custom designed concrete pads, which generally require trenching for plumbing and electrical lines, can become prohibitive. Installation time is also a problem in the case of most sites since concrete pours and trenches generally require one or more building permits and building inspector reviews.

Furthermore, stationary fuel cell and/or electrolyzer systems may be installed in location where the cost of real estate is quite high or the available space is limited (e.g., a loading dock, a narrow alley or space between buildings, etc.). The system installation should have a high utilization of available space. When a considerable amount of stand-off space is required for access to the system via doors and the like, installation real estate costs increase significantly.

When the number of fuel cell and/or electrolyzer systems to be installed on a site increases, one problem which generally arises is that stand-off space between these systems is required (to allow for maintenance of one unit or the other unit). The space between systems is lost in terms of its potential to be used by the customer of the fuel cell system.

In the case of some fuel cell and/or electrolyzer system designs, these problems are resolved by increasing the overall capacity of the monolithic system design. However, this creates new challenges as the size and weight of the concrete pad required increases. Therefore, this strategy tends to increase the system installation time. Furthermore, as the minimum size of the system increases, the fault tolerance of the design is reduced.

The fuel cell and/or electrolyzer stacks or columns of these systems are usually located in hot boxes (i.e., thermally insulated containers). The hot boxes of existing large stationary fuel cell systems are housed in cabinets, housings or enclosures. The terms cabinet, enclosure, and housing are used interchangeably herein. The cabinets are usually made from metal. The metal is painted with either automotive or industrial powder coat paint, which is susceptible to scratching, denting and corrosion. Most of these cabinets are similar to current industrial HVAC equipment cabinets.

### SUMMARY

In one embodiment, an electrochemical system, such as a fuel cell power system or an electrolyzer hydrogen generation system, includes a skid including a deck and at least one pedestal connected to and supporting the deck, and a plurality of modules comprising at least one electrochemical module located on the deck of the skid.

In another embodiment, a method of installing an electrochemical system includes providing a plurality of modules comprising at least one electrochemical module on a skid, transporting the skid with the plurality of modules disposed thereon to an installation site, and providing at least one utility hook-up to the electrochemical system at the installation site.

In another embodiment, a docking station for a skid-mounted electrochemical system includes a housing containing at least one utility stub within an interior of the housing, and at least one opening in a surface of the housing through which at least one utility connection between the at least one utility stub and a skid-mounted electrochemical system may be made.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of a modular fuel cell system according to various embodiments of the present disclosure.

FIG. 2 illustrates top plan view of a modular fuel cell system according to various embodiments of the present disclosure.

FIGS. 3A, 3B, and 3C illustrate top and perspective views of a pad of the fuel cell system of FIG. 2.

FIG. 3D illustrates a perspective view of a modified version of a pad of the fuel cell system of FIG. 2.

FIG. 4A illustrates a perspective view of a modular fuel cell system according to various embodiments of the present disclosure.

FIG. 4B illustrates top plan view of the system of FIG. 4A.

FIG. 4C illustrates a schematic view of a pad of the fuel cell system of FIG. 4A.

FIG. 5A illustrates a top plan view of a modular fuel cell system according to various embodiments of the present disclosure.

FIG. 5B illustrates a schematic view of a pad of the fuel cell system of FIG. 5A.

FIG. 5C illustrates a top plan view of a modular fuel cell system according to various embodiments of the present disclosure.

FIG. 5D illustrates a schematic view of a pad of the fuel cell system FIG. 5C.

FIG. 6A illustrates a top plan view of a modular fuel cell system according to various embodiments of the present disclosure.

FIG. 6B illustrates a schematic view of a pad of the fuel cell system of FIG. 6A.

FIG. 7A illustrates a top plan view of a modular fuel cell system according to various embodiments of the present disclosure.

FIG. 7B illustrates a schematic view of a pad of the fuel cell system of FIG. 7A.

FIG. 8 illustrates a perspective view of modular pad section according to various embodiments of the present disclosure.

FIGS. 9A and 9B illustrate perspective views of a modular pad according to various embodiments of the present disclosure.

FIG. 10 illustrates a perspective view of a modular pad according to various embodiments of the present disclosure.

FIG. 11 illustrates a modular pad according to various embodiments of the present disclosure.

FIG. 12 illustrates a modular pad according to various embodiments of the present disclosure.

FIGS. 13A and 13B illustrate perspective views of a pad according to various embodiments of the present disclosure.

FIG. 14 is a perspective view of a modular pad of a fuel cell system, according to various embodiments of the present disclosure.

FIG. 15 is a perspective view of a modular pad of a fuel cell system, according to various embodiments of the present disclosure.

FIG. 16 is a perspective view of a modular pad of a fuel cell system, according to various embodiments of the present disclosure.

FIG. 17 is a perspective view of a pad section of a fuel cell system, according to various embodiments of the present disclosure.

FIG. 18A is a perspective view of a support frame of a fuel cell system, and FIG. 18B illustrates a module on the support frame of FIG. 18A.

FIGS. 19A1-A3 and 19B1-B3 illustrate a top view of a large site fuel cell system with pre-cast concrete trenches before and after they are filled with the plumbing and the wiring, respectively, according to embodiments of the present disclosure.

FIGS. 19C and 19D are perspective views of the large site fuel cell system of FIGS. 19A1-A3.

FIG. 19E is a schematic side view of components of a gas and water distribution module of FIG. 19C.

FIG. 19F is a side cross-sectional view of a pad for a module of the large site fuel cell system of FIG. 19D.

FIGS. 19G and 19H schematically illustrate a central desulfurization system.

FIG. 19I is a perspective partially-transparent view of a gas and water distribution module.

FIGS. 19J1-J2 illustrate a flow diagram for a central desulfurization system.

FIGS. 20A to 20E are perspective views of steps in a method of installing the large site fuel cell system of FIGS. 19A1-A3 and 19J1-J2.

FIG. 21 is a schematic top view of a subsystem according to an embodiment.

FIG. 22 is a circuit schematic of electrical components of the subsystem of FIG. 21.

FIG. 23 is a circuit schematic of electrical components according to an embodiment of the present disclosure.

FIGS. 24 and 25 are photographs of concrete curbs and raceways that may be used during the installation of the system of embodiments of the present disclosure.

FIG. 26A is a perspective view showing a fuel cell power system including a plurality of modules located on a skid according to an embodiment of the present disclosure.

FIG. 26B is a photograph of a lift hook attached to a support pedestal of a skid according to an embodiment of the present disclosure.

FIG. 26C is a photograph showing a fuel cell power system being lifted by a crane via lift hooks according to an embodiment of the present disclosure.

FIG. 26D is a photograph showing a fuel (i.e., gas) connection to a skid according to an embodiment of the present disclosure.

FIG. 26E is a photograph showing a water connection to a skid according to an embodiment of the present disclosure.

FIG. 26F a photograph showing electrical cables exiting a skid according to an embodiment of the present disclosure.

FIGS. 27A, 27B and 27C are side, rear, and top views, respectively, of a skid-mounted fuel cell power system according to an embodiment of the present disclosure.

FIG. 28 illustrates a fuel cell power system that includes fuel cell power generation components on a pair of skids located adjacent to one another according to an embodiment of the present disclosure.

FIG. 29 illustrates a skid having six power modules, a fuel processing module, a power conditioning module, and a step load module disposed on the skid according to an embodiment of the present disclosure.

FIG. 30 illustrates a skid having six power modules, a fuel processing module, a power conditioning module, a step load module and a microgrid inverter module disposed on the skid according to an embodiment of the present disclosure.

FIGS. 31A and 31B illustrate a skid mounted to a ground surface using L-brackets according to embodiments of the present disclosure.

FIG. 31C is a perspective view of a skid and an L-bracket according to embodiments of the present disclosure.

FIG. 32A is a side view showing a Z-bracket clamped against a flange surface of a skid according to an embodiment of the present disclosure.

FIG. 32B is a top view of a skid illustrating a plurality of Z-brackets around the outer periphery of the skid according to an embodiment of the present disclosure.

FIG. 33A is a top schematic view of a fuel cell power system including a plurality of fuel cell modules located on respective skids with outriggers connected to and extending between the skids according to an embodiment of the present disclosure.

FIG. 33B is a photograph of an outrigger mounted to a skid according to an embodiment of the present disclosure.

FIGS. 34A and 34B are perspective views of a docking station for a skid-mounted fuel cell power system and/or electrolyzer system according to an embodiment of the present disclosure.

FIG. 34C is a perspective view of a docking station for a skid-mounted fuel cell power system and/or electrolyzer system according to another embodiment of the present disclosure.

FIG. 34D is a plan view of the interior of the housing of the docking station of FIG. 34C.

FIG. 35 is a schematic top view of a large site fuel cell system including rows of fuel cell power modules disposed on skids according to an embodiment of the present disclosure.

FIGS. 36A-B illustrate a fuel cell power system including a single block of rows of fuel cell power modules disposed on skids according to an embodiment of the present disclosure.

FIG. 37A illustrates a fuel cell power system including a primary block of rows of fuel cell power modules coupled to a system power distribution unit and an integrated microgrid system according to an embodiment of the present disclosure.

FIG. 37B illustrates another embodiment of a fuel cell power system including a primary block of rows of fuel cell power modules and an integrated microgrid system that includes alternative configuration of electronics modules in the system power distribution unit according to an embodiment of the present disclosure.

FIG. 38A is a photograph illustrating a portion of a fuel cell power system including a plurality of skids having fuel cell power modules located thereon and a cable tray extending between the skids according to an embodiment of the present disclosure.

FIG. 38B is a side elevation view of a cable tray abutting an end of a skid according to an embodiment of the present disclosure.

FIG. 38C is a top view of a cable tray abutting an end of a skid according to an embodiment of the present disclosure.

FIG. 38D is a side elevation view of a cable tray abutting a system power distribution unit of the fuel cell power system according to an embodiment of the present disclosure.

FIGS. 39A and 39B illustrate connections between underground gas and water utility lines and a skid of a fuel cell power system according to various embodiments of the present disclosure.

FIG. 40A-A2 are a top schematic view of a hydrogen generation system, and FIGS. 40B and 40C are top schematic views of a pair of adjacent rows of electrolyzer modules of an embodiment of the present disclosure.

### DETAILED DESCRIPTION

It is to be understood that both the foregoing general description and the following detailed description are exemplary and explanatory only, and are not restrictive of the invention as claimed.

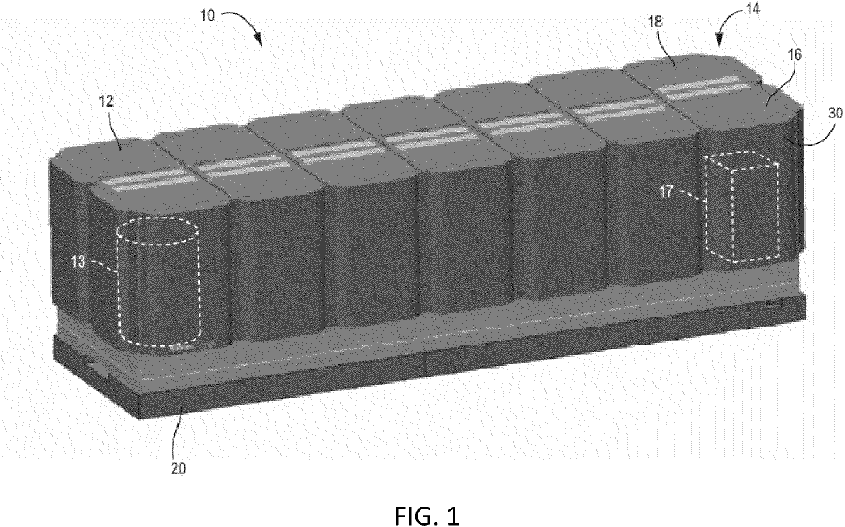

Referring to FIG. 1, a fuel cell system 10 is shown according to an exemplary embodiment. The fuel cell system 10 may have a modular system layout. The fuel cell system 10 may contain modules and components described in U.S. Pat. Application Serial Number 11/656,006, filed on Jan. 22, 2007, and U.S. Pat. Application Serial Number 14/208,190, filed on Mar. 13, 2014, which are incorporated herein by reference in their entireties. A modular design of the fuel cell system 10 may provide flexible system installation and operation. Modules allow scaling of installed generating capacity, reliable generation of power, flexibility of fuel processing, and flexibility of power output voltages and frequencies with a single design set. The modular design results in an “always on” unit with very high availability and reliability. This design also provides an easy means of scale up and meets specific requirements of customer’s installations. The modular design also allows the use of available fuels and required voltages and frequencies which may vary by customer and/or by geographic region. In other embodiments, the fuel cell system 10 may include a unitary system layout (also referred to as a “classic” system layout) rather than a modular system layout.

The modular fuel cell system 10 shown in FIG. 1 includes a housing 14 in which at least one (preferably more than one or plurality) of power modules 12, one or more fuel processing modules 16, and one or more power conditioning (i.e., electrical output) modules 18 are disposed. In embodiments, the power conditioning modules 18 are configured to deliver direct current (DC). In alternative embodiments, the power conditioning modules 18 are configured to deliver alternating current (AC). In these embodiments, the power conditioning modules 18 include a mechanism to convert DC to AC, such as an inverter. For example, the system 10 may include any desired number of modules, such as 2-30 power modules, for example 3-12 power modules, such as 6-12 modules.

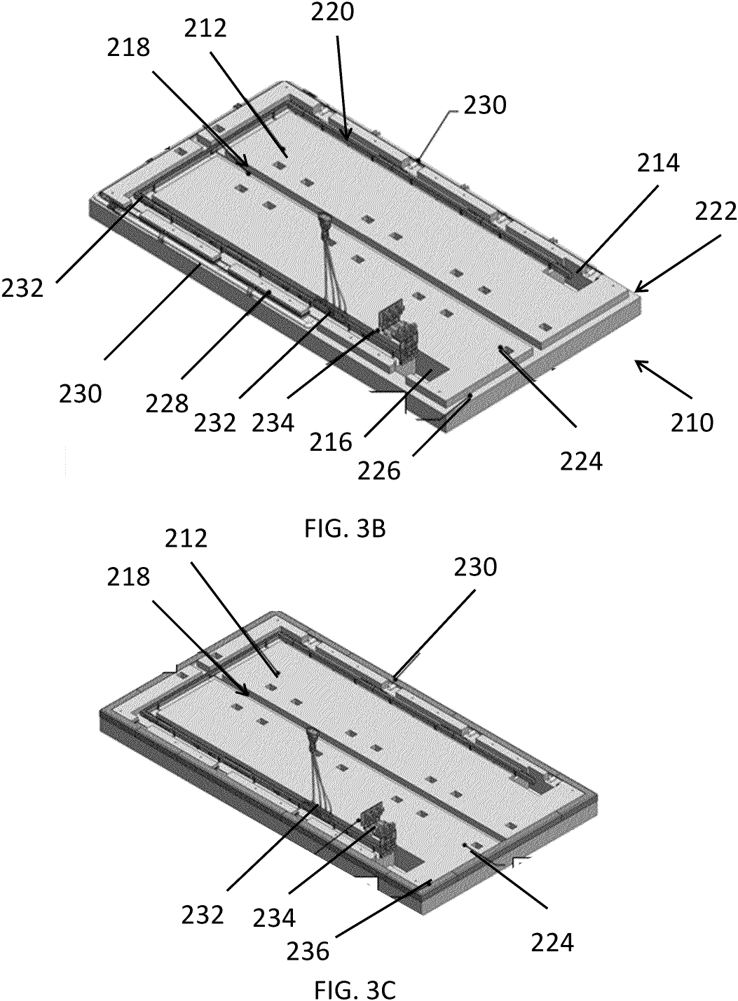

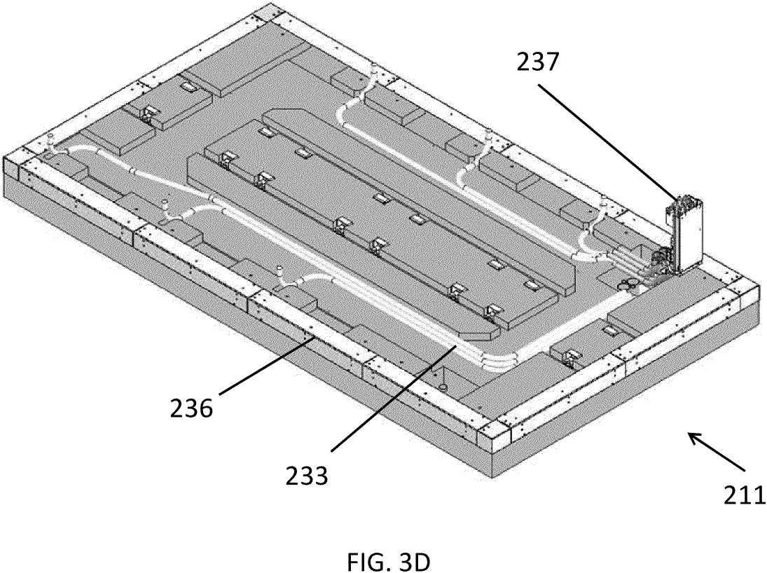

The system 10 of FIG. 1 includes six power modules 12 (one row of six modules stacked side to side), one fuel processing module 16, and one power conditioning module 18 on a pad 20. In some embodiments, the pad 20 may include a base 212 (shown in FIG. 3A) that is formed of a concrete or similar structural material that may be configured for permanent installation of the fuel cell system 10 at a site. In other embodiments described in further detail below, the power modules 12, fuel processing module 16 and power conditioning module 18 may be disposed on a skid having an upper surface (i.e., a deck) which rests upon pedestals (e.g., metal rails) that are connected to the deck. The skid may be configured to enable quick deployments and/or temporary deployments of the fuel cell system 10, and may reduce installation costs and cycle times.

The housing 14 may include a cabinet to house each module 12, 16, 18. Alternatively, as will be described in more detail below, modules 16 and 18 may be disposed in a single cabinet. While one row of power modules 12 is shown, the system may comprise more than one row of modules 12. For example, the system 10 may comprise two rows of power modules 18 arranged back to back/end to end.

Each power module 12 is configured to house one or more hot boxes 13. Each hot box contains one or more stacks or columns of fuel cells (not shown for clarity), such as one or more stacks or columns of solid oxide fuel cells having a ceramic oxide electrolyte separated by conductive interconnect plates. Other fuel cell types, such as PEM, molten carbonate, phosphoric acid, etc. may also be used.

The fuel cell stacks may comprise externally and/or internally manifolded stacks. For example, the stacks may be internally manifolded for fuel and air with fuel and air risers extending through openings in the fuel cell layers and/or in the interconnect plates between the fuel cells.

Alternatively, the fuel cell stacks may be internally manifolded for fuel and externally manifolded for air, where only the fuel inlet and exhaust risers extend through openings in the fuel cell layers and/or in the interconnect plates between the fuel cells, as described in U.S. Pat. Number 7,713,649, which is incorporated herein by reference in its entirety. The fuel cells may have a cross flow (where air and fuel flow roughly perpendicular to each other on opposite sides of the electrolyte in each fuel cell), counter flow parallel (where air and fuel flow roughly parallel to each other but in opposite directions on opposite sides of the electrolyte in each fuel cell) or co-flow parallel (where air and fuel flow roughly parallel to each other in the same direction on opposite sides of the electrolyte in each fuel cell) configuration.

The modular fuel cell system 10 also contains at least one fuel processing module 16. The fuel processing module 16 includes components for pre-processing of fuel, such as adsorption beds (e.g., desulfurizer and/or other impurity adsorption) beds. The fuel processing module 16 may be designed to process a particular type of fuel. For example, the system may include a diesel fuel processing module, a natural gas fuel processing module, and an ethanol fuel processing module, which may be provided in the same or in separate cabinets. A different bed composition tailored for a particular fuel may be provided in each module. The processing module(s) 16 may process at least one of the following fuels selected from natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, bio-gas, bio-diesel and other suitable hydrocarbon or hydrogen containing fuels. If desired, the fuel processing module 16 may include a reformer 17. Alternatively, if it is desirable to thermally integrate the reformer 17 with the fuel cell stack(s), then a separate reformer 17 may be located in each hot box 13 in a respective power module 12. Furthermore, if internally reforming fuel cells are used, then an external reformer 17 may be omitted entirely.

The power conditioning module 18 includes components for converting the fuel cell stack generated DC power to AC power (e.g., DC/DC and DC/AC converters described in U.S. Pat. Number 7,705,490, incorporated herein by reference in its entirety), electrical connectors for AC power output to the grid, circuits for managing electrical transients, a system controller (e.g., a computer or dedicated control logic device or circuit). The power conditioning module 18 may be designed to convert DC power from the fuel cell modules to different AC voltages and frequencies. Designs for 208 V, 60 Hz; 480 V, 60 Hz; 415 V, 50 Hz and other common voltages and frequencies may be provided.

The fuel processing module 16 and the power conditioning module 18 may be housed in one cabinet of the housing 14. If a single input/output cabinet is provided, then modules 16 and 18 may be located vertically (e.g., power conditioning module 18 components above the fuel processing module 16 desulfurizer canisters/beds) or side by side in the cabinet.

As shown in one exemplary embodiment in FIG. 1, one cabinet is provided for one row of six power modules 12, which are arranged linearly side to side on one side of the input/output module 16/18. The row of modules may be positioned, for example, adjacent to a building for which the system provides power (e.g., with the backs of the cabinets of the modules facing the building wall). While one row of power modules 12 is shown, the system may comprise more than one row of modules 12. For example, as noted above, the system may comprise two rows of power modules stacked back to back.

The linear array of power modules 12 is readily scaled. For example, more or fewer power modules 12 may be provided depending on the power needs of the building or other facility serviced by the fuel cell system 10. The power modules 12 and input/output modules 16/18 may also be provided in other ratios. For example, in other exemplary embodiments, more or fewer power modules 12 may be provided adjacent to the input/output module 16/18. Further, the support functions could be served by more than one input/output module 16/18 (e.g., with a separate fuel processing module 16 and power conditioning module 18 cabinets). Additionally, while in the preferred embodiment, the input/output module 16/18 is at the end of the row of power modules 12, it could also be located in the center of a row power modules 12.

The modular fuel cell system 10 may be configured in a way to ease servicing of the components of the system 10. All of the routinely or high serviced components (such as the consumable components) may be placed in a single module to reduce amount of time required for the service person. For example, a purge gas (optional) and desulfurizer material for a natural gas fueled system may be placed in a single module (e.g., a fuel processing module 16 or a combined input/output module 16/18 cabinet). This would be the only module cabinet accessed during routine maintenance. Thus, each module 12, 16, and 18 may be serviced, repaired or removed from the system without opening the other module cabinets and without servicing, repairing or removing the other modules.

For example, as described above, the system 10 can include multiple power modules 12. When at least one power module 12 is taken offline (i.e., no power is generated by the stacks in the hot box 13 in the off line module 12), the remaining power modules 12, the fuel processing module 16 and the power conditioning module 18 (or the combined input/output module 16/18) are not taken off line. Furthermore, the fuel cell system 10 may contain more than one of each type of module 12, 16, or 18. When at least one module of a particular type is taken off line, the remaining modules of the same type are not taken off line.

Thus, in a system comprising a plurality of modules, each of the modules 12, 16, or 18 may be electrically disconnected, removed from the fuel cell system 10 and/or serviced or repaired without stopping an operation of the other modules in the system, allowing the fuel cell system to continue to generate electricity. The entire fuel cell system 10 does not have to be shut down if one stack of fuel cells in one hot box 13 malfunctions or is taken off line for servicing.

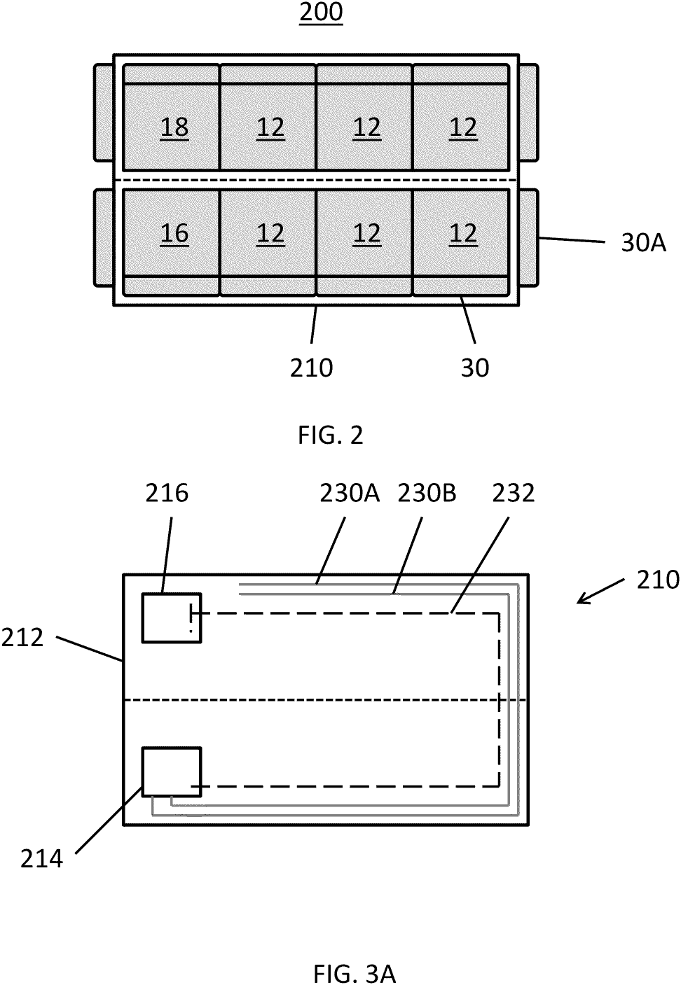

FIG. 2 illustrates top plan view of a modular fuel cell system 200 according to various embodiments of the present disclosure. The fuel cell system 200 is similar to the fuel cell system 10 of FIG. 1. As such, similar reference numbers are used for similar elements, and only the differences therebetween will be described in detail.

Referring to FIG. 2, the system 200 includes power modules 12, a power conditioning module 18, and a fuel processing module 16 disposed on a pad 210. The system 200 may include doors 30 to access the modules 12, 16, 18. The system 200 may further include cosmetic doors 30A.

The power modules 12 may be disposed in a back-to-back configuration. In particular, the power modules 12 may be disposed in parallel rows, and the fuel processing module 16 and the power conditioning module may be disposed at ends of the rows. Accordingly, the system 200 has an overall rectangular configuration, and may be shorter in length than other systems, such as the system 10 of FIG. 1. As such, the system 200 can be disposed in locations where space length is an issue. For example, the system 200 may fit in a parking spot adjacent to a building to which power is to be provided.

While the system 200 is shown to include two rows of three power modules 12, the present disclosure is not limited to any particular number of power modules 12. For example, the system 200 may include 2-30 power modules 12, 4-12 power modules 12, or 6-12 power modules 12, in some embodiments. In other words, the system 200 may include any desired number of power modules 12, with the power modules 12 being disposed in a back-to-back configuration. In addition, the positions of the fuel processing module 16 and the power conditioning module 18 may be reversed, and/or the modules 16, 18 may be disposed on either end of the system 200.

FIG. 3A illustrates a schematic top view of the pad 210. FIG. 3B illustrates a perspective view of the pad 210, and FIG. 3C illustrates a perspective view of the pad 210 including an edge cover.

Referring to FIGS. 3A-3C, the pad 210 includes a base 212. The base 212 may be formed of a concrete or similar material. Alternatively, the base 212 may be made of any other suitable structural material, such as steel or another metal, and may be pre-cast as a single body or may be cast in sections. The base 212 may be made by casting the base material in a patterned mold, removing the cast base 212 from the mold, and then transporting the base 212 from the location of the mold (e.g., in a base fabrication facility) to the operation site of the fuel cell system (i.e., where the fuel cell system will be located to generate power). The base 212 may be configured as a single piece, or may include multiple connected sections.

The base 212 may include first and second through holes 214, 216, a drainage recess 218, a wiring recess 220, and a plumbing recess 222. The base 212 may also include tie-down pockets 224, tie-down inserts 226, and plumbing brackets 228.

The drainage recess 218 may extend along the middle of the base 212, between the rows of modules, and may be configured to collect, for example, rain or debris collected on the base 212. The tie-down pockets 224 and tie-down inserts 226 may be configured to secure corresponding modules to the base 212. The plumbing recess 222 may extend around the perimeter of the base 212. In particular, the plumbing recess 222 may be formed along three or more edges of the base 212. The wiring recess 220 may extend from the first through hole 214 to the second through hole 216, and may be generally U-shaped.

The pad 210 may also include plumbing 230, wiring 232, and a system electrical connection, such as a bus bar 234. In particular, the wiring 232 may be disposed in the wiring recess 220 and may be connected to one or more of the modules. For example, the wiring 232 may be connected to the bus bar 234 and each of the power modules 12. The bus bar 234 may be connected to the power conditioning module 18. The power conditioning module 18 may be connected to an external load through the second through hole 216. The bus bar 234 may be disposed on an edge of the through hole 216, such that the wiring 232 does not extend across the through hole 216. However, the bus bar 234 may be disposed on an opposing side of the through hole 216, such that the wiring 232 does extend across the through hole 216, if such a location is needed to satisfy system requirements.

The plumbing 230 may be disposed in the plumbing recess 222. The plumbing 230 may be connected to an external source of water and/or fuel, via the first through hole 214, and may be attached to the plumbing brackets 228. In particular, the plumbing 230 may include a fuel pipe 230A connecting the fuel processing module 16 to the power modules 12. The plumbing 230 may also include a water pipe 230B configured to provide water to the power modules 12. The plumbing 230 may extend between the plumbing brackets 228 to the power modules 12.

As shown in FIG. 3C, the plumbing 230 may be covered by an edge cover 236. In particular, the edge cover 236 may be configured to cover the plumbing recess 222. In some embodiments, the edge cover 236 may include a number of segments, such that the edge cover 236 may be removed and/or installed on a piece-by-piece basis.

FIG. 3D illustrates a perspective view of a pad 211, according to various embodiments of the present disclosure. The pad 211 is an alternate version of the pad 210 of the fuel cell system of FIG. 2, in place of the pad 210. Accordingly, only the differences between the pads 210, 211 will be described in detail.

Referring to FIG. 3D, the pad 211 includes wiring 233, but does not include a bus bar. In particular, the wiring 233 may be in the form of cables configured to attach each power module 12 to the power conditioning module 18 and the system electrical connection may comprise a cable assembly input or output 237.

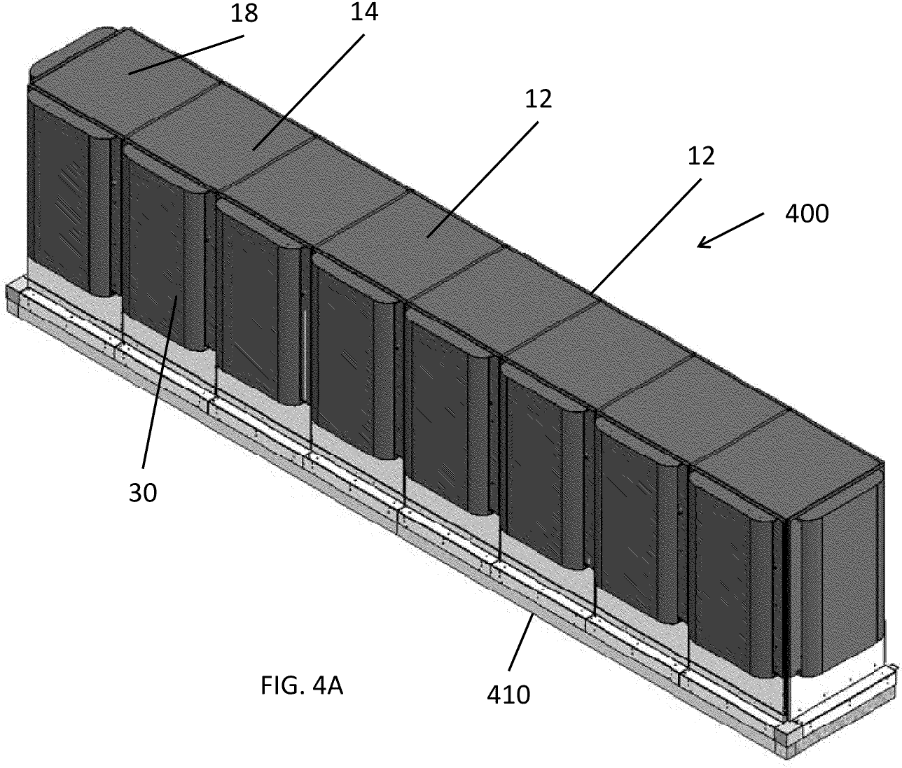

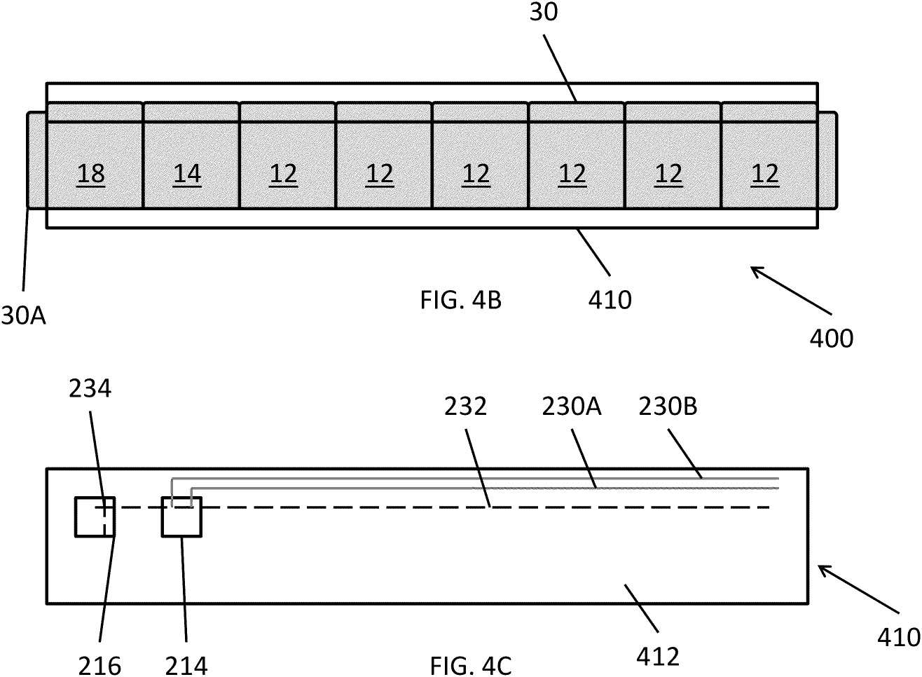

FIG. 4A illustrates a perspective view of a modular fuel cell system according to various embodiments of the present disclosure. FIG. 4B illustrates top plan view of the system 400. FIG. 4C illustrates a schematic view of a pad 410 of FIG. 4A. The fuel cell system 400 includes similar components to the fuel cell system 10 of FIG. 1. As such, similar reference numbers are used for similar elements, and only the differences therebetween will be described in detail.

Referring to FIGS. 4A-C, the system 400 includes power modules 12, a power conditioning module 18, and a fuel processing module 16 disposed on a pad 410. The system 400 may include doors 30 to access the modules 12, 16, 18. The system 400 may further include cosmetic doors 30A.

The power modules 12 may be disposed in a linear configuration. In particular, the power modules 12 may be disposed in one row, and the fuel processing module 16 and the power conditioning module 18 may be disposed at an end of the row. According to some embodiments, the fuel processing module 16 and the power conditioning module 18 may be disposed in the middle of the row. Accordingly, the system 400 has an overall linear configuration, and may be fit into locations having linear space, but limited width. An example of such a location may be behind a big box store.

While the system 400 is shown to include a row of six power modules 12, the present disclosure is not limited to any particular number of power modules 12. For example, the system 400 may include 2-30 power modules 12, 4-12 power modules 12, or 6-12 power modules 12, in some embodiments. In other words, the system 500 may include any desired number of power modules 12, with the modules 12, 16, 18 being disposed in a linear configuration.

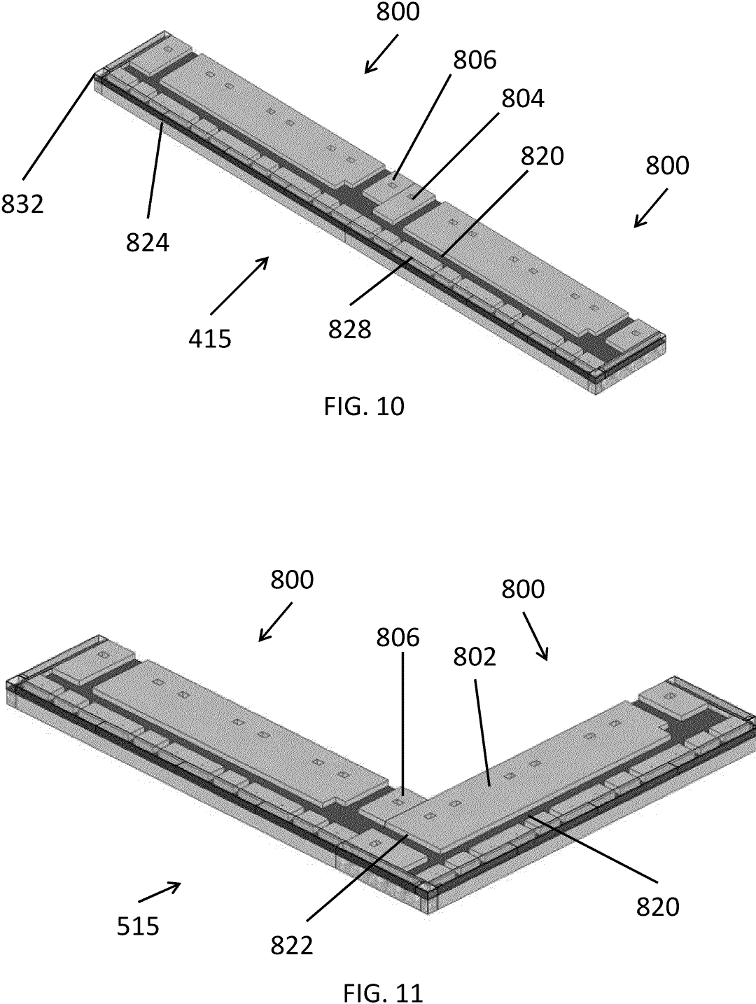

The pad 410 includes a base 412. The base 412 may include first and second through holes 214, 216. The base 412 may also include a wiring recess and a plumbing recess, as discussed below with regard to FIG. 10. The base 412 may be formed of a concrete or similar material. Alternatively, the base 412 may be made of any other suitable structural material, such as steel or another metal, and may be pre-cast as a single body or may be cast in sections. The base 412 may be made by casting the base material into a patterned mold, removing the cast base 412 from the mold and then transporting the base 412 from the location of the mold (e.g., in a base fabrication facility) to the location of the fuel cell system (i.e., where the fuel cell system will be located to generate power).

The pad 410 may also include plumbing 230 (for example, water pipe 230A and fuel pipe 230B), wiring 232, and a system bus bar 234. In particular, the wiring 232 may be disposed in a substantially linear wiring recess and may be connected to one or more of the modules. For example, the wiring 232 may be connected to the bus bar 234 and each of the power modules 12. The bus bar 234 may be connected to the power conditioning module 18. The power conditioning module 18 may be connected to an external load through the second through hole 216. The bus bar 234 may be disposed on an edge of the second through hole 216, such that the wiring 232 does not extend across the second through hole 216. However, the bus bar 234 may be disposed on an opposing side of the second through hole 216, such that the wiring 232 does extend across the second through hole 216, if such a location is needed to satisfy system requirements.

According to some embodiments, the plumbing 230 and the wiring 232 may be disposed adjacent to the doors 30, in order to facilitate connecting the same to the modules 12, 16, 18. In other words, the plumbing 230 and the wiring 232 may be disposed adjacent to an edge of the base 412. According to some embodiments, the wiring 232 may be in the form of cables, similar to what is shown in FIG. 3D, and the bus bar 234 may be omitted.

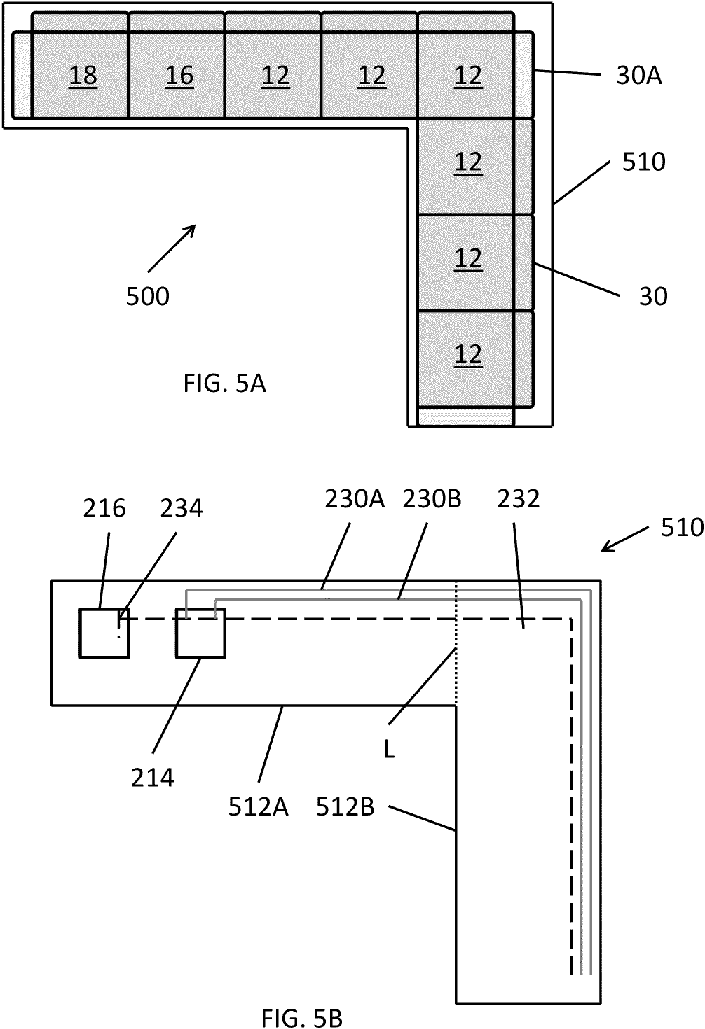

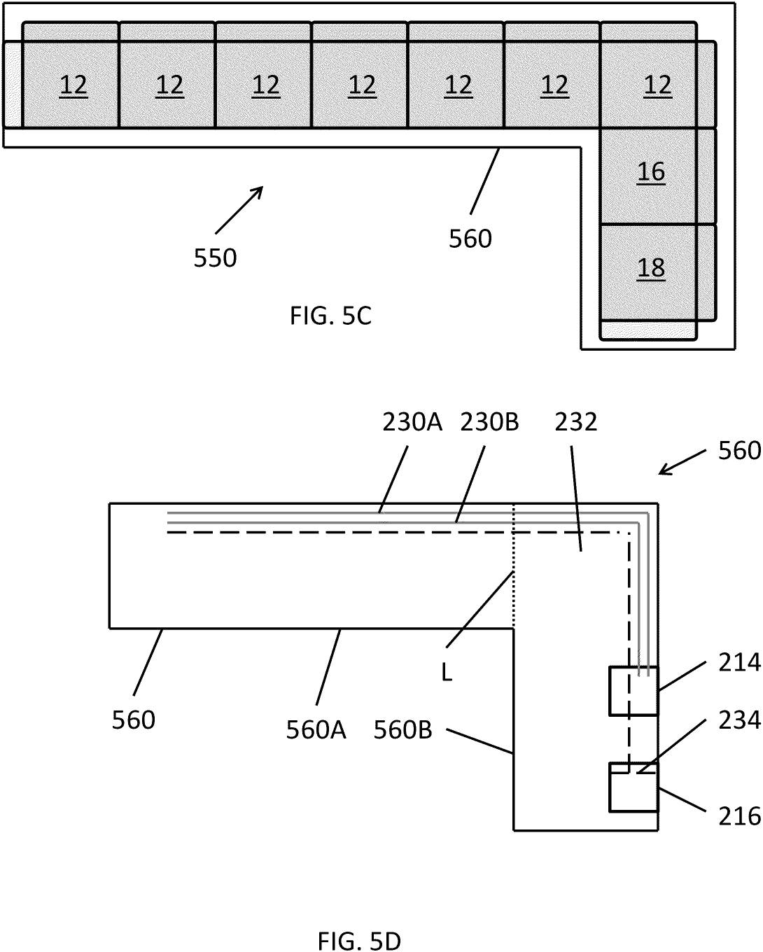

FIG. 5A illustrates a top plan view of a modular fuel cell system 500 according to various embodiments of the present disclosure. FIG. 5B illustrates a schematic view of a pad 510 of FIG. 5A. The fuel cell system 500 includes similar components to the fuel cell system 200. As such, similar reference numbers are used for similar elements, and only the differences therebetween will be described in detail.

Referring to FIGS. 5A and 5B, the system 500 includes power modules 12, a power conditioning module 18, and a fuel processing module 16, which are disposed on a pad 510. The system 500 may include doors 30 to access the modules 12, 16, 18. The system 500 may further include cosmetic doors 30A.

The power modules 12 may be disposed in an L-shaped configuration. In particular, the power modules 12 may be disposed in a first row, and the fuel processing module 16, the power conditioning module 18, and addition power modules 12 may be disposed in a second row substantially orthogonal to the first row. In particular, the modules 16, 18 may be disposed at a distal end of the second row. Accordingly, the system 500 may be configured to operate in locations having linear space, but limited width. An example of such a location may be behind a large store.

While the system 500 is shown to include a row of six power modules 12, the present disclosure is not limited to any particular number of power modules 12. For example, the system 500 may include 2-30 power modules 12, 4-12 power modules 12, or 6-12 power modules 12, in some embodiments. In other words, the system 500 may include any desired number of power modules 12, with the modules 12, 16, 18 being disposed in an orthogonal configuration.

The pad 510 includes a base 512. The base 512 may include first and second through holes 214, 216, a wiring recess, and a plumbing recess. The base 512 may be formed of a concrete or similar material. The base 512 may be pre-cast as a single body or may be cast in sections. For example, the base 512 may include a first section 512A and a second section 512B, which may be precast and then disposed adjacent to one another at an operating location. The division between the sections 512A and 512B is shown by dotted line L. The first row of modules may be disposed on the first section 512A, and the second row of modules may be disposed on the second section 512B.

The pad 510 may also include plumbing 230 (for example, water plumbing 230A and fuel plumbing 230B), wiring 232, and a system bus bar 234. In particular, the wiring 232 may be disposed in a wiring recess and may be connected to one or more of the modules. For example, the wiring 232 may be connected to the bus bar 234 and each of the power modules 12. The bus bar 234 may be connected to the power conditioning module 18. The power conditioning module 18 may be connected to an external load through the second through hole 216.

According to some embodiments, the plumbing 230 and the wiring 232 may be disposed adjacent to the doors 30, in order to facilitate connecting the same to the modules 12, 16, 18. In other words, the plumbing 230 and the wiring 232 may be disposed adjacent to edges of the base 512. According to some embodiments, the wiring 232 may be in the form of cables, similar to what is shown in FIG. 3D, and the bus bar 234 may be omitted.

FIG. 5C illustrates a top plan view of a modular fuel cell system 550 according to various embodiments of the present disclosure. FIG. 5D illustrates a schematic view of a pad 560 of FIG. 5C. The fuel cell system 550 includes similar components to the fuel cell system 500. As such, similar reference numbers are used for similar elements, and only the differences therebetween will be described in detail.

Referring to FIGS. 5C and 5D, the system 550 includes power modules 12, a power conditioning module 18, and a fuel processing module 16, which are disposed on a pad 560. The power modules 12 may be disposed in a first row, and fuel processing module 16 and the power conditioning module 18 may be disposed in a second row that is generally orthogonal to the first row. As such, the system 550 may be generally L-shaped. The pad 560 may include first and second sections 560A and 560B separated by dotted line L. However, the pad 560 may be formed of a single piece of material. The first row of modules may be disposed on the first section 560A, and the second row of modules may be disposed on the second section 560B.

The pad 560 may also include plumbing 230 (for example, water plumbing 230A and fuel plumbing 230B), wiring 232, a first through hole 214, a second through hole 216, and a system bus bar 234. In particular, the wiring 232 may be disposed in a wiring recess and may be connected to one or more of the modules. For example, the wiring 232 may be connected to the bus bar 234 and each of the power modules 12. The bus bar 234 may be connected to the power conditioning module 18. The power conditioning module 18 may be connected to an external load through the second through hole 216.

According to some embodiments, the plumbing 230 and the wiring 232 may be disposed adjacent to the doors 30, in order to facilitate connecting the same to the modules 12, 16, 18. In other words, the plumbing 230 and the wiring 232 may be disposed adjacent to edges of the pad 560. According to some embodiments, the wiring 232 may be in the form of cables, similar to what is shown in FIG. 3D, and the bus bar 234 may be omitted.

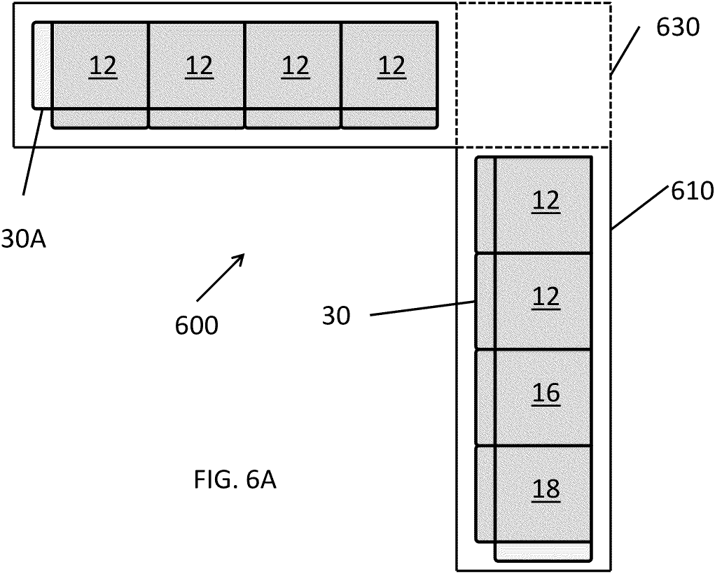

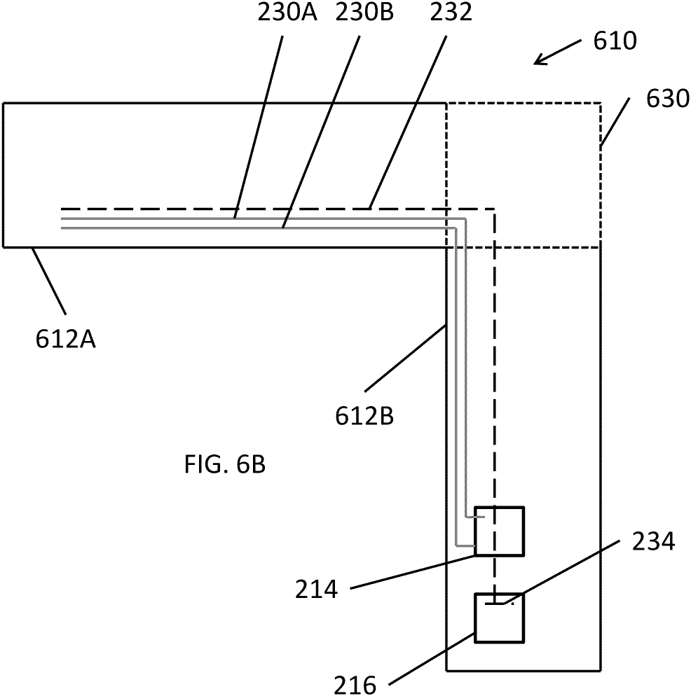

FIG. 6A illustrates a top plan view of a modular fuel cell system 600 according to various embodiments of the present disclosure. FIG. 6B illustrates a schematic view of a pad 610 of FIG. 6A. The fuel cell system 600 includes similar components to the fuel cell system 500. As such, similar reference numbers are used for similar elements, and only the differences therebetween will be described in detail.

Referring to FIGS. 6A and 6B, the system 600 includes power modules 12, a power conditioning module 18, and a fuel processing module 16, which are disposed on a pad 610. The system 600 may include doors 30 to access the modules 12, 16, 18. The system 600 may further include cosmetic doors 30A.

The power modules 12 may be disposed in an L-shaped configuration. In particular, the power modules 12 may be disposed in a first row, and the fuel processing module 16, the power conditioning module 18, and addition power modules 12 may be disposed in a second row substantially orthogonal to the first row. In particular, the modules 16, 18 may be disposed at a distal end of the second row.

In contrast to the system 500, the system 600 includes a dummy section 630 disposed between the first and second rows. The dummy section 630 may be a portion of the pad 610 that does not include a module. Plumbing 230 and wiring 232 may be routed through the dummy section 630 and may extend along an edge of the pad 610.

The pad 610 may include a first section 612A and a second section 612B, which are separated by the dummy section 630. In some embodiments, the dummy section 630 may be a separate section of the pad 610, or may be a portion of either of the first and second sections 612A, 612B. In some embodiments, an empty cabinet may be disposed on the dummy section 630. The first row of modules may be disposed on the first section 612A, and the second row of modules may be disposed on the second section 612B.

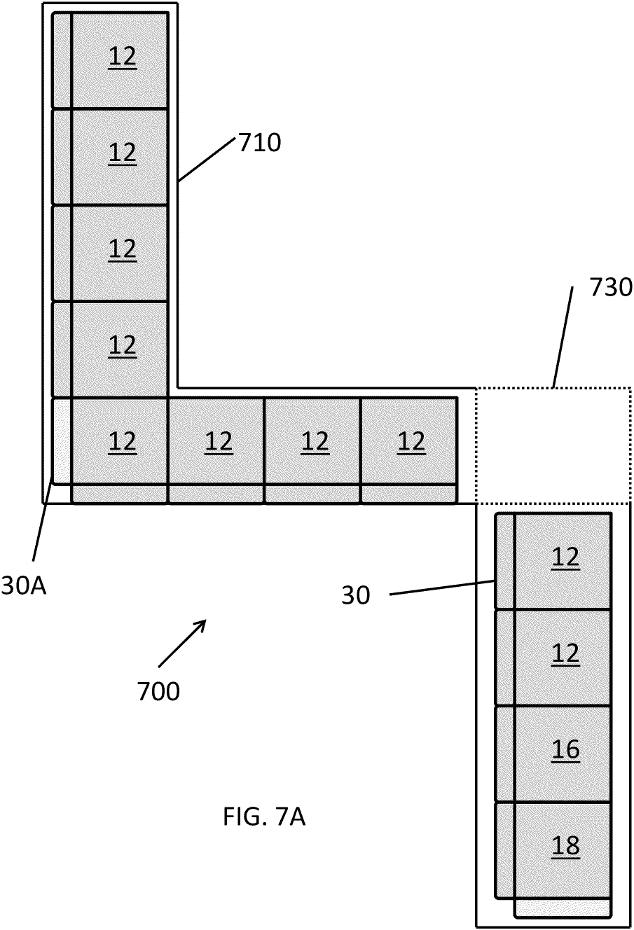

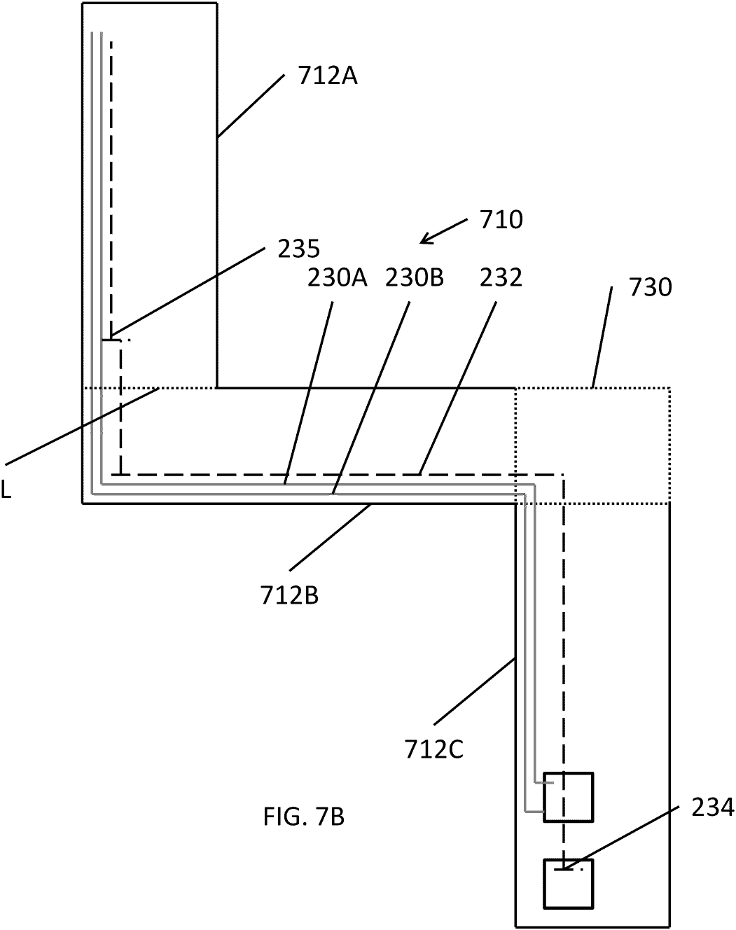

FIG. 7A illustrates a top plan view of a modular fuel cell system 700 according to various embodiments of the present disclosure. FIG. 7B illustrates a schematic view of a pad 710 of FIG. 7A. The fuel cell system 700 includes similar components to the fuel cell system 500. As such, similar reference numbers are used for similar elements, and only the differences therebetween will be described in detail.

Referring to FIGS. 7A and 7B, the system 700 includes power modules 12, a power conditioning module 18, and a fuel processing module 16, which are disposed on a pad 710. The system 700 may include doors 30 to access the modules 12, 16, 18. The system 700 may further include cosmetic doors 30A.

The power modules 12 may be disposed in a stepped configuration. In particular, the power modules 12 may be disposed in a first row, a second row substantially orthogonal to the first row, and a third row substantially orthogonal to the second row. The fuel processing module 16 and the power conditioning module 18 may be disposed at a distal end of the third row. However, the fuel processing module 16 and the power conditioning module 18 may be disposed in the first row or the second row, according to some embodiments.

The system 700 includes a dummy section 730 between the first and second rows. The dummy section 730 may be a portion of the pad 710 that does not include a module. In some embodiments, an empty cabinet may be disposed on the dummy section 730. Plumbing 230 and wiring 232 may be routed through the dummy section 730 and may extend along an edge of the pad 710.

The pad 710 may include a first section 712A, a second section 712B, and a third section 712C. The first and second sections 712A, 712B may be separated by line L. The second and third sections 712B, 712C may be separated by the dummy section 730. In some embodiments, the dummy section 730 may be a separate segment of the pad 710, or may be a portion of either of the second and third sections 712B, 712C. The first row of modules may be disposed on the first section 712A, the second row of modules may be disposed on the second section 712B, and the third row of modules may be disposed on the third section 712B. The pad 710 may also include a second system bus bar 235 configured to connect wiring 232 of the first and second sections 712A, 712B.

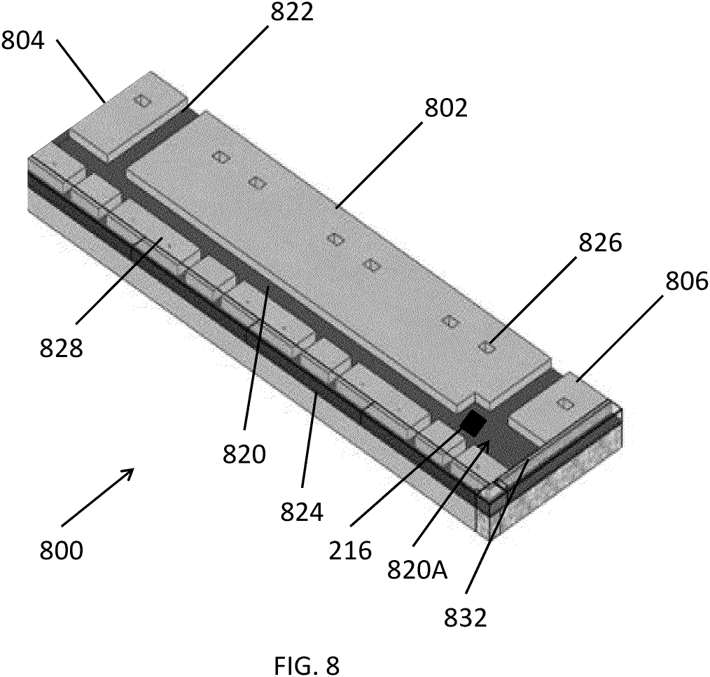

FIG. 8 illustrates a perspective view of modular pad section 800 according to various embodiments of the present disclosure. Referring to FIG. 8, the pad section 800 may be used as any of the sections of the above-described pads. The pad section 800 may be rectangular, e.g., the pad section 800 may have two substantially parallel long sides and two substantially parallel short sides extending therebetween.

The pad section 800 may include a first boss 802, a second boss 804, a third boss 806, plumbing brackets 828, a wiring recess 820, connection recesses 822, and a plumbing recess 824, which may be formed on an upper surface of the pad section 800. The first boss 802 may be disposed between the second and third bosses 804, 806. The second boss 804 may have a larger surface area than the third boss 806. For example, the second boss 804 and the third boss 806 may have substantially the same width, but the second boss 804 may be longer than the third boss 806. The first boss 802 may have a larger surface area than the second or third bosses 804, 806. A portion 820A of the wiring recess 820 that is disposed between the third boss 806 and adjacent plumbing brackets 828 may be enlarged, e.g., the enlarged portion 820A may be wider than the rest of the wiring recess 820. A through hole 216 may be formed in the enlarged portion 820A, according to some embodiments.

The wiring recess 820 may be disposed between the bosses 802, 804, 806 and the plumbing brackets 828. The bosses 802, 804, 806 may include tie-down pockets 826, configured to secure modules disposed thereon. The plumbing brackets 828 may be disposed in a first row, and the bosses 802, 804, 806 may be disposed in a second row that is substantially parallel to the first row.

The plumbing recess 824 may be formed on only two or three sides/edges of the pad section 800, depending on the shape of a pad constructed using the pad sections. For example, the plumbing recess 824 may extend along a long side and one short side of the pad section 800, if the pad section 800 is to be used in a fuel cell system having L-shaped or linear configuration. In the alternative, the plumbing recess 824 a long side and two short sides of the pad section 800, if the pad section 800 is to be used in a fuel cell system having a rectangular configuration.

An edge cover 832 may be disposed on the plumbing recesses 822. The pad section 800 may be precast, delivered, and then assembled on site with one or more other pad sections 800.

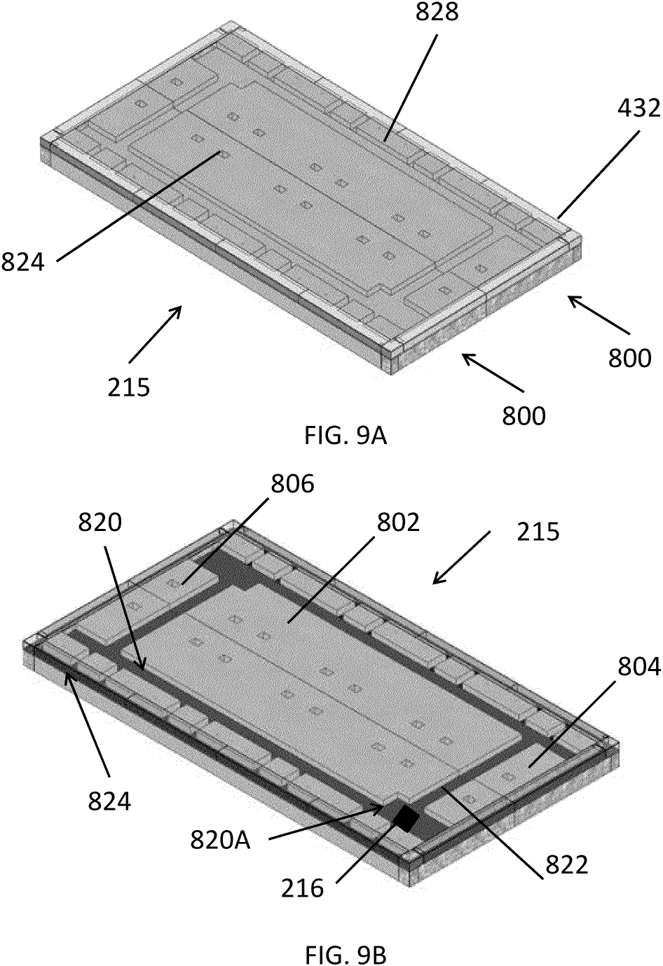

FIGS. 9A and 9B illustrate perspective views of a modular pad 215 according to various embodiments of the present disclosure. The pad 215 may be used as the pad 210 of the fuel cell system 200. Referring to FIGS. 9A and 9B, the pad 215 includes two of the pad sections 800 disposed adjacent to one another. In particular, the pad sections 800 may be disposed flush with one another, and/or may be physically connected to one another.

In particular, each pad section 800 may be configured such that the connection recesses 822 and the plumbing recesses 824 are respectively aligned with one another, when the sections 800 are assembled, as shown in FIGS. 9A and 9B. In other words, the connection recesses 822 of the adjacent pad sections 800 may form contiguous recesses, and the plumbing recesses 824 of two adjacent pad sections 800 may form a contiguous plumbing recess, when the pad sections 800 are aligned with one another. In addition, the pad sections 800 may be aligned such that the second bosses 804 are aligned with (contact) the third bosses 806, and the first bosses 802 are aligned with (contact) one another. In other words, a long side of a first pad section 800 may be disposed in contact with a long side of a second pad section 800 (rotated 180 degrees with respect to the identical first pad section). One or more through holes 216 may be formed the pad sections 800, in order to allow for the routing of plumbing and/or wiring. In particular, a through hole 216 may be formed in the enlarged portion 820A of the wiring recess 820.

FIG. 10 illustrates a perspective view of a modular pad 415 according to various embodiments of the present disclosure. The pad 415 that may be a linear pad that can be substituted for the linear pad 410 of FIGS. 4A and 4B. Referring to FIG. 10, the pad 415 includes two pad sections 800 aligned together lengthwise. In particular, the third boss 806 of one pad section 800 is disposed adjacent to the second boss 804 of the other pad section 800. In other words, a short side of one of the pad sections 800 may be disposed in contact with a short side of the other pad section 800. As such, the wiring recesses 820 and the plumbing recesses 824 of the pad sections 800 may be respectively aligned (contiguous) with one another. In particular, the wiring recesses 820 may be aligned to form a substantially contiguous and linear wiring recess.

FIG. 11 illustrates a modular pad 615 according to various embodiments of the present disclosure. The pad 615 may be substituted for the pad 610 of FIG. 6B.

Referring to FIG. 11, the pad 615 includes two pad sections 800 that are orthogonally aligned together. In particular, the third boss 806 of one pad section 800 is disposed adjacent to the first boss 802 of the other pad section 800. As such, the wiring recesses 820 may be connected by one of the connection recesses 822, and the plumbing recesses 824 of the pad sections 800 may be respectively aligned (contiguous) with one another. In other words, a short side of one pad section 800 may be disposed in contact with a long side of the other pad section 800.

An additional pad section 800 may be aligned with one of the above pad sections 800, such that a step-shaped pad, such as pad 710 of FIG. 7B, may be formed. In other words, each section 712A, 712B, 712C may be formed using one of the pad sections 800.

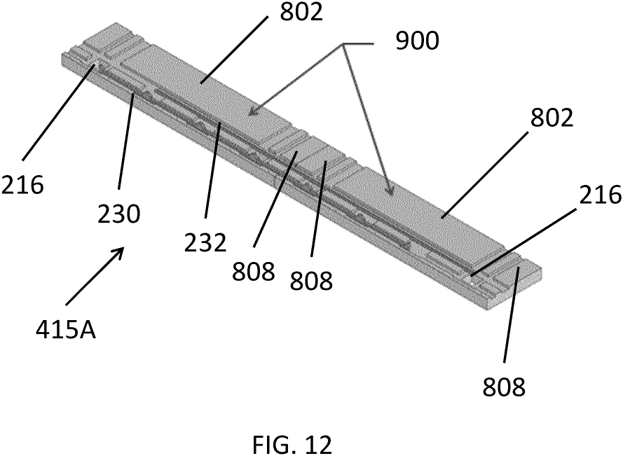

FIG. 12 illustrates a modular pad 415A according to various embodiments of the present disclosure. The pad 415A that may be substituted for the pad 410 of FIGS. 4A and 4B.

Referring to FIG. 12, the pad 415A includes two modular pad sections 900. The pad sections 900 are similar to the pad sections 800, so only the differences therebetween will be discussed in detail.

In particular, the pad sections 900 each include a first boss 802 and second bosses 808 disposed on opposing sides of the first boss 804, on an upper surface of the pad section 900. The second bosses 808 may have the same size and shape. Accordingly, the pad sections 900 may be symmetrical widthwise, which is not the case for the pad sections 800, since the pad sections 800 include the second and third bosses 804 and 806 having different sizes. The pad sections 900 may be aligned together in a manner similar to the pad sections 800 in the pad 415, as discussed above.

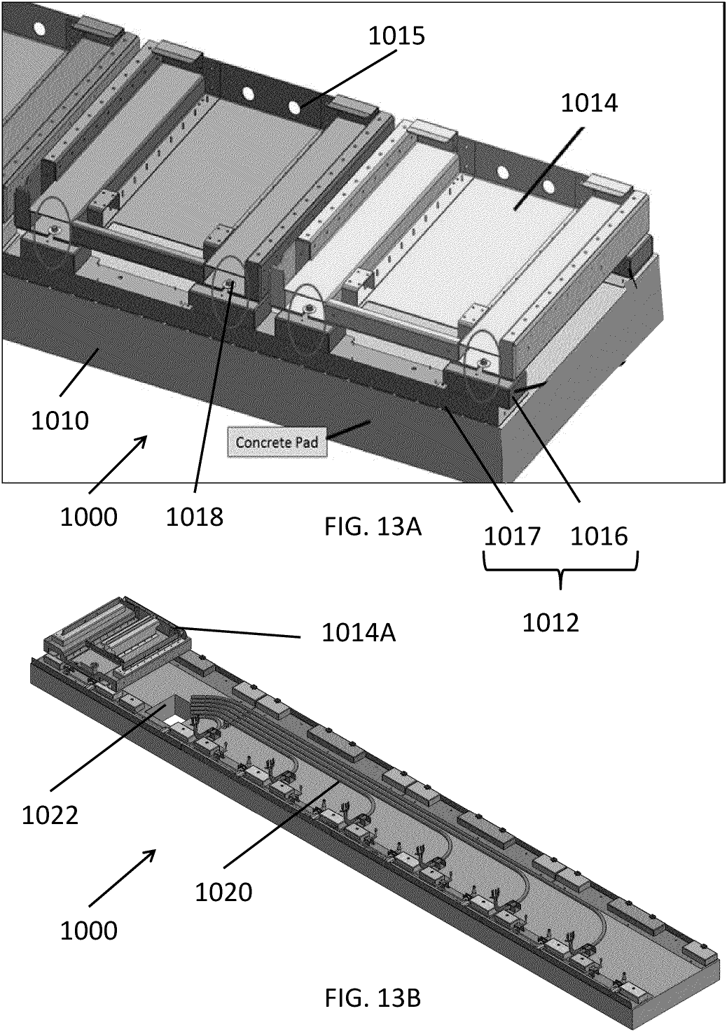

FIGS. 13A and 13B illustrate perspective views of a pad 1000 of a fuel cell system, according to various embodiments of the present disclosure.

Referring to FIGS. 13A and 13B, the pad 1000 may be incorporated into any of the above fuel cell systems. The pad 1000 includes the base 1010, a separator 1012, and frames 1014. The base 1010 may be formed of concrete or similar material, as described above. In particular, the base 1010 may be cast on site, or may be precast in one or more sections and then assembled on site.

The separator 1012 may be disposed on an upper surface of the base 1010, and may be formed of sheet metal or other similar material. The separator 1012 may include rails 1017 disposed on opposing sides of the base 1010, and spacers 1016 disposed on the rails 1017. The rails 1017 may be single pieces, or may include connected rail sections.

The frames 1014 may be attached to the spacers 1016 using any suitable method, such as by using bolts 1018, clamps, or the like. The frames 1014 are configured to receive modules, such as power modules, fuel processing modules, or the like. The separator 1012 may be configured to separate the base 1010 and the frames 1014, such that there is a space formed therebetween.

The pad 1000 may include plumbing 1020 disposed on the base 1010. The plumbing 1020 may extend from a through hole 1022 formed in the base 1010, and may be configured to provide water and/or fuel to modules disposed on the frames 1014. The pad 1000 may include a frame 1014A configured to receive a power conditioning module. The pad 1000 may also include wiring (not shown) configured to connect the power modules to a power conditioning module disposed on the frame 1014A. In the alternative, wiring could be routed through openings 1015 formed in the frames 1014.

The separator 1012 is configured to space apart the frames 1014 from the upper surface of the base 1010. Accordingly, the plumbing 1020 may be disposed directly on the upper surface of the base 1010. In other words, the upper surface of the base 1010 may be substantially planar, e.g., does not need to include recesses for the plumbing 1020 and/or wiring.

The configuration of the pad 1000 provides advantages over conventional pads, in that plumbing and/or wiring is not required to be set into features cast into the base 1010, in order to have a flat surface for the installation of fuel cell system modules. As such, the pad 1000 may be manufactured at a lower cost, since the base 1010 does not require cast features.

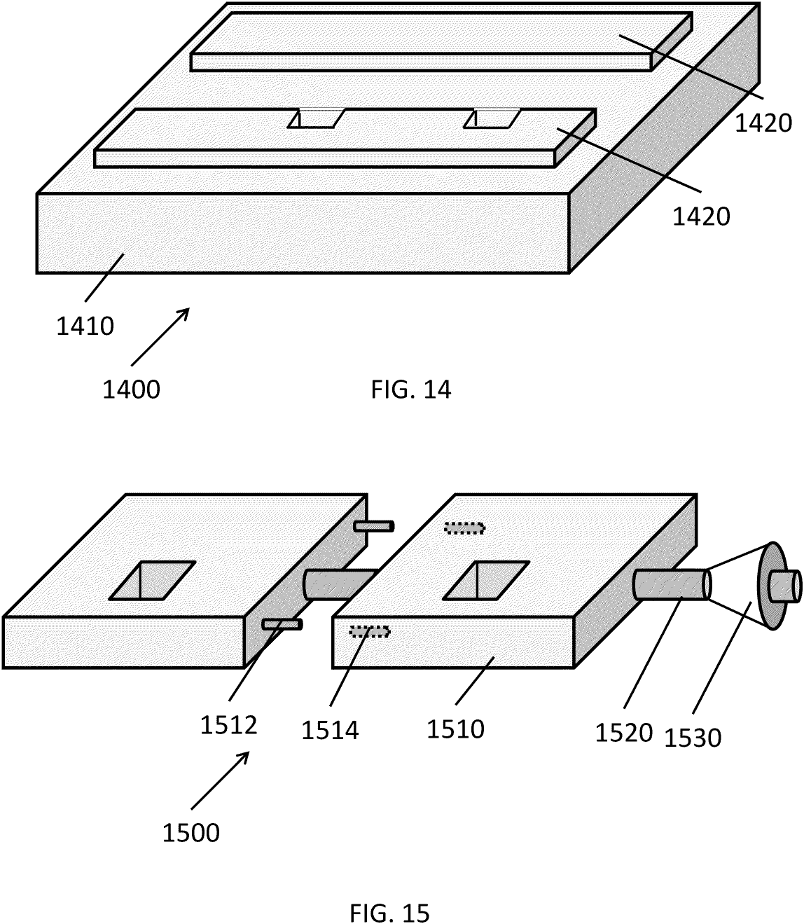

FIG. 14 is a perspective view of a pad 1400 for a fuel cell system, according to various embodiments of the present disclosure. Referring to FIG. 14, the pad 1400 includes a base 1410 and replicators 1420 disposed on the base 1410. The base 1410 may be a cast on site or precast and delivered to a site. The base 1410 may be formed of concrete or a similar material.

The replicators 1420 may be attached to the base 1410 and may be formed of plastic or other non-corrosive material. The replicators 1420 may replicate features that are molded into bases of the previous embodiments described above. For example, the replicators 1420 may form bosses such that wiring and/or plumbing channels or recesses are formed on a flat upper surface of the base 1410 between the replicators 1420. Accordingly, the replicators 1420 may create an elevated structure for supporting the modules 12, 16, 18 of a fuel cell system, while the wiring and plumbing is formed on the flat upper surface of the concrete base 1410 in the channels or recesses between the replicators. The replicators 1420 may also be used as templates for drilling features into the base 1410. The replicators 1420 may be attached (e.g., snapped) together and/or attached to the base 1410 using any suitable attachment methods, such as being molded onto the upper base surface.

According to some embodiments, multiple pads 1400 may be attached to one another as pad sections, to create a larger pad 1400. For example, the pads 1400 could be connected using “living hinges” on pad plumbing covers, which may snap lock into position. In other words, the pad 1400 may be considered a pad section, according to some embodiments.

FIG. 15 is a perspective view of a pad 1500 for a fuel cell system, according to various embodiments of the present disclosure. Referring to FIG. 15, the pad 1500 includes pad sections 1510 and a tension cable 1520. While one tension cable 1520 is shown, multiple tension cables 1520 may be included. The tension cable 1520 is configured to connect the pad sections 1510. In particular, wedges 1530 may be disposed on the tension cable 1520 to bias the pad sections 1520 together. While one wedge 1530 is shown, wedges may be disposed on opposing ends of each tension cable 1520.

The pad sections 1510 may further include alignment pins 1512 and alignment holes 1514. In particular, the alignment pins 1512 may be interested into the alignment holes 1514, in order to align the pad sections 1520 with one another. According to some embodiments, the alignment pins 1512 may be pyramid-shaped and the alignment holes 1514 may have a corresponding shape, in order to facilitate alignment of the pad sections 1510.

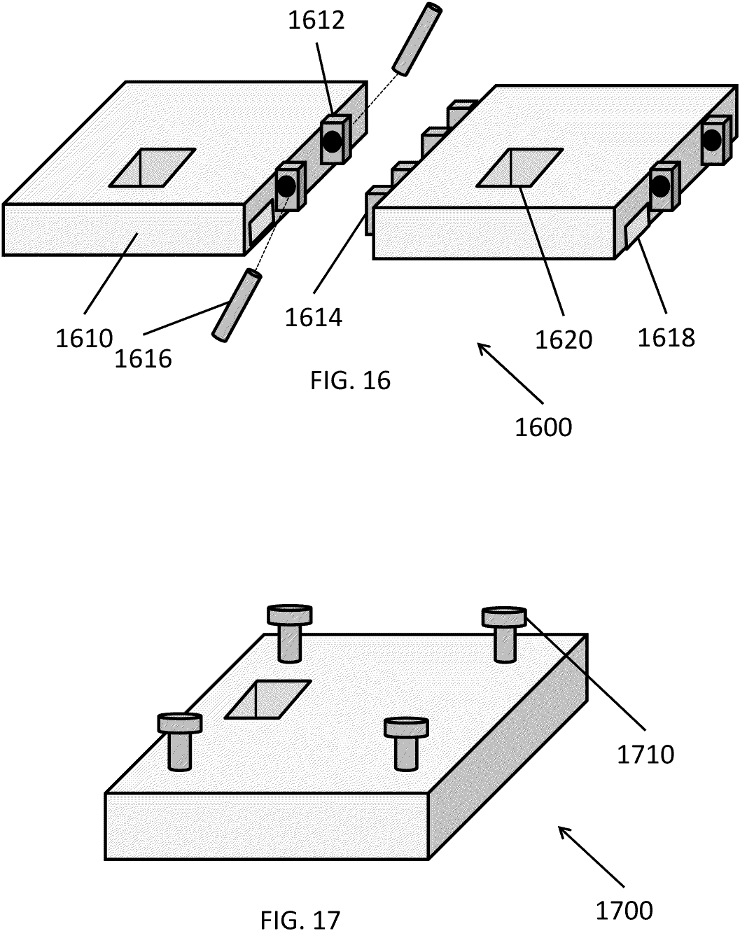

FIG. 16 is a perspective view of a pad 1600 for a fuel cell system, according to various embodiments of the present disclosure. Referring to FIG. 16, the pad 1600 includes pad sections 1610 that are connected together. In particular, the pad sections 1610 include first and second brackets 1612, 1614, which mate with one another and are locked together with pins 1616 inserted there through. The pad sections 1610 may include recesses or cut-outs 1618 that may provide space for plumbing and/or wiring. The plumbing and/or wiring may be fed through the pad sections 1610 to holes 1620 formed therein. The configuration of the pad 1600 may allow for the pad 1600 to have various shape and/or sizes. In some embodiments, the pad sections 1600 may be disposed on a relatively thin concrete pad.

FIG. 17 illustrates a pad section 1700 of a fuel cell system, according to various embodiments. Referring to FIG. 17, the pad section 1700 includes tie downs 1710 extending from an upper surface thereof. The tie downs 1710 may be formed of forged or toughened metal, and may be inserted into the pad during or after fabrication. The tie downs 1710 may be mushroom shaped, and may allow for the blind installation of a module on the pad section 1700. As such, the tie downs 1710 allow for a module to be more easily attached to the pad section 1700, since the tie downs 1710 are self-guiding.

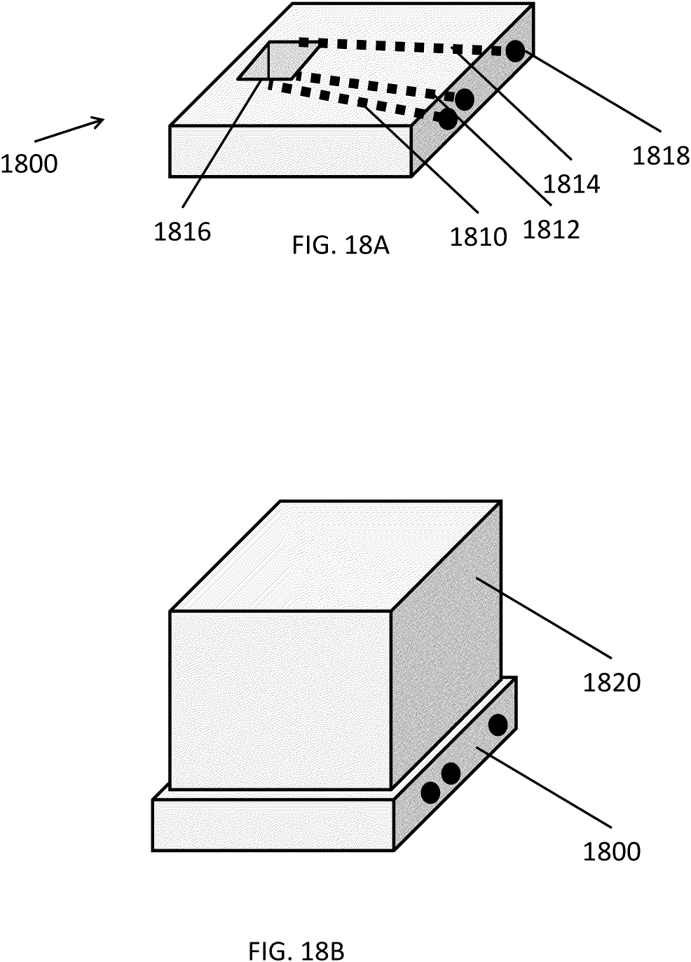

FIG. 18A illustrates a support frame 1800 of a fuel cell system, according to various embodiments. The support frame may include water plumbing 1810, fuel plumbing 1812, and electrical wiring 1814, which may extend between a hole 1816 in the support frame 1800 and quick connects 1818.

The support frame 1800 may be attached and prewired to a module 1820 of a fuel cell system as shown in FIG. 18B at a manufacturing site and then shipped to a site for assembly where the fuel cell system will generate power. The pre-attached frame 1800 may be similar to the frame 1014 shown in FIG. 13A. Accordingly, assembly of a fuel cell system may be simplified.

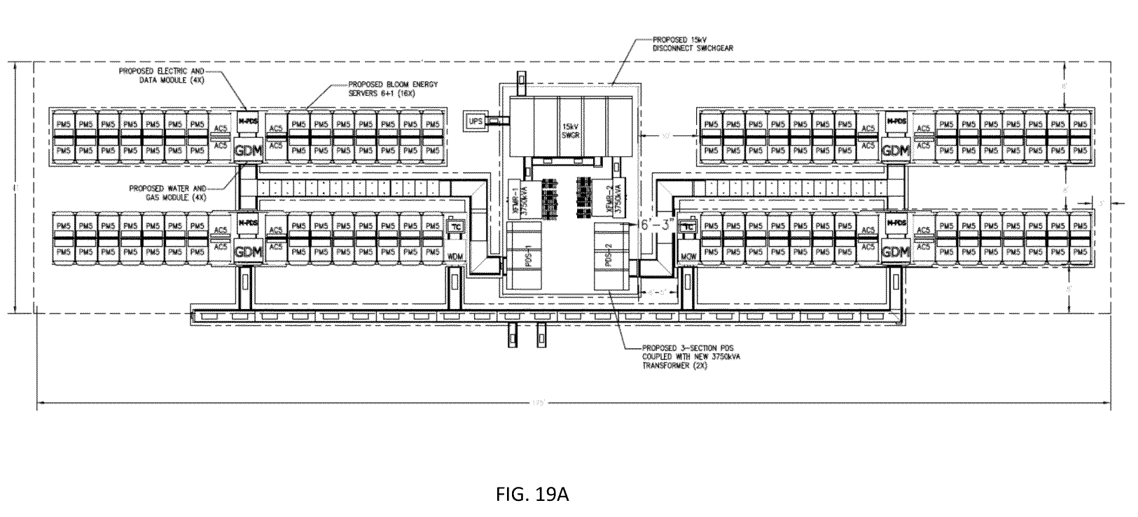

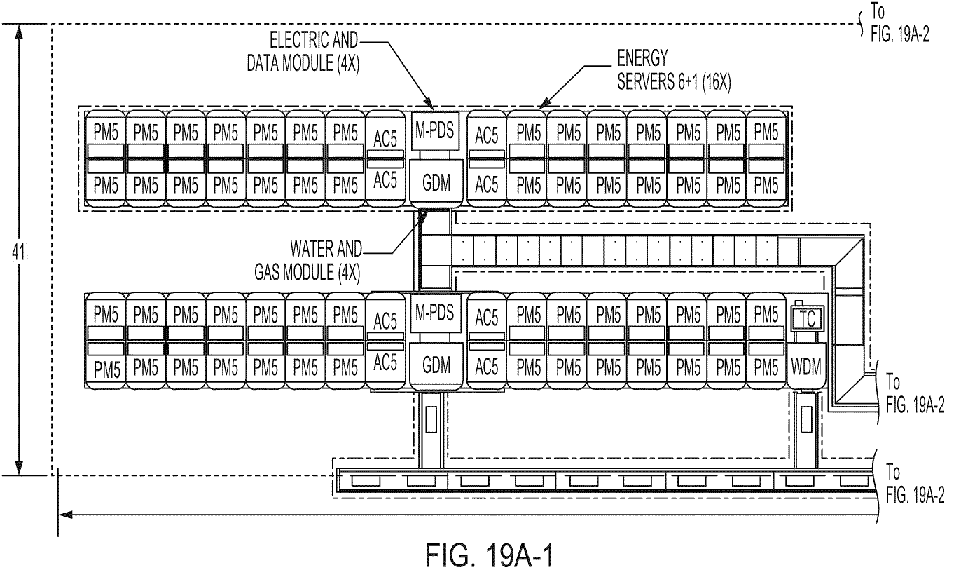

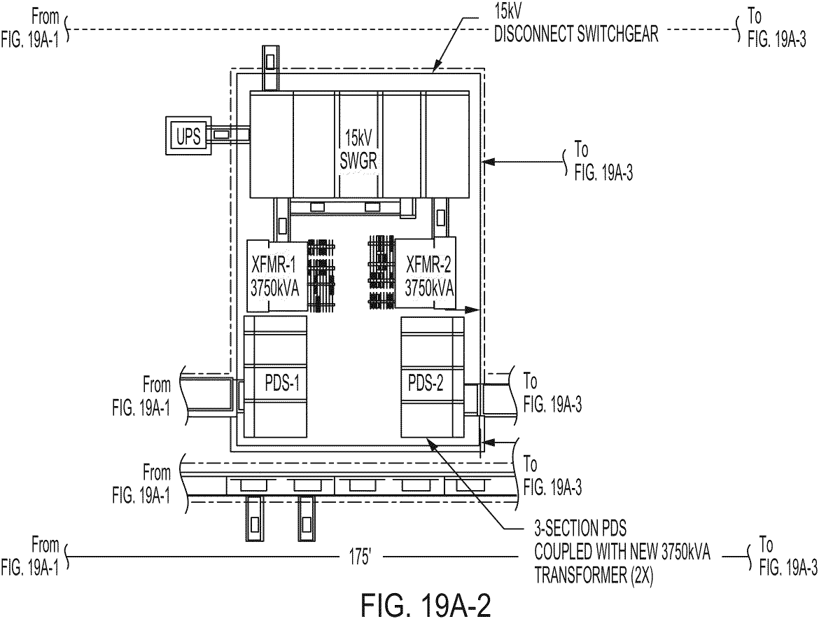

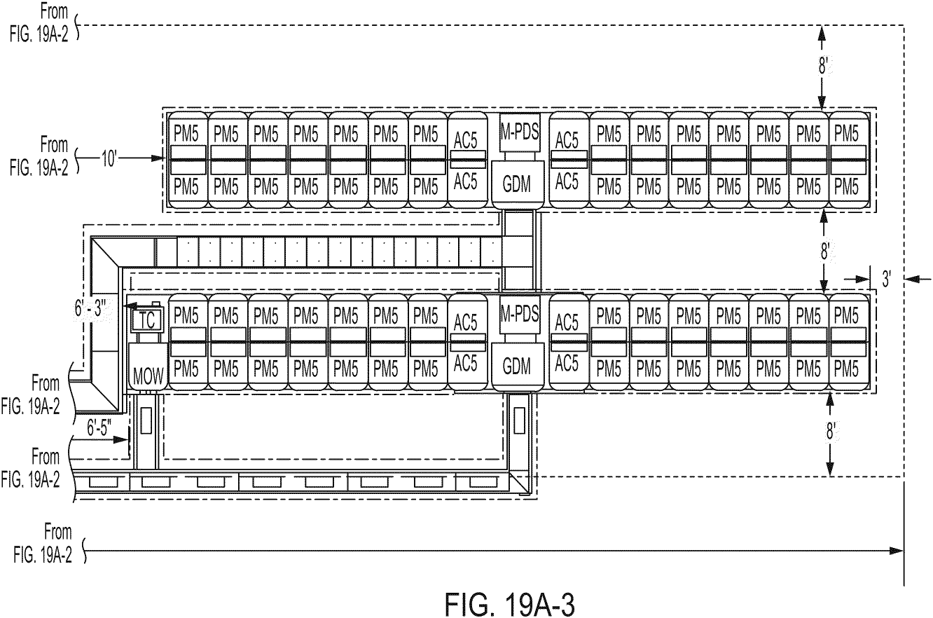

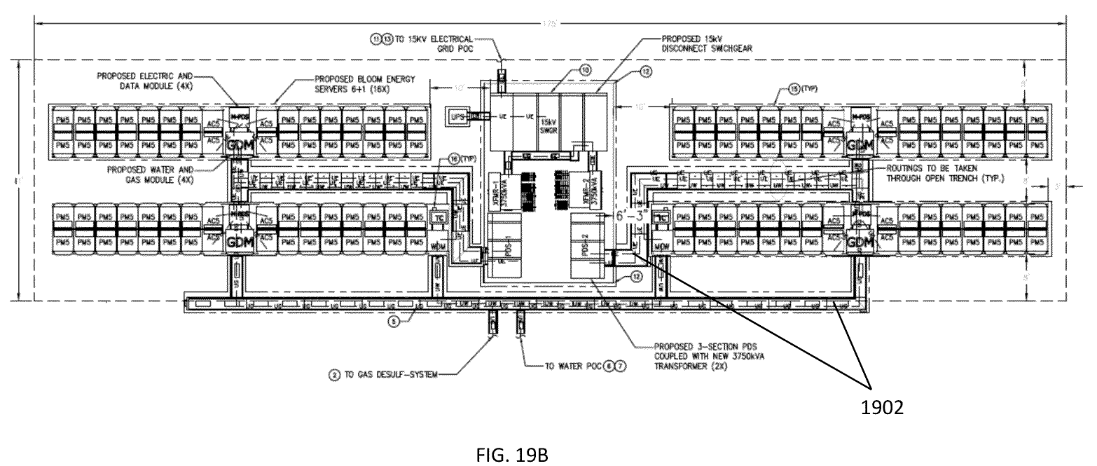

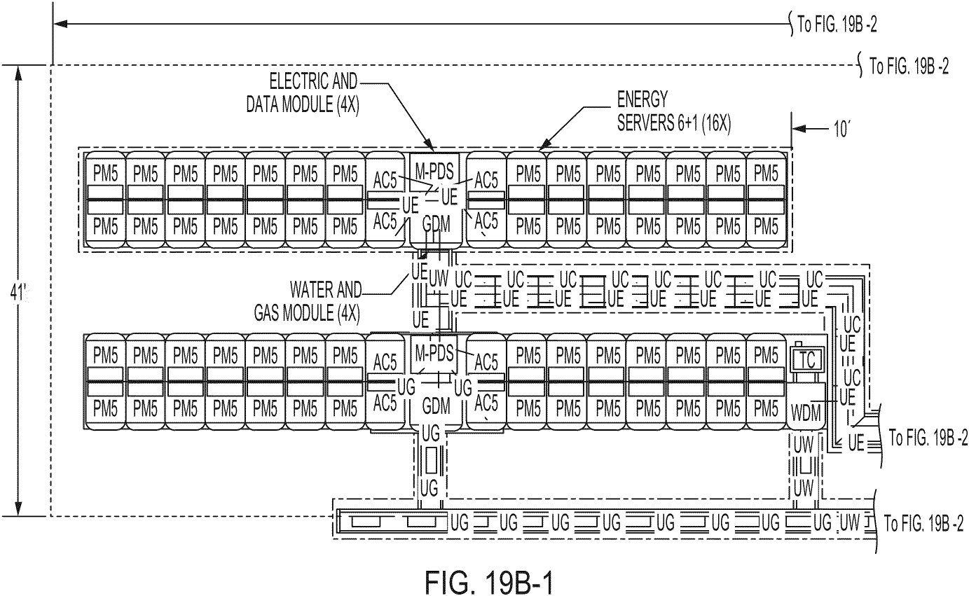

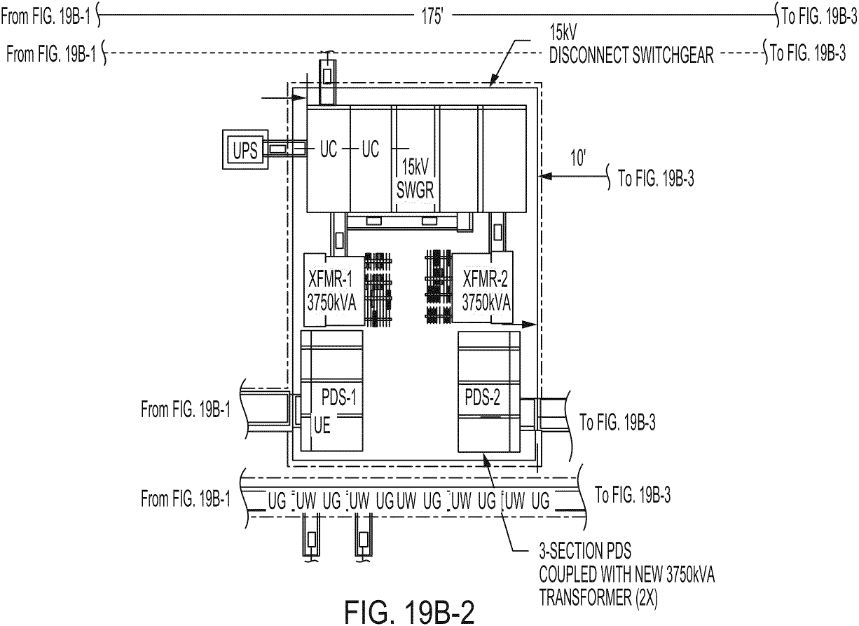

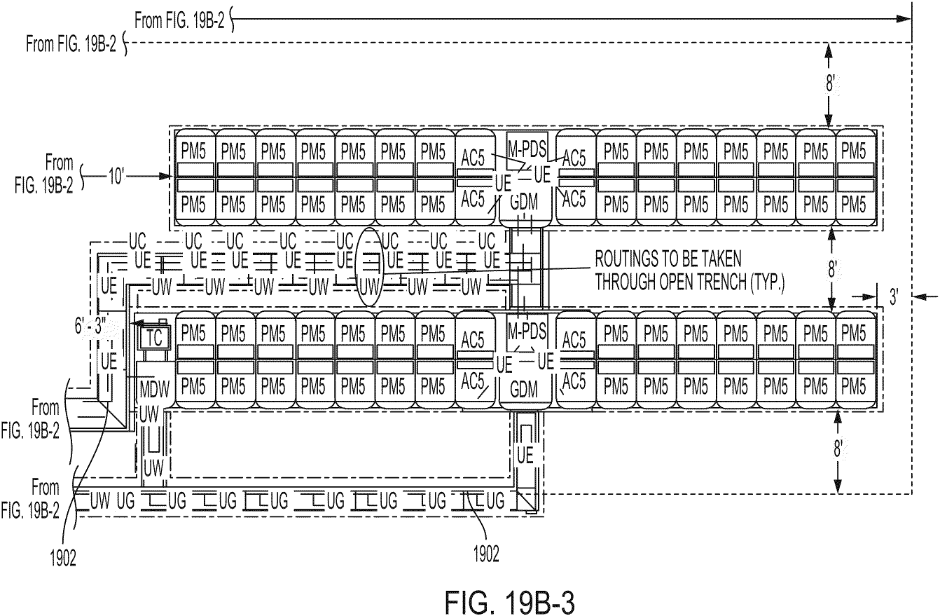

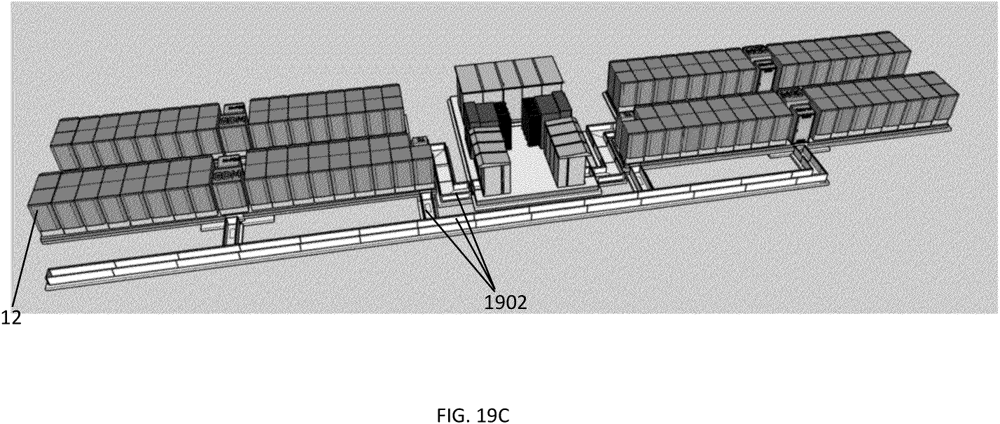

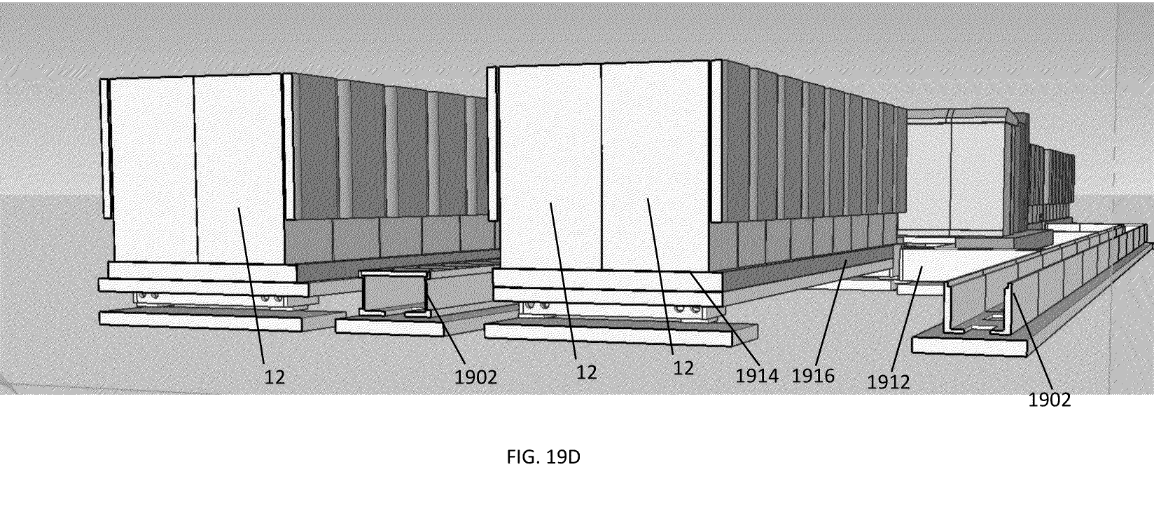

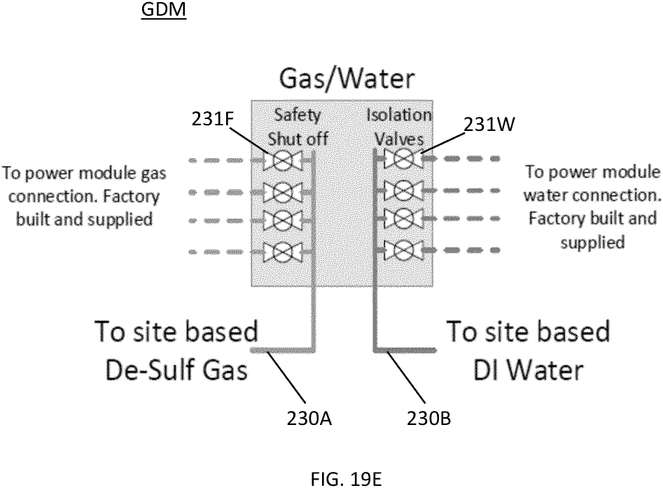

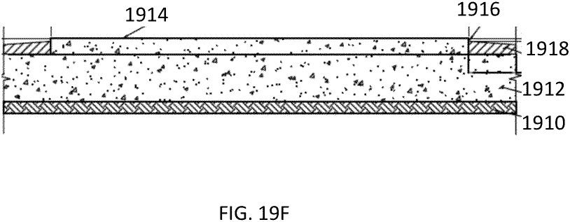

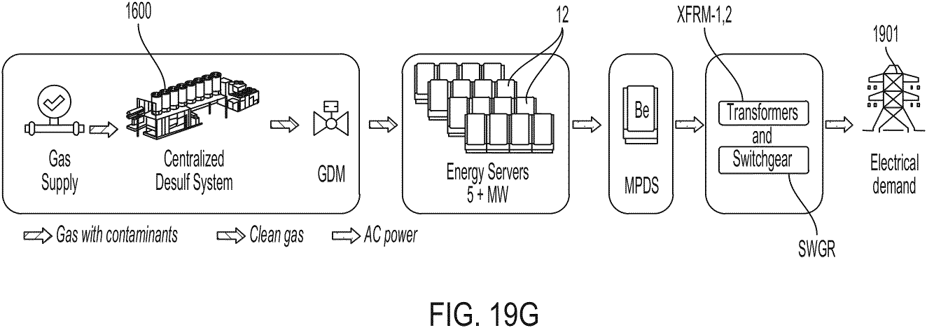

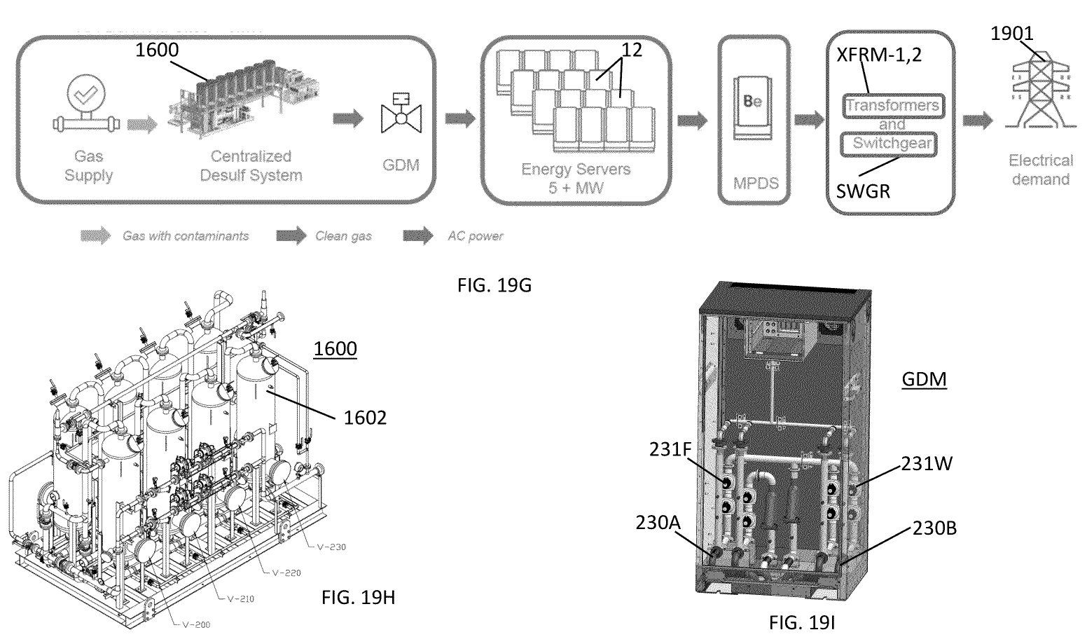

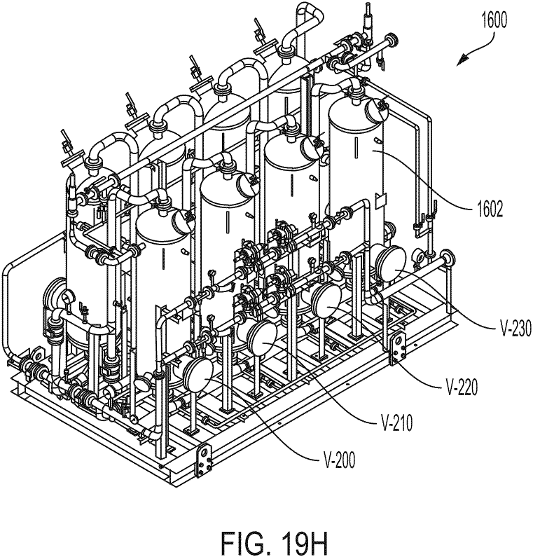

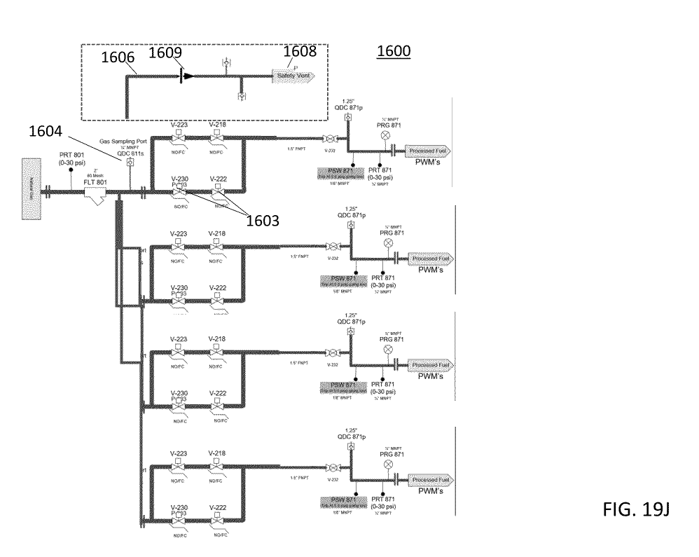

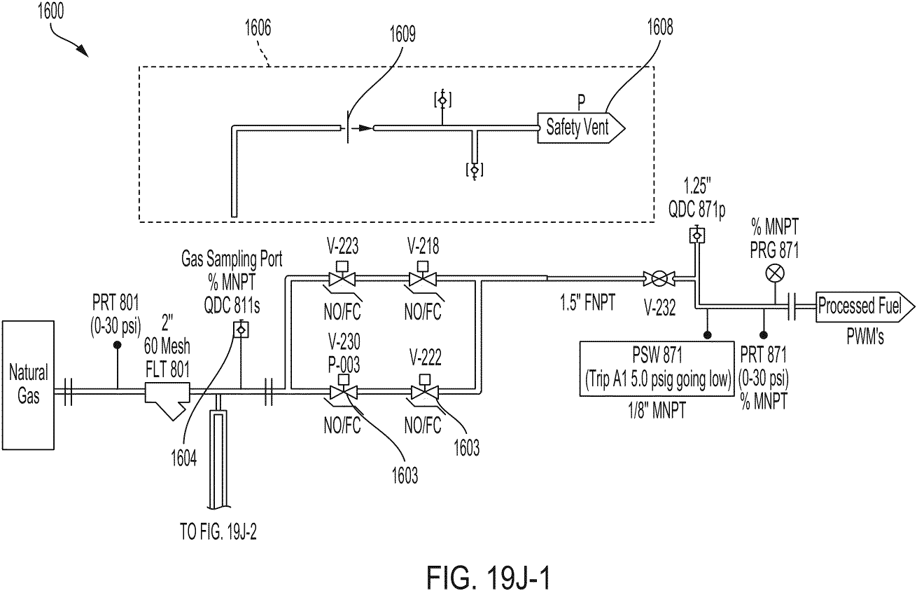

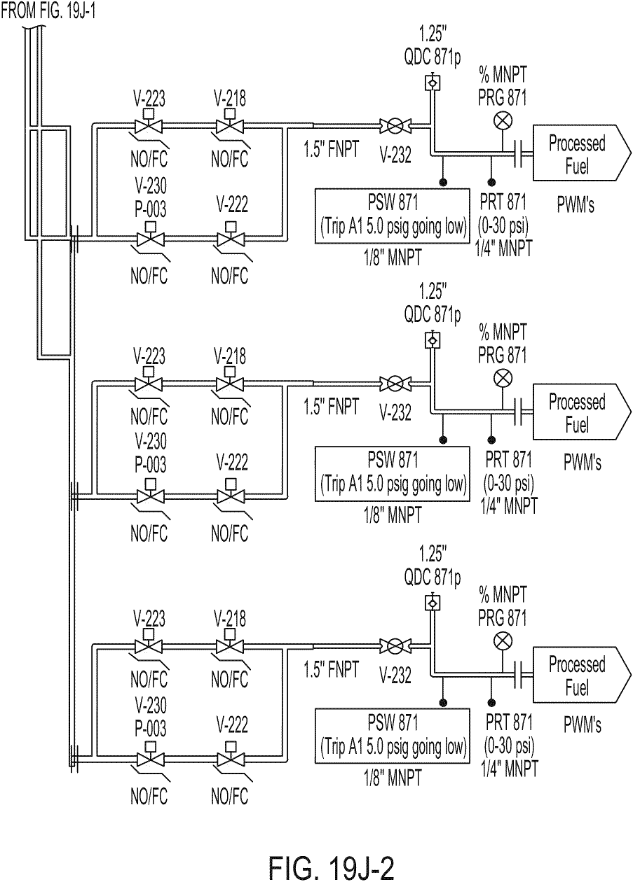

FIGS. 19A1-A3 and 19B1-B3 illustrate a top view of a large site fuel cell system of another embodiment with pre-cast concrete trenches before and after the trenches are filled with the plumbing and the wiring, respectively. FIGS. 19C and 19D are perspective views of the large site fuel cell system of FIGS. 19A1-A3 and 19B1-B3. FIG. FIG. 19E is a schematic side view of components of a gas and water distribution module of FIG. 19C. 19F is a side cross-sectional view of a pad for a module of the large site fuel cell system of FIG. 19D. FIGS. 19G and 19H schematically illustrate a central desulfurization system. FIG. 19I is a perspective partially-transparent view of a gas and water distribution module (GDM). FIGS. 19J1-2 illustrate a flow diagram for a central desulfurization system. All modules described below may be located in a separate housing from the other modules. The system reduces the number of components, and simplifies component installation, thus reducing the total system cost.

The large site fuel cell system contains multiple rows of the above described power modules 12 (labeled PM5). A single gas and water distribution module (GDM) is fluidly connected to multiple rows of power modules. For example, at least two rows of at least six power modules each, such as four rows of seven power modules each, are fluidly connected to the single gas and water distribution module. As shown in FIG. 19E, the single gas and water distribution module GDM may include connections between the above described water and fuel plumbing 230 and the power modules. The connections may include conduits (e.g., pipes) and valves 231F and 231W which route the respective fuel and water from the central plumbing 230 into each power modules. The fuel and water plumbing 230 may include the above described fuel pipes 230A labeled “UG” and the above described water pipes 230B labeled “UW”. The gas and water plumbing 230 may be connected to utility gas and water pipes, respectively. A single system level fuel processing module 16 which includes components for pre-processing of fuel, such as adsorption beds (e.g., desulfurizer and/or other impurity adsorption) beds, may be connected to all gas pipes 230A. Thus, a single desulfurizer may be used to desulfurize natural gas fuel provided to all GDMs in the fuel cell system.

Optionally one or more water distribution modules (WDM) may be provided in the system. The WDM may include water treatment components (e.g., water deionizers) and water distribution pipes and valves which are connected to the municipal water supply pipe, and to the individual modules in the system.

Each row of power modules 12 is electrically connected to a single above described power conditioning module 18 (labeled AC5) which may include a DC to AC inverter and other electrical components. A single mini power distribution module (MPDS) is electrically to each of the power conditioning modules 18 using the above the described wires 232 labeled “UE”. For example, at least two rows of at least six power modules 12 each, such as four rows of seven power modules each, are electrically connected to a single MPDS through the respective power conditioning modules 18, such as four power conditioning modules 18. The MPDS may include circuit breakers and electrical connections between the plural power conditioning modules 18 and one of the system power distribution modules PDS-1 or PDS-2.

One or more telemetry modules (TC) may also be included in the system. The telemetry modules may include system controllers and communication equipment which allows the system to communicate with the central controller and system operators. Thus, four inverters in power conditioning modules 18 and telemetry cables may be connected to the single MPDS. The system also includes the system power distribution unit (i.e., central power supply unit) that feeds the safety systems within the GDMs and also feeds a telemetry ethernet switch (4:1). This reduces the number of power conduits and telemetry conduits installed by an onsite contractor from 4 into 1. Alternatively, a single connection may be used telemetry data transfer. The single cat 5 cable may be replaced with a wireless transceiver unit for data communications between the power conditioning module 18 and the telemetry module TC. This eliminates the data cable installation.

A set of plural rows of the power modules and their respective power conditioning modules fluidly and electrically connected to the same GDM and the same MPDS, respectively, may be referred to as a subsystem. The fuel cell system may include plural subsystems, such as two to ten subsystems. Four subsystems are shown in FIGS. 19A1-A3and 19B1-B3.

The fuel cell system may also include a system power distribution unit which is electrically connected to all subsystems of the fuel cell system using the wires 232 (i.e., “UE”). The system power distribution unit may include at least one system power distribution module, such as two modules PDS-1 and PDS-2, at least one transformer, such as two transformers (XFMR-1 and XFMR-2) and a disconnect switch gear (SWGR). The transformers XFMR-1 and XFMR-2 may be electrically connected to the respective PDS-1 and PDS-2 modules using the wires 232. The switch gear may comprise 15 kV switch gear which has inputs electrically connected to the transformers via the wires 232, and an output electrically connected to an electrical load and/or grid. An optional uninterruptible power subsystem (UPS) may also be included. Thus, electric power is provided from the power modules through the respective MPDS, PDS-1 or PDS-1, XFRM-1 or XFRM-2 and SWGR to the grid and/or load.

As shown in FIG. 19B1 - 19D, the plumbing 230 (e.g., fuel and water pipes) may be provided from the respective utilities (e.g., gas and water pipes) to the respective GDM in each subsystem through pre-cast concrete trenches 1902. Likewise, the wires 232 may be provided between each MPDS and the system power distribution unit through the same pre-cast concrete trenches 1902. The pre-cast concrete trenches 1902 may have a “U” shape with two vertical sidewalls connected by a horizontal bottom wall or horizontal connecting bars. Openings may be provided in the horizontal bottom wall. The pre-cast concrete trenches 1902 are located below grade and are covered with cover plates, dirt, gravel and/or asphalt concrete paving.

As shown in FIGS. 19D and 19F, each module of the system, such as a power module 12 and/or power conditioning module 18 may be installed on a multi-layer support. The multi-layer support is formed on compacted soil 1910. The support includes a cellular concrete (aka concrete foam) base 1912, such as Confoam® cellular concrete base. A conventional (non-cellular) concrete pad 1914 is located on the base 1912. The concrete pad 1914 has a smaller area than the base 1912. U-shaped steel mesh formwork 1916, such as Novoform®, which surrounds a metal rebar cage, is provided on the sides of the concrete pad 1914. The base 1912 supports the bottom of the framework 1916. The top of the concrete pad 1914 is located between 1.5 and 2 inches above finished grade, which may comprise gravel or asphalt concrete paving 1918 located over the base 1912.

As shown in FIG. 19G, the central desulfurization system (e.g., module) 1600 replaces the separate desulfurizers in each row of power modules. The central desulfurization module 1600 is fluidly connected to the GDM, which is fluidly connected to the power modules 12 to provide fuel to the power modules 12. The power modules 12 are electrically connected to the MPDS, which is electrically connected to the electrical load (e.g., the power grid or a stand-alone load) 1901. The central desulfurization system (e.g., module) 1600 is shown in FIG. 19H. The central desulfurization system (e.g., module) 1600 contains one or more vessels 1602 (e.g., columns) filled with a sulfur adsorbent material (e.g., a sulfur adsorber bed). The GDM is shown in FIG. 19I. The GDM distributes fuel to four rows of power modules (which is referred to as a “stamp”).

FIGS. 19J1-J2 illustrate flow diagram for the central desulfurization system 1600. The system 1600 may include a filter at the fuel inlet and two parallel fuel flow paths (e.g., fuel lines, i.e., fuel conduits) to each row of power modules (i.e., “stamp”). Furthermore, there may be two sets of two control valves 1603, such as mass flow control valves, located in parallel fuel flow paths to each “stamp”. Pressure transducers (PRT) may be located on various lines and used to monitor the line pressure and take the necessary action during system operation. A gas sampling port 1604 may also be located on the main inlet line. In one embodiment, the system also includes a separate sulfur breakthrough detection line 1606 (shown in dashed box) which is used to detect sulfur breakthrough. The output of the detection line 1606 may be fluidly connected to a safety vent 1608. A sulfur detection sensor 1609 may be located on the detection line 1606 to detect the presence of sulfur in the fuel that is output from the desulfurization system 1600.

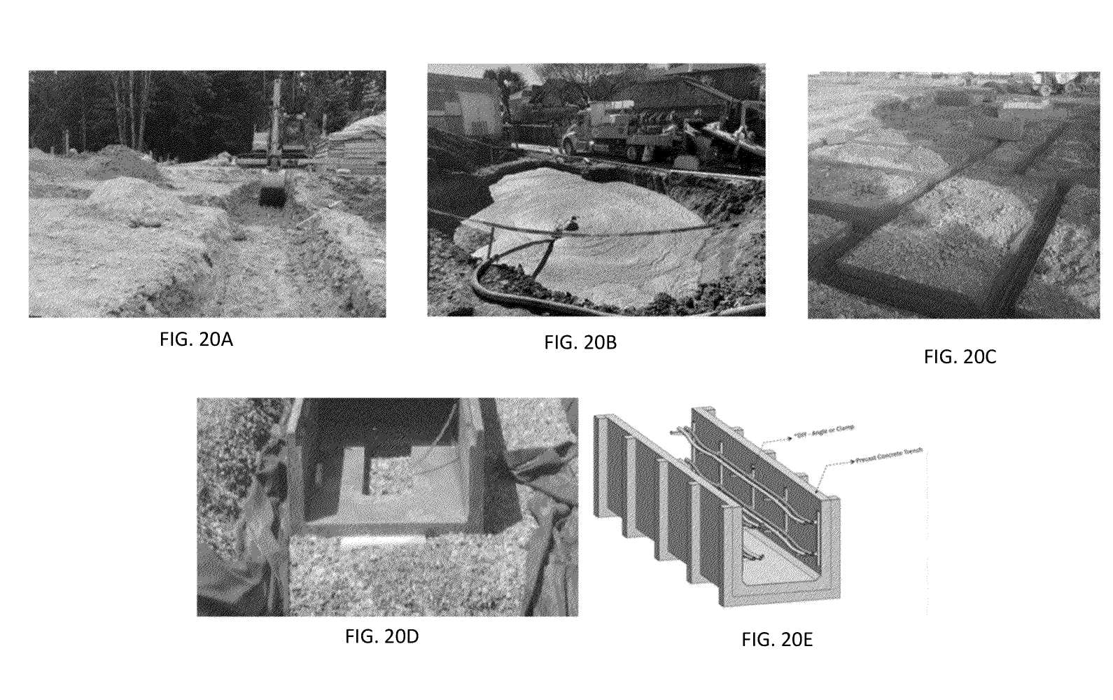

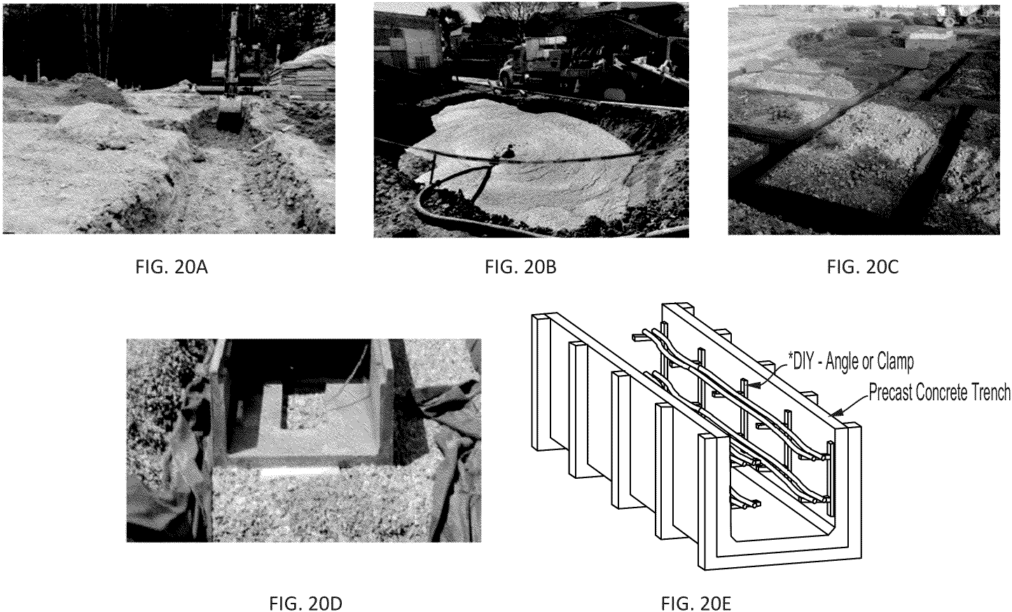

FIGS. 20A to 20E are perspective views of steps in a method of installing the large site fuel cell system of FIG. 19A1 - 19J2.

As shown in FIG. 20A, trenches are formed in the soil and then compacted using heavy machinery, such as an excavator. As shown in FIG. 20B, the cellular concrete base 1912 is filled into the trenches. The cellular concrete comprises a flowable fill material (e.g., foam concrete) which is filled from a pipe or hose and then solidified into the base 1912.

As shown in FIG. 20C, the U-shaped steel mesh formwork 1916 and rebar cage are placed on top of the base 1912. The framework 1916 may include polymer sheets that cover the metal mesh. The concrete pad 1914 is then formed inside the bounds of the framework 1916. The modules are then placed on the concrete pad 1914.

As shown in FIG. 20D, additional trenches are formed outside of the bases 1912. The pre-cast concrete trenches 1902 are then placed into the additional trenches.

As shown in FIG. 20E, the gas pipes 230A, water pipes 230B and wires 232 are then placed into the pre-cast concrete trenches 1902 and connected to the respective GDMs and power components, such as MPDS, PDS-1 and PDS-2. The pipes and wires may be attached or clamped inside the pre-cast concrete trenches 1902 at different vertical levels. The pre-cast concrete trenches 1902 are then covered with cover plates, dirt, gravel and/or asphalt concrete paving.

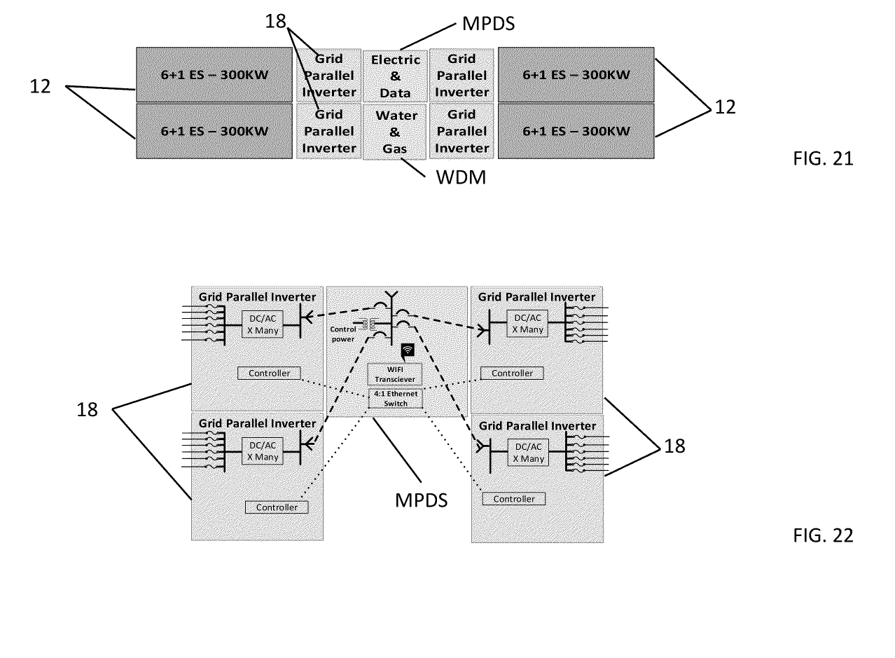

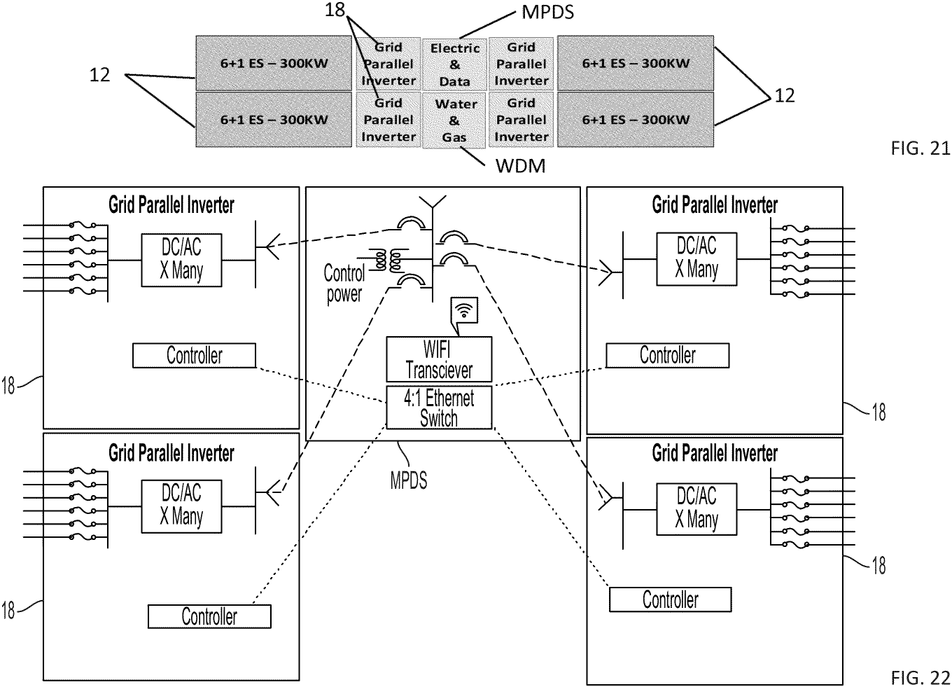

FIG. 21 is a schematic view of one subsystem of the system shown in FIG. 19A1 - 19C. Each row of power modules 12 may comprise a 300 kW Energy Server® fuel cell power generator from Bloom Energy Corporation, labeled “ES”. Thus, the subsystem includes four rows of 300 kW ES for a total of 1200 kW of power. The entire system containing four subsystems can deliver 4800 kW of power. The 1200 kW ES configuration is comprised of 4 x 300 kW ES that all converge the standard power, communication, water and gas interconnects into center sections for common tie-in during the installation process.

The MPDS in FIG. 22 takes advantage of the install proximity in two ways. First, a single electrical tie-in to this module can in turn be distributed to the power conditioning modules 18 by suppling the interconnect cables as part of a site install kit. This reduces the installation from 4 sets of conduits and trenches into one. This configuration also allows omission an output circuit breaker and surge device in each power conditioning module 18 for a total of 4 breakers and 4 surge devices eliminated from the 1200 kW system. Additional beneficial features include the placement of the WIFI transmitter in the MPDS module and its communication interconnects to the separate ES. The WIFI system may service the entire installation and may lead to omission of 4 sets of conduits and wires, which reduces installation cost and complexity. Thus, reduces system and installation can be realized due to the collection of the separate units into the system.

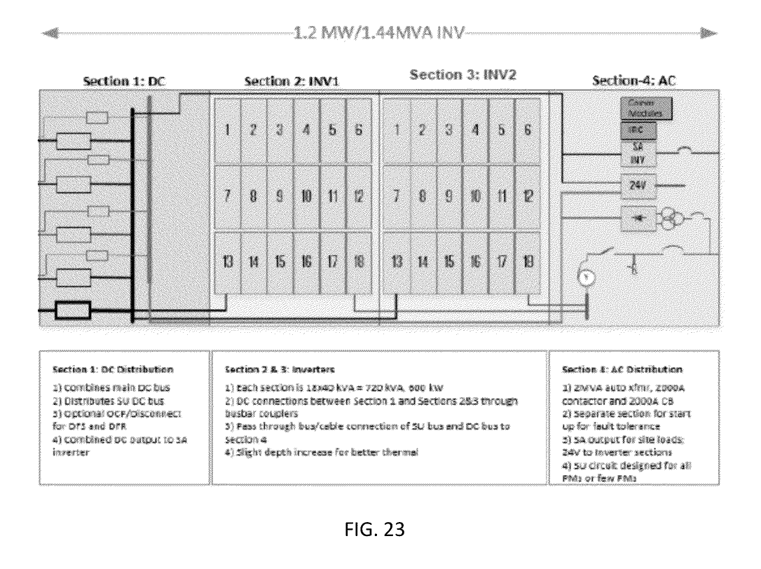

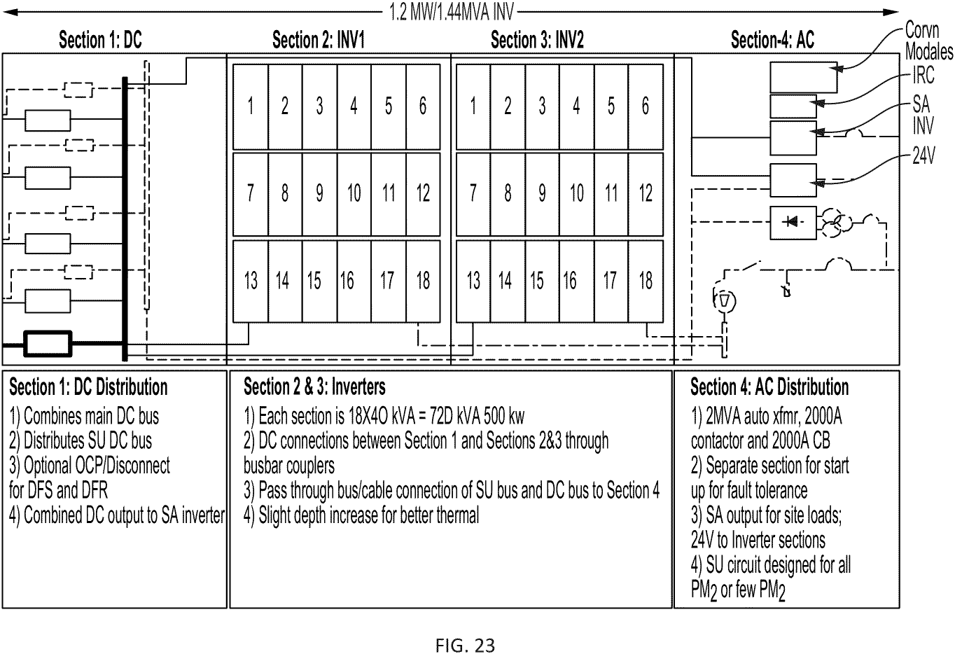

FIG. 23 shows alternative electronics modules according to another embodiment. The configuration in FIG. 23 shows 4 separate cabinets (i.e., housings) with each cabinet being fully populated for a dedicated purpose. The first cabinet is the location for landing the individual power module from the 4 ES while paralleling them on to a common DC bus. This module includes bussing, fuse protection and internal cabling landing locations. This module may support both 50 and 75 kW rated power modules and may include a fully rated interconnection of the collected output DC as an optional means to extend the DC bus to an adjacent 1200 kW system. The center modules 2 and 3 are populated with inverters units only that have large ampacity DC input and AC output. This embodiment may further reduce cost by eliminating the smaller inverter units and making a single monolithic inverter for implementation in the central system power distribution unit. The final module 4 provides further cost savings. This module houses the start-up and safety equipment for the fuel cell power modules. This reduces the quantity of these items from 4 to 1. This further serves as the collected output terminals for the system and the only location provided for external conduit entry.

In one embodiment, each subsystem includes 1200 kW/1200 kVA or 1420 kVA inverter. The subsystem will still retain the individual start-up and safety systems within the grid connected inverters. This will allow an individual safety shutdown within a single 300 kW ES (i.e., row of power modules 12). While a safety shutdown request coming from the GDM will shut down all 4 ES in the subsystem. This results in reduced product costs if the circuit breaker is removed within the 4 grid parallel inverters. The protection that these breakers provide may be moved to the integrated system PDS-1 or PDS-2. Thus, the 4 redundant surge protection devices and safety systems from each subsystem may be consolidated in the central system power distribution unit.

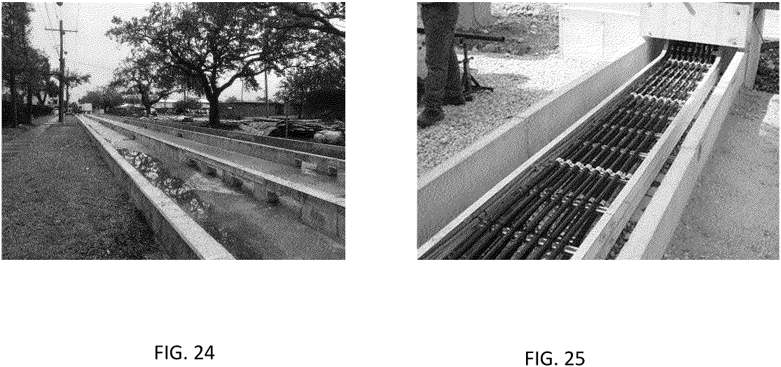

FIGS. 24 and 25 are photographs of concrete curbs and raceways that may be used during the installation of the system of embodiments of the present disclosure. FIG. 24 illustrates concrete curbs which may be used instead of a pre-cast concrete pads. This allows the subsystems to be co-located in one area with a single electrical tie in location. The curbs provides pathways under the modules so that wires 232 and plumbing 230 can be installed on grade as opposed to below grade. This eliminates trench excavation.

Furthermore, excavation and the usage of separate conduits may be reduced or eliminated by using pre-manufactured concrete cable raceways shown in FIG. 25. The raceways may comprise the pre-cast concrete trenches described above with respect to FIGS. 20D and 20E. These can be installed on grade or in simple excavated trenches without the earthwork needed for conduit burial. Lastly, fixed cable raceways and improved site design can predetermine actual conductor lengths allowing pre-manufactured conductor sets for each run of cables from the 1200 kW subsystems to the central electrical gear (i.e., to the system power distribution unit). This improves quality, reduces scrap and labor hours on site. In general, the installation is improved by increased quality, reduced site build time, reduced labor costs (e.g., electrical and plumbing), while still maintaining serviceability with lower overall height of components and simplified rigging.

In conventional electrochemical systems, such as fuel cell power systems and electrolyzer hydrogen generation systems, concrete pads require all items to be rigged and installed individually. Various embodiments are directed to features and applications of fuel cell or electrolyzer systems that are supported by a skid. Various embodiments include fuel cell power systems or electrolyzer hydrogen generation systems, including systems having a unitary (referred to as “classic”) system layout or a modular system layout, and which utilize a skid for installation cost and cycle time reduction. Such systems may be referred to as “Packaged Energy Servers (PESs).” Various embodiments include PES systems and methods of installing PES systems.

The Packaged Energy Server (PES) may comprise a completed fuel cell power or electrolyzer system that may be deployed to a site. Various embodiments of a PES supported by a skid may reduce installation costs and cycle times, and enable quick deployments and/or temporary deployments of fuel cell systems. In one embodiment, a skid contains a single deck (e.g., metal deck) which rests on pedestals (e.g., metal rails) that are connected to the deck. The deck of the skid supports the fuel cell or electrolyzer cabinets.

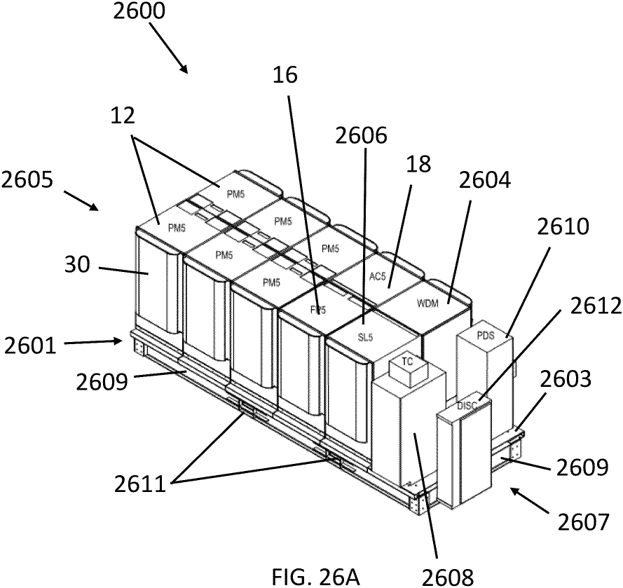

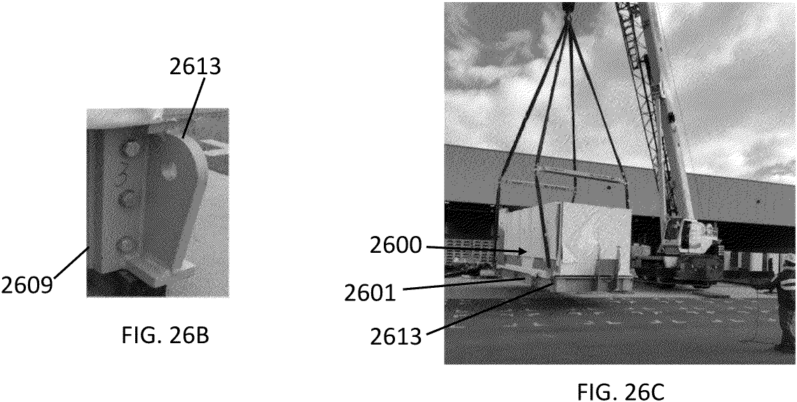

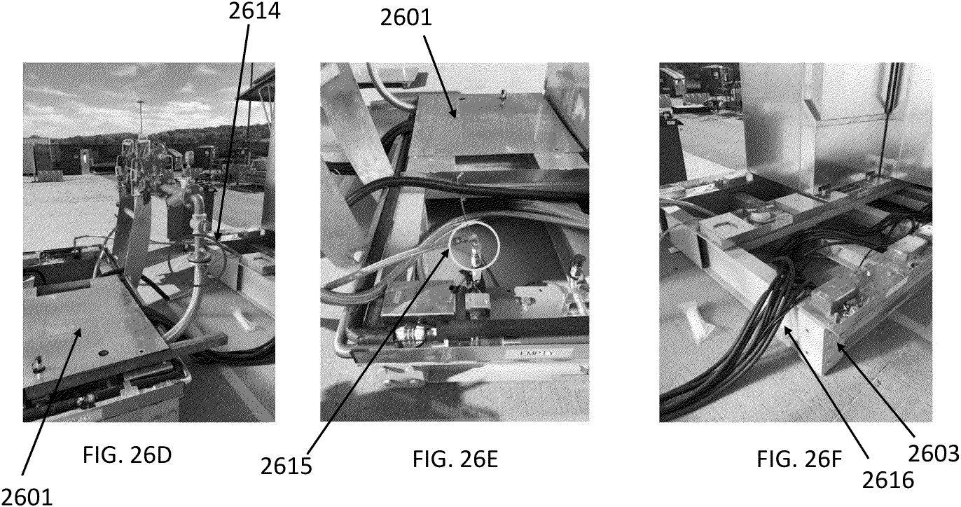

FIG. 26A is a perspective view showing a fuel cell power system 2600 including a plurality of modules located on a skid 2601. The system 2600 may include one or more power modules 12 (labeled PM5 in FIG. 26A), one or more fuel processing modules 16 (labeled FP5 in FIG. 26A) and one or more power conditioning modules 18 (labeled AC5 in FIG. 26A), which may be disposed on the same skid 2601. The system 2600 may further include doors 30 to access the modules 12, 16, 18. Alternatively, the system 2600 may comprise an electrolyzer system containing electrolyzer modules, water distribution module and power module located on the same skid.

The power modules 12 may be disposed in a back-to-back configuration. In particular, the power modules 12 may be disposed in parallel rows. A fuel processing module 16 and a power conditioning module 18 may be disposed in a back-to-back configuration at the ends of the respective rows of power modules 12.

The system 2600 may also include additional ancillary equipment. The ancillary equipment may include one or more additional modules, such as a water distribution module (WDM) 2604. The WDM 2604 may include water treatment components (e.g., water deionizers) and water distribution pipes and valves which may be connected to a water supply (e.g., a municipal water supply pipe), and to the individual modules in the system 2600. The ancillary equipment of the system 2600 may also include a step load module 2606 (labeled SL5 in FIG. 26A). The step load module 2606 may include storage components, such as batteries and/or ultracapacitors, which may support the power system in meeting step load changes. The WDM 2604 and the step load module 2606 may be disposed in a back-to-back configuration adjacent to the power conditioning module 18 and the fuel processing module 16, respectively.

In some embodiments, the ancillary equipment of the system 2600 may additionally include a telemetry cabinet 2608 (labeled TC in FIG. 26A) that may include system controllers and communication equipment that enables the system 2600 to communicate with a central controller and/or system operators. In some embodiments, the ancillary equipment of the system 2600 may also include a power distribution system 2610 (labeled PDS in FIG. 26A) that may control power distribution to various components located on and/or off of the skid 2601. In some embodiments, the ancillary equipment of the system 2600 may also include a disconnect system 2612 (labeled DISC in FIG. 26A), such as a disconnect switchgear, that may be configured to protect, isolate and de-energize components of the system 2600 in the event of a fault condition and/or for maintenance purposes. In some embodiments, the disconnect system 2612 may be combined with or substituted with a backup power supply (BPS). A disconnect/BPS system on-board the skid 2601 may allow for quick and easier installation as a disconnect/BPS does not have to be set during construction.

In some embodiments, power distribution, telemetry and disconnect/BPS functions may be combined in a single unit (e.g., an electrical distribution system (“EDS”) unit) that may be located on or attached to the skid 2601. In some embodiments, the EDS unit may include a single cabinet or housing disposed on the skid 2601. This may allow for further skid footprint reduction, and may provide for a quicker and cheaper installation because the equipment for power distribution, telemetry and disconnect/BPS functionality does not need to be set separately during construction.

The skid 2601 may have a generally rectangular shape. However, other horizontal shapes may also be used. In some embodiments, the skid 2601 may have a length dimension that is at least about 8 feet, such as between 10 and 40 feet, including between 20 and 25 feet. The skid 2601 may have a width dimension that is at least about 4 feet, such as between 5 and 15 feet, including between 7 and 10 feet. The skid 2601 may include an upper surface, which may also be referred to as a deck 2603, on which the power modules 12, fuel processing module 16, power conditioning module 18, and optional ancillary equipment may be supported. In some embodiments, the power modules 12 may be located adjacent to a first side 2605 of the skid 2601, and ancillary equipment of the system 2600 (e.g., step load module 2606, WDM 2604, telemetry cabinet 2608, power distribution system 2610, disconnect system/BPS 2612, etc.) may be located adjacent to a second side 2607 of the skid 2601 that is opposite the first side 2605. For convenience the first side 2605 of the skid 2601 may be referred to as the “rear” side 2605 of the skid 2601, and the second side 2607 of the skid 2601 may be referred to as the “front” side 2607 of the skid 2601. As noted above, parallel rows of power modules 12 may be disposed on the deck 2603 and may extend along the length of the skid 2601 from the rear side 2605 towards the front side 2607 of the skid 2601. The fuel processing module 16 and power conditioning module 18 may be disposed in a back-to-back configuration on the deck 2603 between the power modules 12 and the ancillary equipment. The step load module 2606 and the WDM 2604 may be disposed in a back-to-back configuration on the deck 2603 adjacent to the fuel processing module 16 and the power conditioning module 18, respectively. The telemetry cabinet 2608, power distribution system 2610, and disconnect system/BPS 2612 may be located proximate to the front side 2607 of the skid 2601. In some embodiments, the telemetry cabinet 2608 and power distribution system 2610 may be disposed on the deck 2603, and the disconnect system/BPS 2612 may be mounted to the front side 2607 of the skid 2601.

While the system 2600 is shown to include two rows of three power modules 12 on a skid 2601, the present disclosure is not limited to any particular number of power modules 12 on the skid 2601. For example, the system 200 may include 2-30 power modules 12, 4-12 power modules 12, or 6-12 power modules 12 on the skid 2601, in some embodiments. In other words, the system 2600 may include any desired number of power modules 12 on the skid 2601. In some embodiments, the power modules 12 may be disposed as a pair of rows of power modules 12 in a back-to-back configuration on the skid 2601. Alternatively, a single row of power modules 12, or more than two rows of power modules 12, may be located on the skid 2601. In addition, the positions of the fuel processing module 16 and the power conditioning module 18 on the skid 2601 may be reversed, and/or the modules 16, 18 may be disposed on either end of the skid 2601. Further, in various embodiments, some or all of the auxiliary equipment 2604, 2606, 2608, 2610 and 2612 may either be omitted from the system 2600 or located off the skid 2601.

Further, although the fuel cell power system 2600 has been described above as including a modular system layout, it will be understood that various embodiments may include a fuel cell power system 260 having a unitary system layout (also referred to as a “classic” system layout) disposed on a skid 2601. In such a unitary system layout, one or more of the modules 12, 16 and 18 may not be able to be disconnected and removed from the system 2600 without requiring the entire system 2600 to be shut down and/or removed.

Further embodiments include electrolyzer systems disposed on a skid 2601. An electrolyzer system may be used for hydrogen generation. One or more electrolyzer modules, which may be similar to the power modules 12 shown in FIG. 26A, may be disposed on the deck 2603 of a skid 2601. Each electrolyzer module may include a housing or cabinet that is configured to house one or more hot boxes 13 (see FIG. 1). Each hot box 13 of an electrolyzer module may contain at least one electrolyzer cell stack including multiple solid oxide electrolyzer cells (SOECs). Each electrolyzer module may contain additional components, such as a steam recuperator, a steam heater, an air recuperator and/or an air heater that may be located inside or outside of a hot box 13. During operation, the at least one electrolyzer cell stack may be provided with steam and electric current or voltage from an external power source. In particular, the steam may be provided to the fuel electrodes of the electrolyzer cells of the stack, and the power source may apply a voltage between the fuel electrodes and the air electrodes of the electrolyzer cells, in order to electrochemically split water molecules and generate hydrogen (e.g., H₂) and oxygen (e.g., O₂). Air may also be provided to the air electrodes, in order to sweep the oxygen from the air electrodes. As such, the stack may output a hydrogen stream and an oxygen-rich exhaust stream. The hydrogen stream may be used as a hydrogen fuel source and/or provided to a hydrogen storage system for later use. Additional supporting equipment for the electrolyzer module(s) may be located on the skid 2601. In some embodiments, a combined fuel cells power and electrolyzer hydrogen generation system (i.e., the PES system) may include at least one power module and at least one electrolyzer module disposed on a skid 2601 for cogeneration of electric power and hydrogen.

Referring again to FIG. 26A, the deck 2603 of the skid 2601 may be supported above the ground by a plurality of support pedestals 2609 that are connected to the deck 2603. The support pedestals 2609 may include a network of rail structures, such as metal (e.g., steel) rails, such as I-beams, that may be connected together (e.g., via mechanical fasteners, such as bolts, and/or welded together) to provide a suitably strong support base. As shown in FIG. 26A, the support pedestals 2609 may extend around the periphery of the skid 2601. Additional support pedestals 2609 (not visible in FIG. 26A) may extend across the skid beneath the deck 2603. At least some of the support pedestals 2609 may include fork pockets 2611 for the insertion of the prongs of a forklift for transport, installation and/or removal of the system 2600. The skid 2601 may additionally include lift points for a crane, such as lift hooks. FIG. 26B illustrates a lift hook 2613 attached to a support pedestal 2609 of a skid 2601, and FIG. 26C illustrates a fuel cell power system 2600 being lifted by a crane via lift hooks 2613. In some embodiments, the system 2600 may be transported to or from an installation site on a flatbed truck over standard roadways, on standard gauge railway cars and/or via shipping containers. The system 2600 including the skid 2601 may be fully factory assembled and tested prior to deployment to the installation site, which may enable significantly faster and cheaper installations.

The skid 2601 may additionally include connections to an external water supply and/or an external fuel supply, and may further include one or more electrical connections to an external load and/or an electrical grid. FIG. 26D shows a fuel (i.e., gas fuel such as natural gas, biogas, propane, hydrogen, etc.) connection 2614 to a skid 2601, FIG. 26E illustrates a water connection 2615 to the skid 2601, and FIG. 26F shows electrical cables 2616 exiting the skid 2601. The skid 2601 may additionally include plumbing for water and fuel as well as wiring (e.g., electrical cables, bus bar(s), etc.) between various modules and other components of the system 2600. Plumbing and wiring may be located within recesses and/or openings within the skid 2601. In various embodiments, recesses and/or openings for plumbing and wiring may be located in the deck 2603 of the skid 2601, in the support pedestals 2609 of the skid 2601, and/or within clearances between the deck 2603 and support pedestals 2609. In some embodiments, the deck 2603 of the skid 2601 may be configured with features and/or components that are similar or identical to any of the pads 210, 211, 215, 410, 415, 415A, 510, 560, 615, 1000, 1400, 1500, and 1600 and/or pad sections 800, 900, 1510, 1610 and 1700 described above with reference to FIGS. 2-17. In some embodiments, the upper surface of the deck 2603 may be substantially planar, e.g., does not include recesses or other features for the plumbing and/or wiring and/or for installation of the modules 12, 16, 18, 2604, 2606, 2608 and/or 2610 supported on the deck 2603. In some embodiments, one or more overlay structures may be located over the upper surface of the deck 2603 that may provide a space or separation between the upper surface of the deck 2603 and the lower surface of the modules 12, 16, 18, 2604, 2606, 2608 and/or 2610 supported on the deck 2603. The plumbing and electrical connections may extend within the space between the upper surface of the deck 2603 and the lower surface of the modules 12, 16, 18, 2604, 2606, 2608 and/or 2610. The overlay structures may include, for example, the above-described frames 1014 configured to receive the modules, and the above-described separators 1012 configured to separate the frames 1014 from the upper surface of the deck 2603, as described above with reference to FIGS. 13A and 13B. Alternatively, or in addition, the overlay structures may include the above-described replicators 1420 that may form elevated structures for supporting the modules, as described above with reference to FIG. 14. Other suitable overlay structures are within the contemplated scope of the present disclosure. The overlay structures may be attached to the upper surface of the deck 2603 using suitable mechanical fasteners.

In some embodiments, all inter-skid connections may be made and optionally tested at the factory, which may enable faster system installation. Field connections to external fuel, water and/or power systems may be easily and rapidly made at the installation site, and may be made from either above-ground or below ground connections.

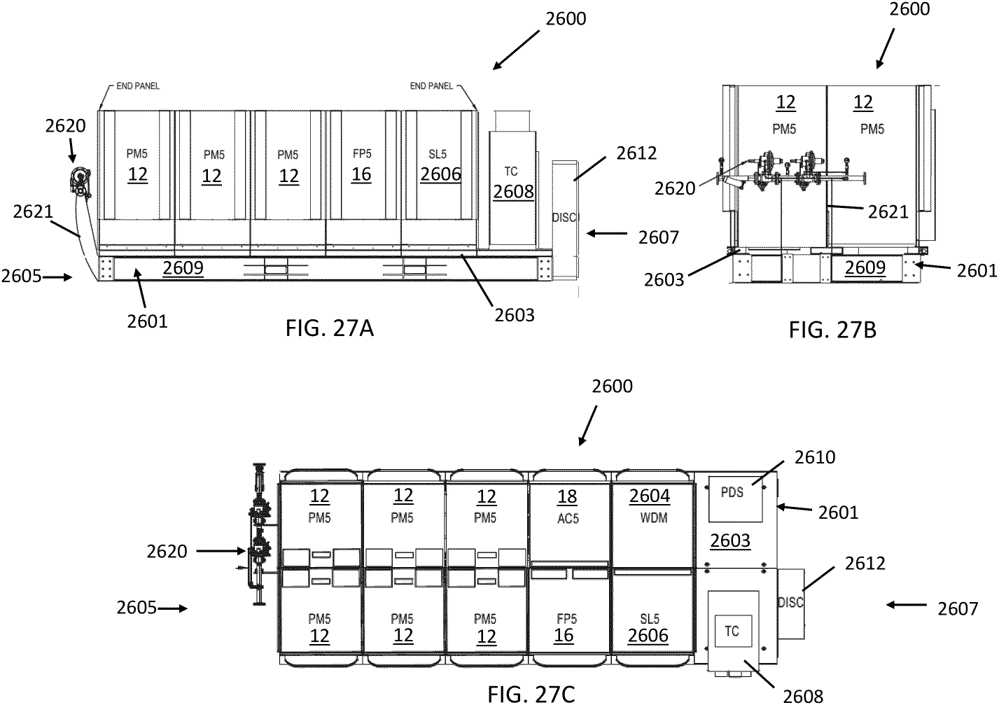

FIGS. 27A, 27B and 27C are side, rear, and top views, respectively, of a skid-mounted fuel cell power system 2600 according to an embodiment of the present disclosure. The fuel cell power system 2600 shown in FIGS. 27A-27C has a substantially similar configuration as the system 2600 previously described with reference to FIG. 26A, and thus repeated discussion of common elements is omitted for brevity. In the embodiment shown in FIGS. 27A-27C, the system 2600 additionally includes a fuel injector/regulator apparatus 2620, such as an RSA^{®} fuel injector system, mounted to the skid 2601. The fuel injector/regulator apparatus 2620 may be mounted to the rear side 2605 of the skid 2601 via one or more bracket members 2621, such that the fuel injector/regulator apparatus 2620 may be raised above ground-level and laterally-spaced away from the adjacent power modules 12. A fuel inlet conduit (not shown in FIGS. 27A-27C) coupled to an external fuel source (e.g., natural gas pipe, fuel tank, fuel cylinder, etc.) may be connected to an inlet of the fuel injector/regulator apparatus 2620 and a fuel outlet conduit (not shown in FIGS. 27A-27C) may be coupled to an outlet conduit of fuel injector/regulator apparatus 2620 for providing fuel to the modules 12 and 16 of the system 2600. In various embodiments, providing an on-board fuel injector/regulator apparatus 2620 that is pre-mounted (e.g., using bracket member 2621) to the skid at the factory may allow for quick and easier installation as a fuel injector/regulator apparatus 2620 does not have to be set during construction.

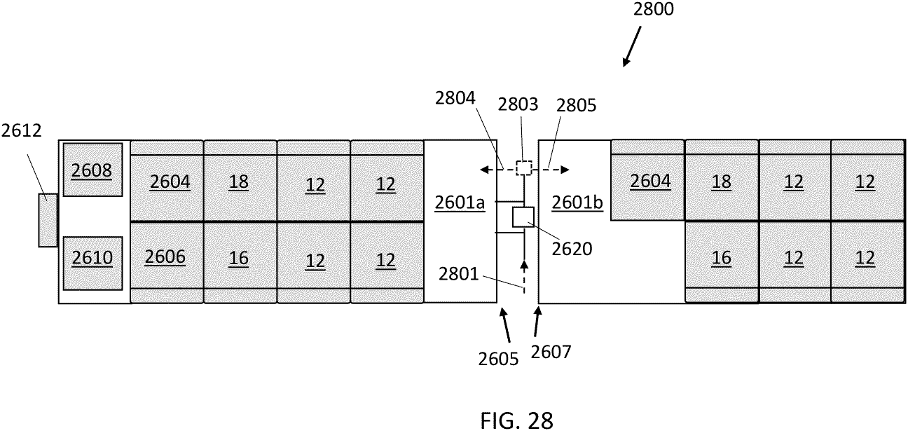

A fuel cell power and/or a electrolyzer hydrogen generation system may include multiple skids 2601. FIG. 28 illustrates a top view of an embodiment of a fuel cell power system 2800 that includes fuel cell power generation components on a pair of skids 2601a and 2601b located adjacent to one another. Although the embodiment shown in FIG. 28 includes two skids 2601a and 2601b, it will be understood that a power system 2800 may include any number of skids. The skids 2601a, 2601b may have any convenient layout. The skids 2601a and 2601b in FIG. 28 have an in-line layout in which the rear side 2505 of a first skid 2601a faces the front side 2507 of the second skid 2601b. Alternatively, the skids 2601a, 2601b of the system 2800 may be laterally arranged in a front-to-front, a back-to-back and/or a side-by-side configuration. The skids 2601a, 2601b of the system 2800 may be oriented parallel to one another, perpendicular to one another, and/or at oblique angles relative to one another. In some embodiments, a plurality of skids 2601a, 2601b may be vertically stacked on top of one another in a tower or stacking configuration. This may enable increased power density per area. In some embodiments, one or more skids 2601a, 2601b may be placed on the roof of a pre-existing building or structure. Each skid 2601a, 2601b of the system 2800 may have individual connections to external (e.g., utility) water and/or fuel supplies, and may have separate electrical connections to an external load and/or an electrical grid. Alternatively, inter-skid connections may enable water, fuel and/or power to be shared between multiple skids 2601a, 2601b. The skids 2601a, 2601b of the system 2800 may have the same size or may have different sizes. The different skids 2601a, 2601b of the system 2800 may have identical components mounted to each skid 2601a, 2601b, or may have different components mounted to the respective skids 2601a, 2601b.

In the embodiment shown in FIG. 28, a single fuel supply line 2801 may be connected to the inlet of a fuel injector/regulator apparatus 2620 mounted to the first skid 2601a. A splitter 2803 coupled to the outlet of the fuel injector/regulator apparatus 2620 may direct portions of the fuel flow to the respective skids 2601a and 2601b, as indicated by arrows 2804 and 2805. Thus, the second skid 2601b lacks a separate fuel injector/regulator apparatus 2620, which decreases system costs.

In addition, some or all of the ancillary equipment for the system 2800 may be located on one or more skids 2801a, but may not be located on other skid(s) 2801b of the system 2800 to further decrease system cost and complexity. In the embodiment shown in FIG. 28, for example, the first skid 2801a includes four power modules 12, a fuel processing module 16, a power conditioning module 18, a WDM 2604 in addition to a step load module 2606, a telemetry cabinet 2608, a power distribution system 2610, and disconnect system/BPS 2612. The second skid 2601b also includes four power modules 12, a fuel processing module 16, a power conditioning module 18, and a WDM 2604, but does not include a step load module 2606, a telemetry cabinet 2608, a power distribution system 2610, or a disconnect system/BPS 2612. Instead, the ancillary equipment on the first skid 2601a is electrically connected (using wired and/or wireless connections) to the modules located on the second skid 2601b. Various configurations and distributions of the different components of a multi-skid fuel cell system 2800 are within the contemplated scope of disclosure.

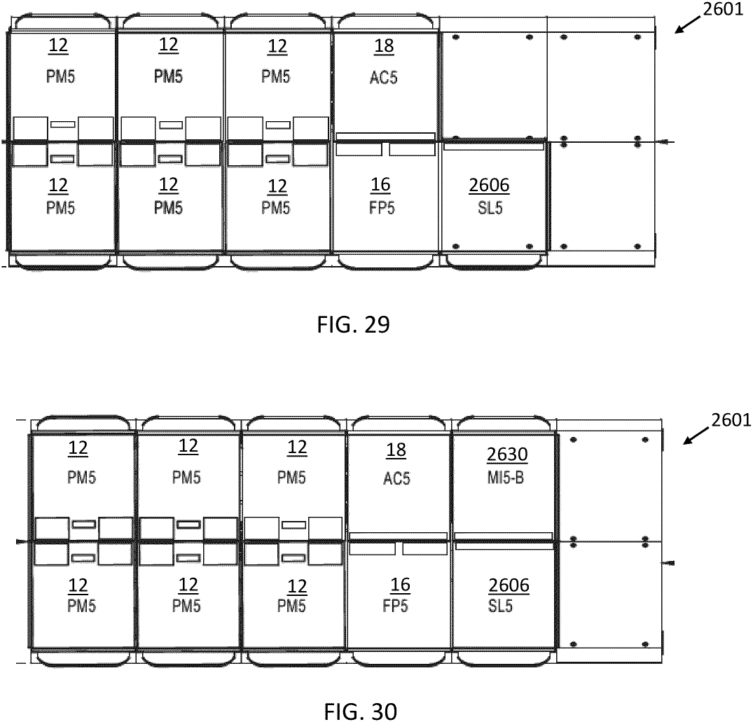

FIGS. 29 and 30 illustrate various arrangements of fuel cell power system components disposed on a skid 2601, according to embodiments of the present disclosure. FIG. 29 illustrates a skid 2601 having six power modules 12, a fuel processing module 16, a power conditioning module 18, and a step load module 2606 disposed on the skid 2601.

FIG. 30 illustrates a skid 2601 having six power modules 12, a fuel processing module 16, a power conditioning module 18, a step load module 2606 and a microgrid inverter module 2630 (labeled MI5-B in FIG. 30) disposed on the skid 2601. The microgrid inverter module 2630 may enable supply of constant, stable grid-independent power to microgrid loads, such as during electric power grid outages and flicker events.

A fuel cell power and/or an electrolyzer hydrogen generation system having one or more skids 2601 may be installed on both hardscape (e.g., concrete, asphalt, etc.) and softscape (e.g., vegetation, soil, etc.) environments. In various embodiments, minimal site preparation may be required prior to installation. In non-level environments, such as in a location having slope greater than ~2°, one or more shims may be provided under the skid 2601 to provide a substantially level deck 2603 for supporting the various components of the fuel cell power and/or electrolyzer hydrogen generation system. In some embodiments, outriggers or similar stabilizers may be provided to increase the stability of the skid 2601, such as in sites having high wind or seismic activity. An anchoring system, such as one or more earth anchors and/or concrete anchors may be used to anchor the system to the ground.

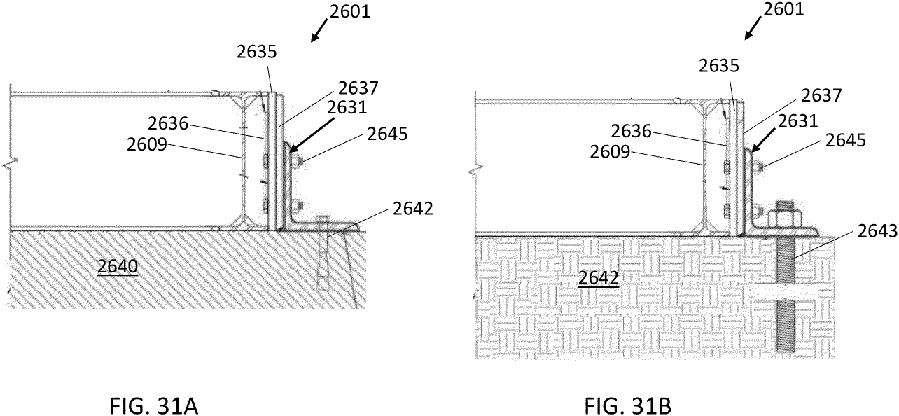

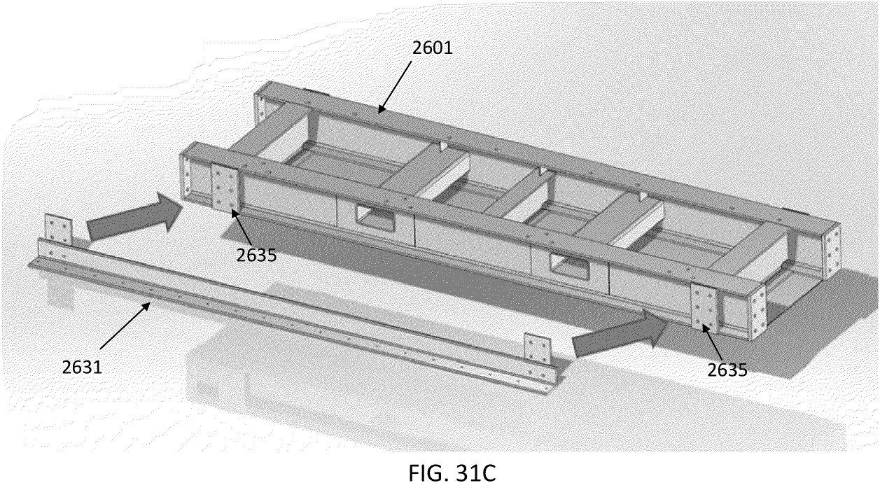

In some embodiments, L-brackets may be used to secure the system to the install location. The use of L-brackets may be advantageous in situations where space is limited (e.g., the site location is next to a building, walkway or other structure) and/or to improve access to and serviceability of the system. L-bracket stabilizers may also be used to install multiple skids adjacent to one another. FIGS. 31A and 31B illustrate exemplary embodiments of a skid 2601 mounted to a ground surface using L-brackets 2631. In the embodiment shown in FIG. 31A, the ground surface may be a concrete surface 2640, and in the embodiment shown in FIG. 31B the ground surface may be an asphalt surface 2642 over compacted soil. The L-bracket 2631 may be placed against a mounting surface 2635 of a support pedestal 2609 of the skid 2601. Optional stiffening members 2636, 2637 (e.g., steel plates) may be placed interior and exterior of the mounting surface 2635 in the location where the L-bracket 2631 is to be attached. Mechanical fastening members 2645 (e.g., bolt and nut pairs) may be placed through the mounting surface 2635, the optional stiffening members 2636, 2637 and the vertical part of the L-bracket 2631 to secure the L-bracket 2631 to the support pedestal 2609. In the embodiment shown in FIG. 31A, a concrete expansion anchor 2642 may be placed through the lower part of the L-bracket 2631 into the ground surface 2640. In the embodiment shown in FIG. 31B, an earth anchor 2643 may be placed through the L-bracket 2631 into the ground surface 2642. A plurality of L-brackets 2631 may be attached along the sides of the skid 2601 to secure the skid 2601 to the ground surface. FIG. 31C is a perspective view of a skid 2601 and an L-bracket 2631 illustrating how the L-bracket 2631 may be attached to mounting surfaces 2635 on the side of the skid 2601.

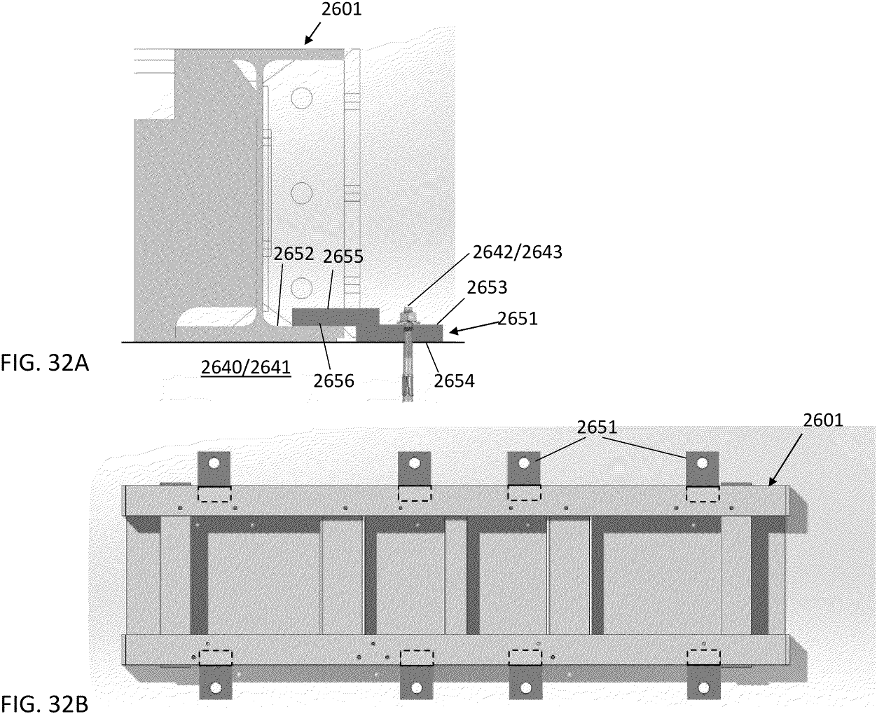

Alternatively, or in addition, one or more Z-brackets may be used to secure the system to the install location. The Z-brackets may be anchored to the ground and may press down on a surface of the skid 2601 such that the skid 2601 may be constrained in all degrees-of-freedom. FIG. 32A is a side view showing a Z-bracket 2651 clamped against a flange surface 2652 of a skid 2601. The Z-bracket 2651 may include a first portion 2653 having a flat lower surface 2654 that may be located on the ground 2640/2641, and a second portion 2655 including a lower surface 2656 that is elevated with respect to the lower surface 2654 of the first portion 2653. The first portion 2653 of the Z-bracket may be anchored to the ground 2640/2641 using an earth anchor 2643 or concrete expansion anchor 2642, as described above with reference to FIGS. 31A and 31B. The anchor 2642/2643 may be torqued against the upper surface of the first portion 2653 of the Z-bracket 2651, causing the lower surface 2656 of the second portion 2655 to clamp against the flange surface 2652 of the skid 2601. In various embodiments, one or more Z-brackets 2651 may secure the skid 2601 to the ground without being bolted or otherwise fastened to the skid 2601. FIG. 32B is a top view of a skid 2601 illustrating a plurality of Z-brackets 2651 around the outer periphery of the skid 2601. The dashed lines in FIG. 32B indicate the locations in which the Z-brackets 2651 bear on a flange surface of the skid 2601.

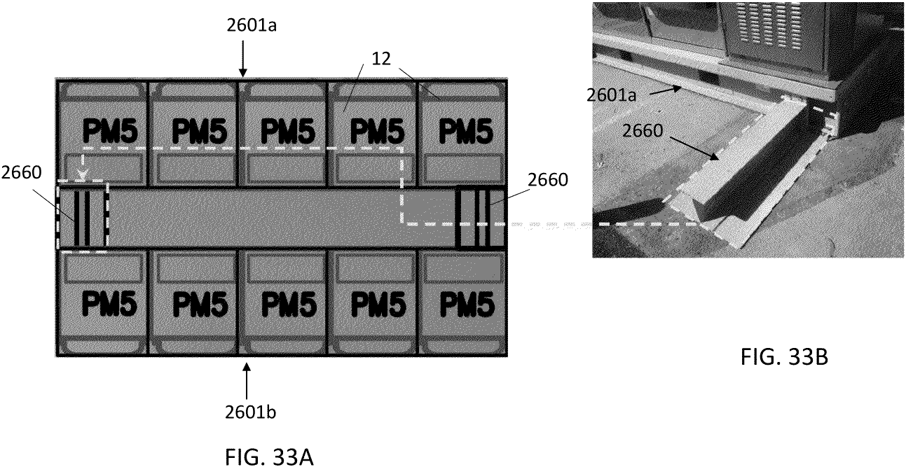

In some embodiments, additional stability may be provided to a system by utilizing a multi-skid configuration including one or more outriggers extending between the skids 2601. FIG. 33A is a top schematic view of a fuel cell power system including a plurality of fuel cell power modules 12 (labeled PM5) arranged in parallel rows. Each of the rows of modules PM5 may be located on a separate skid 2601a, 2601. Although the embodiment of FIG. 33A illustrates a single row of fuel cell power modules 12 on each skid 2601a, 2601b, it will be understood that the each of the skids 2601a, 2601b may include more than two rows of modules and/or may include different types of modules (e.g., fuel cell power modules, electrolyzer modules, fuel processing modules 16, power conditioning modules 18, etc.). One or more outriggers 2660 may be attached to and extend between the pair of adjacent skids 2601a and 2601b. Each of the outriggers 2660 may be a wide-flange beam that may be mounted (e.g., bolted) to a side of each skid 2601a, 2601b, as shown in the photograph of FIG. 33B. In the embodiment of FIG. 33A, the outriggers 2660 may include mounting plates on either side that enable the outriggers 2660 to be mounted to a pair of skids 2601a, 2601b to provide increased stability as needed, such as in sites having high wind or seismic activity.

Further embodiments are directed to docking stations for skid-mounted fuel cell power and/or a electrolyzer hydrogen generation systems. In some embodiments, a docking station may include a housing or enclosure at an installation site that provides protection of various external connections (e.g., utility stubs) to the skid-mounted system. The docking station may be a fixed installation at a site. A skid-mounted power and/or electrolyzer system may be transported to the site and placed proximate to the docking station to enable easy and reliable hook-up of the system to any required external connections. The docking station may provide a single point-of-connection between the fixed infrastructure of a site, such as fuel (e.g., natural gas) supply, water supply, and the site’s electrical system, and the skid-mounted power and/or electrolyzer system. A docking station may allow for a site owner to prepare the connections for docking of a skid-mounted system and may provide and aesthetically acceptable stub up of utilities. The use of a docking system may facilitate easy deployment of skid-mounted power and/or electrolyzer systems as needed, including swap-out of entire systems or components of systems, as well as expansion or reduction of capacity by adding or removing skid(s) on an as-needed basis.

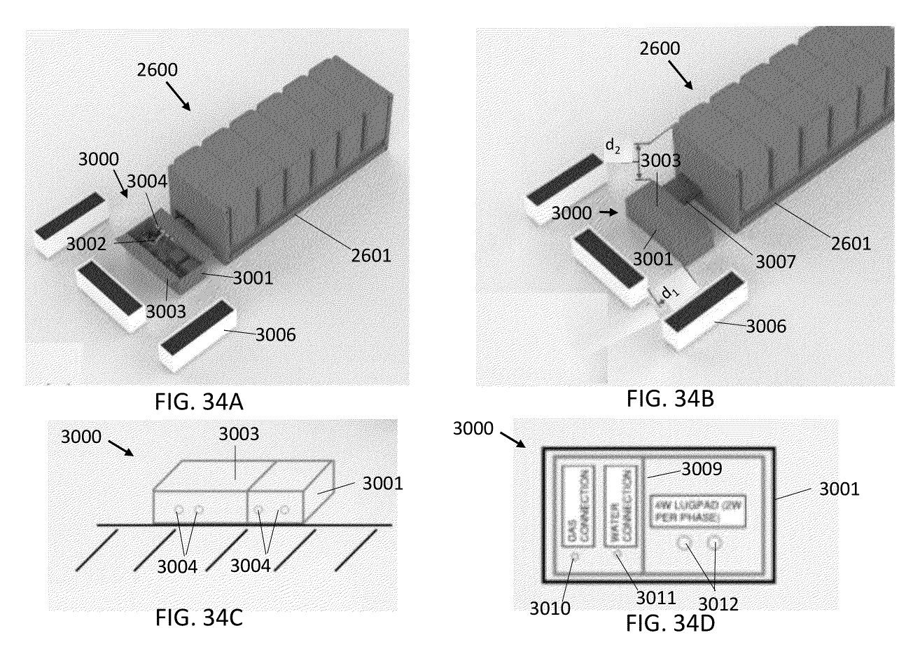

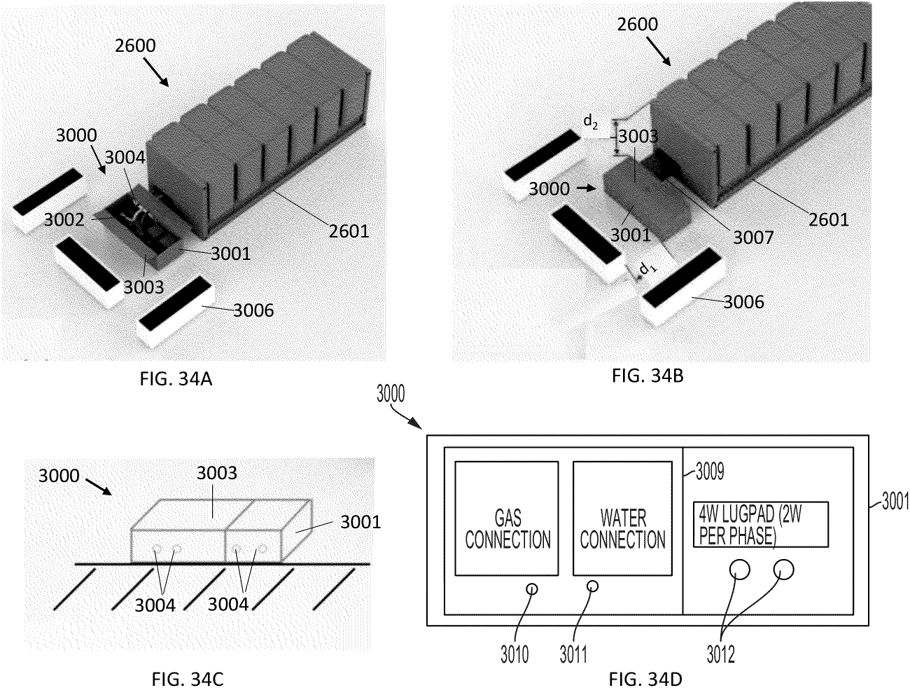

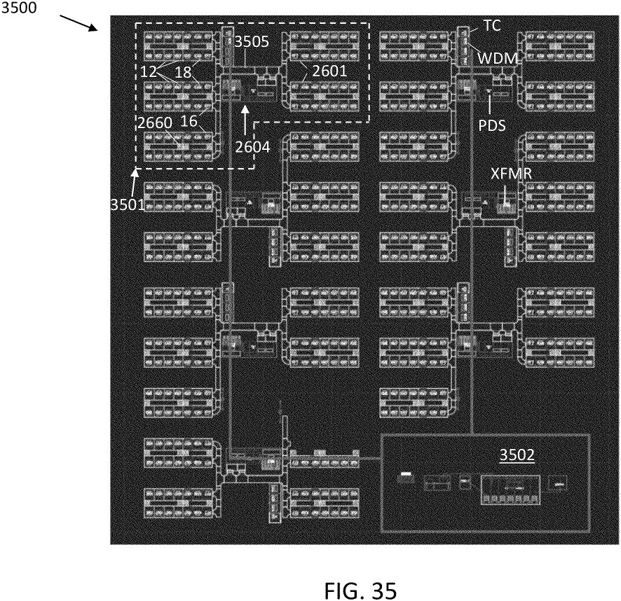

FIGS. 34A and 34B are perspective views of a docking station 3000 for a skid-mounted fuel cell power system and/or electrolyzer system 2600 according to an embodiment of the present disclosure. The docking station 3000 may include a housing 3001 having a lid or door 3003 that may be opened to provide access to the interior of the housing 3001. In embodiments, the lid or door 3003 may be locked when in a closed position to prevent unauthorized access to the interior of the housing 3001. The housing 3001 may be constructed of a suitable structural material, such as steel, and may have a rectangular prism shape as shown in FIGS. 34A and 34B. Other materials and shapes for the housing 3001 are within the contemplated scope of disclosure. The housing 3001 may include an opening 3004 (e.g., a cutout portion) on a side surface of the housing 3001 facing the skid 2601. Utility connections 3002 (e.g., water, fuel and/or electric connections) between the docking station 3000 and the skid-mounted system 2600 may be made through the opening 3004. In the embodiment shown in FIGS. 34A and 34B, a plurality of cables and/or fluid conduits 3002 may extend from the interior of the housing 3001 through the opening 3004 to the skid-mounted system 2600. As shown in FIG. 34B, the cables and/or fluid conduits 3002 may be located in a protective outer conduit or chase 3007 extending between the docking system 3000 and the system 2600. In some embodiments, protective barriers 3006 may be located around the docking system 3000. The docking system 3000 may be provided with a minimum lateral clearance d₁ and vertical clearance d₂ around the docking system 3000.

FIG. 34C is a perspective view of a docking system 3000 according to another embodiment. In the embodiment shown in FIG. 34C, the housing 3001 of the docking system 3000 may have a plurality of openings 3004. In one non-limiting example, a first opening 3004 may be used to provide a water connection to the system 2600, a second opening 3004 may be used to provide a fuel (e.g., natural gas) connection to the system 2600, and a pair of openings 3004 may be used to provide an electrical connection to and from the system 2600. In some embodiments, fluid conduits and/or electrical cables may extend through the openings 2004 into the interior of the housing 3001. Alternatively, the openings 2004 may include receptacles or sockets into which fluid conduits and/or electrical cables from the system 2600 may be plugged into.

FIG. 34D is a plan view of the interior of the housing 3001 of the docking station 3000 according to an embodiment of the present disclosure. The bottom surface of the housing 3001 may include openings through which underground utility connections (stubs) may enter the interior of the housing 3001. For example, the housing 3001 may include a fuel utility connection 3010, a water utility connection 3011, as well as at least one electrical connection 3012 (e.g., to a load and/or a grid). In some embodiments, the housing 3011 may include an internal divider 3009 between the mechanical (e.g., fuel and water) and the electrical connections.

Further embodiments are directed to large site electrochemical systems, such as fuel cell power systems and/or electrolyzer hydrogen generation systems, that include electrochemical modules mounted on skids 2601. In some embodiments, the plumbing and/or electrical connections to and between the skids of the system may be located above-ground, such as within above-ground cable trays. FIG. 35 is a schematic top view of a large site fuel cell system 3500 according to an embodiment of the present disclosure. The fuel cell system 3500 shown in FIG. 35 may be similar to the system as described above with reference to FIG. 19A1-19J2. In particular, the system may include multiple rows of power modules 12. Each row of power modules 12 may be electrically connected to a single above-described power conditioning module 18 which may include a DC to AC inverter and other electrical components. Each row of power modules 12 may also be fluidly connected to a single above-described fuel processing module 16 including components for pre-processing of fuel, such as adsorption beds (e.g., desulfurizer and/or other impurity adsorption beds). Alternatively, a single fuel processing module may be used for plural rows of power modules 12 as described above. Each of the rows of power modules 12 and the associated power conditioning module 18 and the associated fuel processing module 16 may be located on a skid 2601. In the embodiment shown in FIG. 35, each row of power modules 12, a power conditioning module 18 and an optional fuel processing module 16 may be located on a separate skid 2601. Pairs of adjacent skids 2601 including respective rows of power modules 12, a power conditioning module 18 and a fuel processing module 16 may extend parallel and adjacent to each another. In some embodiments, the pairs of adjacent skids 2601 may be connected together by one or more outriggers 2660 as described above with reference to FIGS. 33A and 33B. In other embodiments, each skid 2601 may include two or more rows of power modules 12, power conditioning modules 18 and optional fuel processing modules 16 located on the skid 2601.

The system 3500 may be configured in a plurality of blocks 3501, where each block 3501 may include a plurality of rows of power modules 12 (and associated fuel processing modules 16 and power conditioning modules 18). A single block 3501 of the system 3500 is enclosed by the dashed line in FIG. 35. Each block 3501 may include an above-described system power distribution unit 2604. Each of the system power distribution units 2604 may include at least one transformer XFMR. Each of the system power distribution units 2604 may include at least one system power distribution module (PDS) as described above with reference to FIG. 19A1-19J2. Each of the power distribution modules PDS may be electrically connected to power conditioning modules 18 of multiple rows the block 3501 and may provide power to a transformer XFMR of the block 3501. The transformer XFMR may provide a single power output for the block 3501. The power outputs from each block 3501 may be provided over an electrical connection (e.g., copper wire) to a common substation 3502 that may include a switchgear and/or other components that may couple the system to the grid and/or a load.

In some embodiments, the components of the system power distribution unit 2604, such as the at least one transformer XFMR and the at least one system power distribution module PDS may be located on one or more skids 2601. Alternatively, at least some of the components of the system power distribution unit 2604 may be located on a pad, such as a concrete pad. Each block 3501 of the system 3500 may optionally also include one or more above-described water distribution modules (WDMs), and one or more above-described telemetry modules (TCs). The water distribution modules (WDMs) and telemetry modules (TCs) of each block 3501 may be located on a separate skid 2601, as shown in FIG. 35.

The system 3500 shown in FIG. 35 includes seven blocks 3501 each including a plurality of rows of power modules 12 and a system power distribution unit 2604. Each row includes seven power modules 12 and may form a 300 kW Energy Server® fuel cell power generator (ES) as described above with reference to FIG. 21. Six of the seven blocks 3501 include ten rows of power modules 12 and may provide 3 MW of power. A seventh block 3501 (located on the lower left-hand corner of FIG. 35) includes seven rows of power modules 12. Thus, the system 3500 as a whole may provide 20.1 MW of power. It will be understood that various other configurations of the system are within the scope of the present disclosure, including variations in the number of blocks 3501 of the system, variations in the number of rows of power modules 12 per block 3501, variations in the number of power modules 12 per row, as well as variations in the layout(s) of the blocks 3501 and the rows of power modules 12 within each block 3501. In some embodiments, multiple skids 2601 including rows of power modules 12 may be vertically stacked in a modular “power tower” configuration on top of the pre-prepared (e.g., paved) install surface or yard.

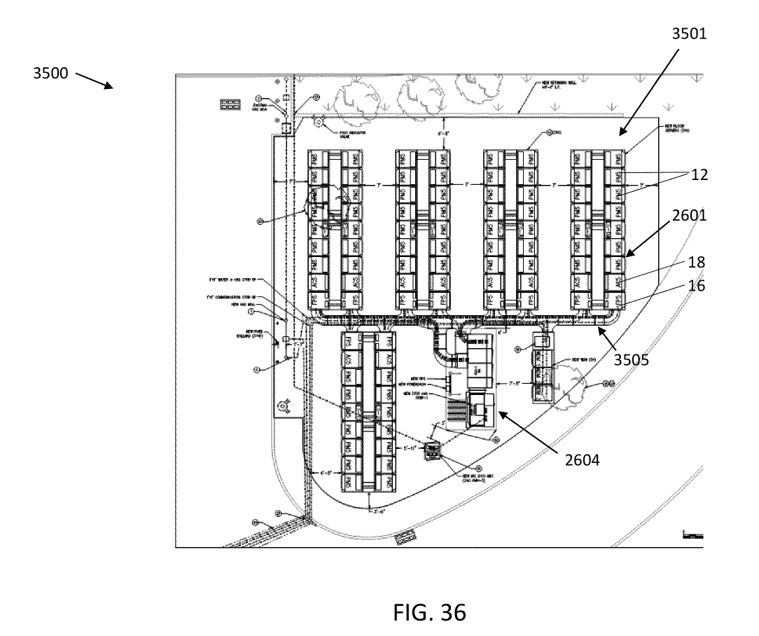

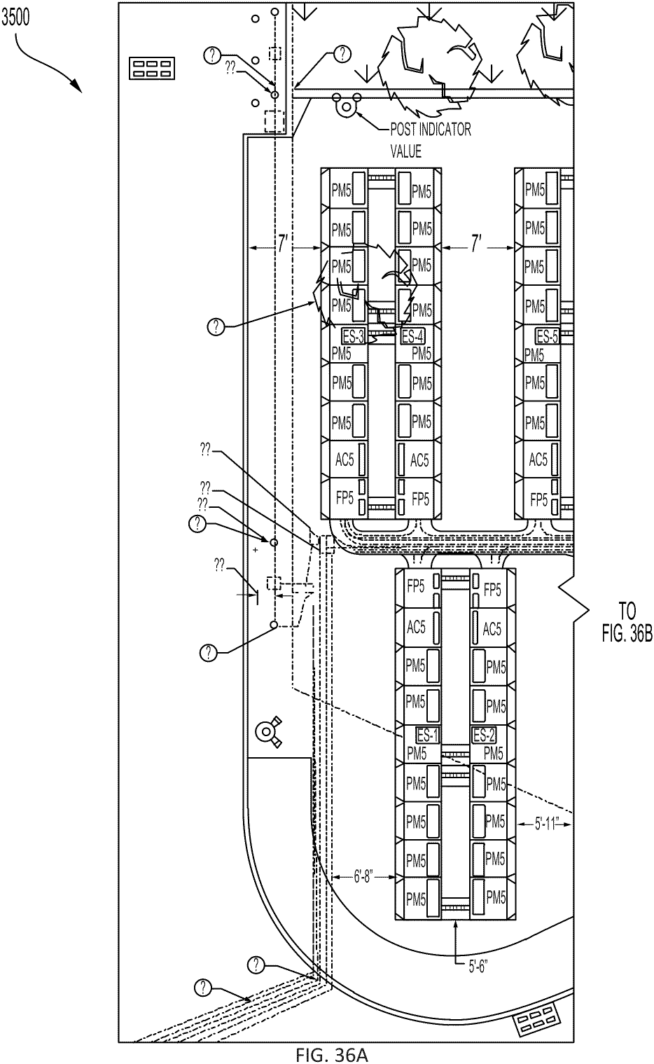

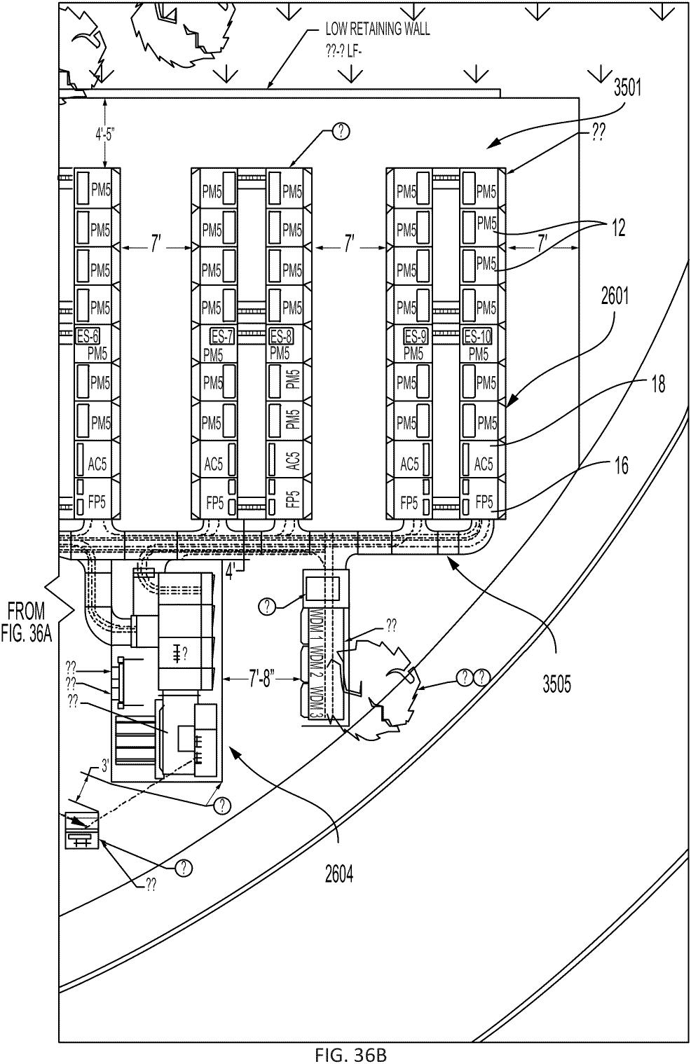

FIGS. 36A-B illustrate another embodiment of a fuel cell power system 3500 including a single 3 MW block 3501 of power modules 12 (labeled PM5 in FIGS. 36A-B) located on skids 2601. Referring to FIGS. 35 and 36A-B, in various embodiments, the system 3500 may include above-ground electrical connections between the rows of power modules 12 and a centralized system power distribution unit 2604. In particular, above-ground cable trays 3505 may extend between an end of each of the skids 2601 including the rows of power modules 12 and the centralized system power distribution unit 2604 of the block 3501. The above-ground cable trays 3505 may also extend to the skid(s) 2601 including ancillary equipment, such as water distribution modules (WDM) and/or a telemetry module (TC). Electrical connections (e.g., copper wires) between the power conditioning modules 18 (labeled AC5 in FIGS. 36A-B) in each row of power modules 12 and the centralized system power distribution unit 2604 may be located in cable trays 3505 that may abut an end of each of the skids 2601. In some embodiments, above-ground plumbing connections (e.g., gas and/or water conduits) between the skids 2601 may be mounted below the cable trays 3505. Providing above-ground electrical and/or plumbing connections to the skid-mounted modules may minimize the amount of ground penetration (e.g., trenches) needed during system installation, which may significantly reduce system installation time and cost.

In some embodiments, installation of a fuel cell system 3500 such as shown in FIGS. 35 and 36A-B may include preparing a site surface (e.g., a “yard”), such as by paving the entire system installation area with asphalt to create a “parking lot″-like surface for installation of the system components. Alternatively, the installation surface may be prepared using compacted aggregate or permeable pavers where appropriate. Saw cuts and trenches may then be formed through the pre-prepared installation surface where necessary for interconnections, such as for connections to underground utility lines. Skids 2601 including system components (e.g., electrochemical modules) mounted thereon may then be placed in appropriate locations over the pre-prepared installation surface. As discussed above, the skids 2601 and the system components on the skids 2601 may be fully factory assembled and tested prior to deployment to the installation site, which may enable significantly faster and cheaper installations.

In some embodiments, the fuel cell system 3500 may include a central desulfurization system 1600 as described above with reference to FIG. 19A1-19J2. In some embodiments, the central desulfurization system 1600 may be located on a skid 1601. Alternatively, the central desulfurization system may be located on a pad, such as a concrete pad. Each block 3501 of the system 3500 may include at least one above-described gas and water distribution module (GDM) that may be fluidly coupled to the central desulfurization system 1600 via a suitable fluid conduit. In some embodiments, the fluid conduit may be located above ground, such as mounted to a cable tray 3505 as discussed above. Alternatively, the fluid conduit may be located within a trench, such as a precast concrete trench as shown in FIGS. 20D and 20E. Each GDM within a block 3501 may be fluidly coupled to multiple rows of fuel cell power modules 12. The use of a central desulfurization system 1600 and one or more GDMs may obviate the need for fuel processing modules 16 and/or water distribution modules WDMs within the system 3500. In various embodiments, the one or more GDMs of the system 3500 may be located on a skid 2601, which may be a skid 2601 including one or more rows of fuel cell power modules 12 and associated power conditioning modules 18, or on a separate skid 2601 that does not include a row of power modules 12 and an associated power conditioning module 18.

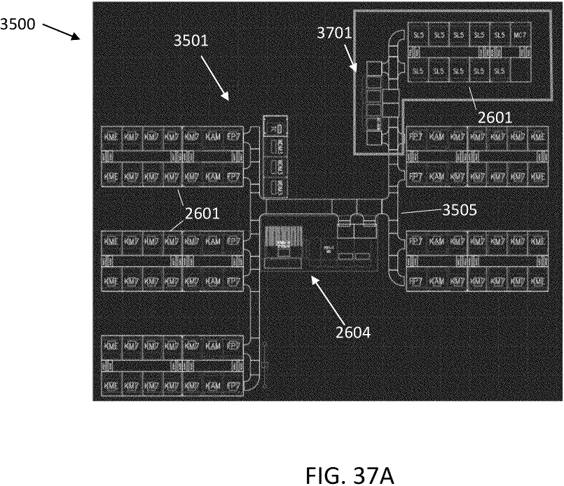

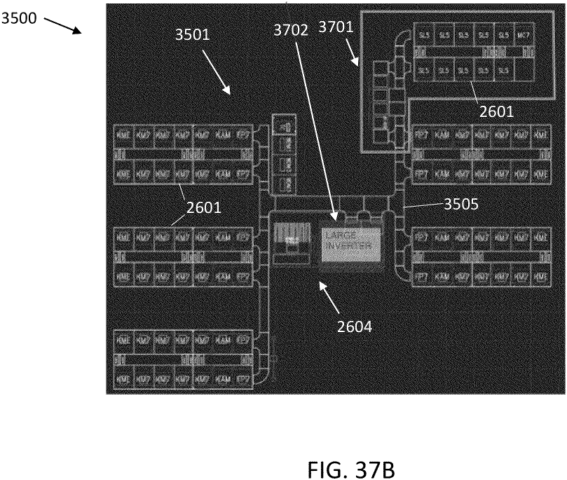

FIG. 37A illustrates another embodiment of a fuel cell power system 3500 including a primary block 3501 of rows of power modules coupled to an above-described system power distribution unit 2604 and an integrated microgrid system 3701. The integrated microgrid system 3701 may be configured to provide a stable, grid-independent power supply, such as a DC power supply, for localized use. The primary block 3501 of rows of power modules and the components of the integrated microgrid system 3701 may each be located on skids 2601 as described above. Cable trays 3505 may extend between the rows of power modules of the primary block 3501 and to both the system power distribution unit 2604 and to the integrated microgrid system 3701. The cable trays 3505 may have a stacked configuration such that a first set of electrical connections (e.g., copper wires) located in a first portion (e.g., housing) of the cable tray may be configured to carry AC power between the rows of power modules and the system power distribution unit 2604, and a second set of electrical connections (e.g., copper wires) located in a second portion (e.g., housing) of the cable tray that is vertically stacked above or below the first portion of the cable tray may be configured to carry DC power between the rows of power modules and the integrated microgrid system 3701. Power from the rows of power modules may be selectively fed to the system power distribution unit 2604 and/or to the integrated microgrid system 3701 depending on the current power requirements.

FIG. 37B illustrates another embodiment of a fuel cell power system 3500 including a primary block 3501 of rows of power modules and an integrated microgrid system 3701 that includes alternative configuration of electronics modules 3702 in the system power distribution unit 2604. The alternative configuration of electronics modules 3702 may be similar to the configuration described above with reference to FIG. 23. In particular, the alternative configuration of electronics modules 3702 may include separate cabinets (i.e., housings) with each cabinet being fully populated for a dedicated purpose. One module may receive DC power from the power modules of the primary block 3501 and may be configured couple power from multiple rows of power modules onto a common DC bus. This module may include a fully rated interconnection of the collected output DC as an optional means to extend the DC bus to an adjacent system, such as the integrated microgrid system 3701 shown in FIG. 37B. One or more additional modules may form a single monolithic inverter unit (i.e., a “large inverter”) having large ampacity DC input and AC output. This may help reduce cost by eliminating the smaller inverter units and making a single monolithic inverter for implementation in the central system power distribution unit 2604. The large inverter may convert DC power from the power modules to AC power and provide an AC power output to a transformer of the central power distribution unit 2604. An additional module may contain start-up and safety equipment for the fuel cell power modules, and may also serve as the collected output terminals for the system and a location provided for external conduit entry.

In the embodiment shown in FIG. 37B, the cable trays 3505 may be used to feed DC power from the rows of power modules of the primary block 3501 to the electronics modules 3702 in the system power distribution unit 2604, and from the electronics modules 3702 in the system power distribution unit 2604 to the integrated microgrid system 3701.

Additional embodiments may relate to electrochemical systems, such as fuel cell power systems 3500, that incorporate carbon capture technology. In particular, additional plumbing may be fluidly coupled to the rows of power modules located on skids 2601 for receiving a carbon-containing exhaust stream, which may include anode exhaust from the fuel cell stacks located in the hot boxes of the power modules 12. For example, a carbon-containing exhaust stream may include an anode tail gas oxidizer exhaust stream. The additional plumbing may be coupled to additional modules and/or processing devices that may be configured to process the exhaust stream such that carbon-containing constituents of the exhaust (e.g., CO₂, CO, etc.) may be either recycled for use by the system or may be separated from the exhaust stream for storage, sequestration, and/or use in other chemical or industrial processes, such as beverage carbonation. The additional modules and/or processing devices may be co-located with the system 3500 (e.g., on skids 2601 and/or on one or more concrete pads), or may be located remotely from the system 3500. In some embodiments, the additional plumbing for capture of carbon-containing exhaust stream(s) may include above-ground fluid conduits fluidly coupled to the power modules within each of the rows of power modules. In some embodiments, the above-ground fluid conduits may be mounted to the cable trays 3505.

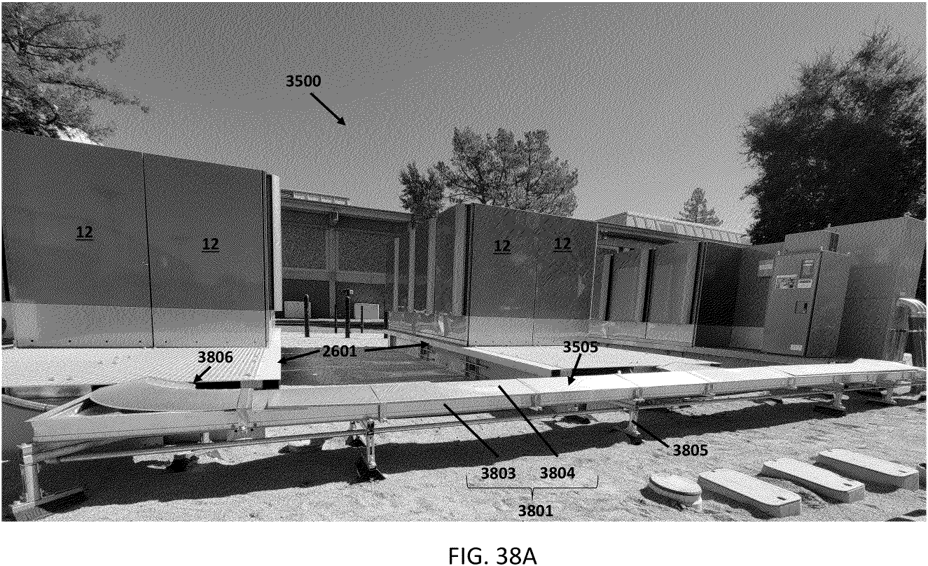

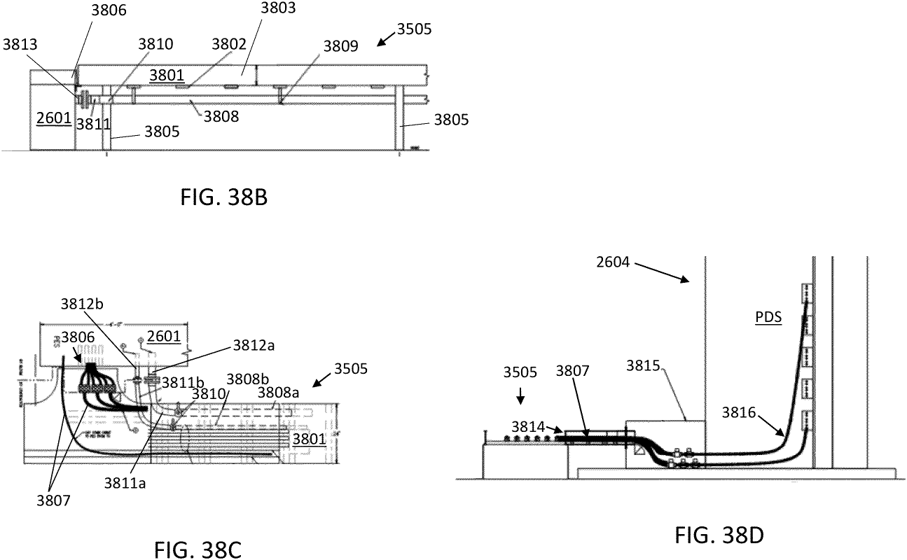

FIG. 38A is a photograph illustrating a portion of a fuel cell power system 3500 including a plurality of skids 2601 having fuel cell power modules 12 located thereon and a cable tray 3505 extending between the skids 2601. FIG. 38B is a side elevation view of a cable tray 3505 abutting an end of a skid 2601. FIG. 38C is a top view of a cable tray 3505 abutting an end of a skid 2601. FIG. 38D is a side elevation view of a cable tray 3505 abutting a system power distribution unit 2604 of the fuel cell power system 3500.

Referring to FIGS. 38A-38D, the cable tray 3505 may include a housing 3801 formed by a bottom surface 3802, a pair of sidewalls 3803 and a cover 3804. The housing 3801 may be raised above ground by a plurality of vertical supports 3805. The housing 3801 may have an open end that may abut an opening 3806 in an end of the skid 2601. A plurality of electrical connections 3807 (i.e., cables) for carrying power and communications (e.g., data) to and from the skid 2601 may be located within the housing 3801 of the cable tray 3505. The electrical connections 3807 may extend from the housing 3801 of the cable tray 3505 through the opening 3806 into the skid 2601, where the electrical connections 3807 may be routed to the appropriate modules located on the skid 2601.

Referring again to FIGS. 38A-38D, plumbing conduits 3808a, 3808b for water and gas may be mounted below the housing 3801 of the cable tray 3505 via suitable attachment mechanisms, such as strut clamps 3809 as shown in FIG. 38B. The plumbing conduits 3808a and 3808b may be supported above ground level. A valve 3810, such as a ball valve, may be located on the cable tray 3505 at the ends of each of the plumbing conduits 3808a, 3808b. Flexible cables 3811a, 3811b may extend between the valves 3810 and respective fluid connections 3812a, 3812b on the skid 2601. Additional plumbing conduits 3813a, 3813b on the skid 2601 may route water and gas to the appropriate modules located on the skid 2601.

FIG. 38D illustrates the interface between the cable tray 3505 and a component of the system power distribution unit 2604, such as an above-described system power distribution module (PDS). The electrical connections 3807 from the housing 3801 of the cable tray 3505 may exit the cable tray 3505 through an opening 3814 into an enclosure 3815, which may be a junction box as shown in FIG. 38D. The electrical connections 3807 from the cable tray 3505 may be connected to a second set of electrical connections 3816 that may be routed into the appropriate location in the PDS or other electrical equipment in the system power distribution unit 2604. Alternatively, the enclosure 3815 may be an electrical pullbox such that the electrical connections 3807 from the cable tray 3505 may be routed through the enclosure 3815 and into the appropriate equipment in the system power distribution unit 2604.

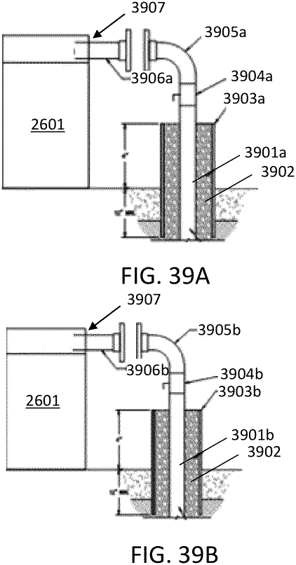

FIGS. 39A and 39B illustrate connections between underground gas and water utility lines and a skid 2601 of a fuel cell power system 3500 according to various embodiments of the present disclosure. In some embodiments, the fuel cell power system 3500 may include a limited number of connections to gas and water utility lines, such as one set of gas and water connections per system 3500, or one set of gas and water connections per block 3501 in the case of a multi-block system as shown in FIG. 35. The gas and water plumbing connections between the skids 2601 of a respective system 3500 and/or block 3501 may be made via cable trays 3505 as described above with reference to FIGS. 38A-38D. This may minimize the amount of ground penetration and/or trenching needed for system installation, which may help to reduce installation time and cost. Referring to FIG. 39A, a gas conduit 3901a may extend vertically from an underground gas utility line (not shown in FIG. 39A) to a location above ground level. The conduit 3901a may optionally be encased in a suitable material 3902, such as cement, and may be surrounded by an outer tubular member 3903a, such as a metal sleeve. A valve 3904a, such as a ball valve, may be located at the end of the gas conduit 3901a. A flexible conduit 3905a may extend between the valve 3904a and a second gas conduit 3906a that extends through an opening 3907 into the skid 2601. Referring to FIG. 39B, a water conduit 3901b may similarly extend vertically from an underground water utility line (not shown in FIG. 39B) and may terminate in a valve 3904b, such as a ball valve. A flexible conduit 3905b may extend between the valve 3904b and a second water conduit 3906b that extends through an opening 3907 into the skid 2601. The conduit 3901b may also optionally be encased in a suitable material 3902, such as cement, and may be surrounded by an outer tubular member 3903b, such as a metal sleeve.

In an alternative embodiments, the gas conduit 3901a and the water conduit 3901b may be coupled to respective second gas conduit 3906a and second water conduit 3906b that are located on a cable tray 3505 instead of a skid 2601, such that gas and water may be distributed to each of the skids 2601 of the system 3500 and/or block 3501 via the cable tray 3505.

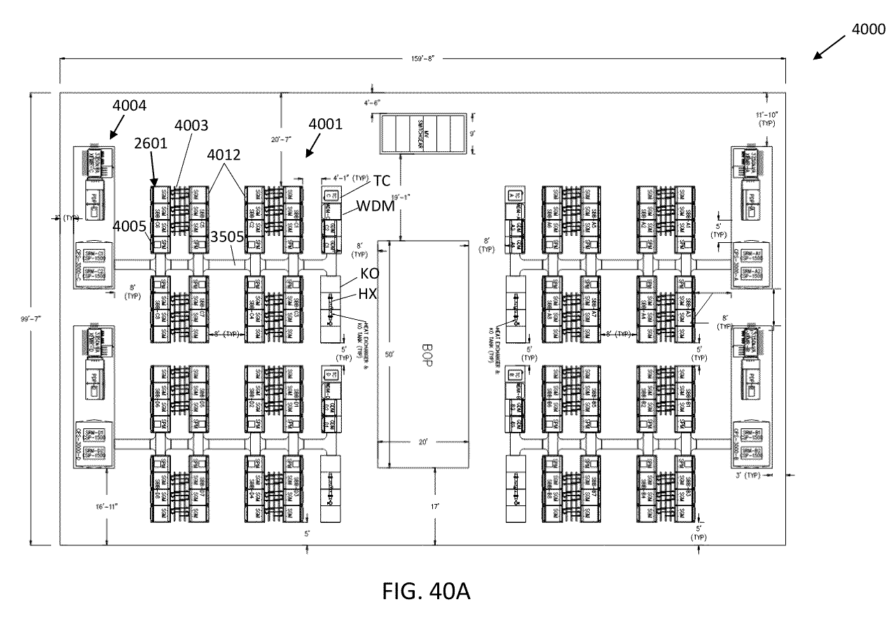

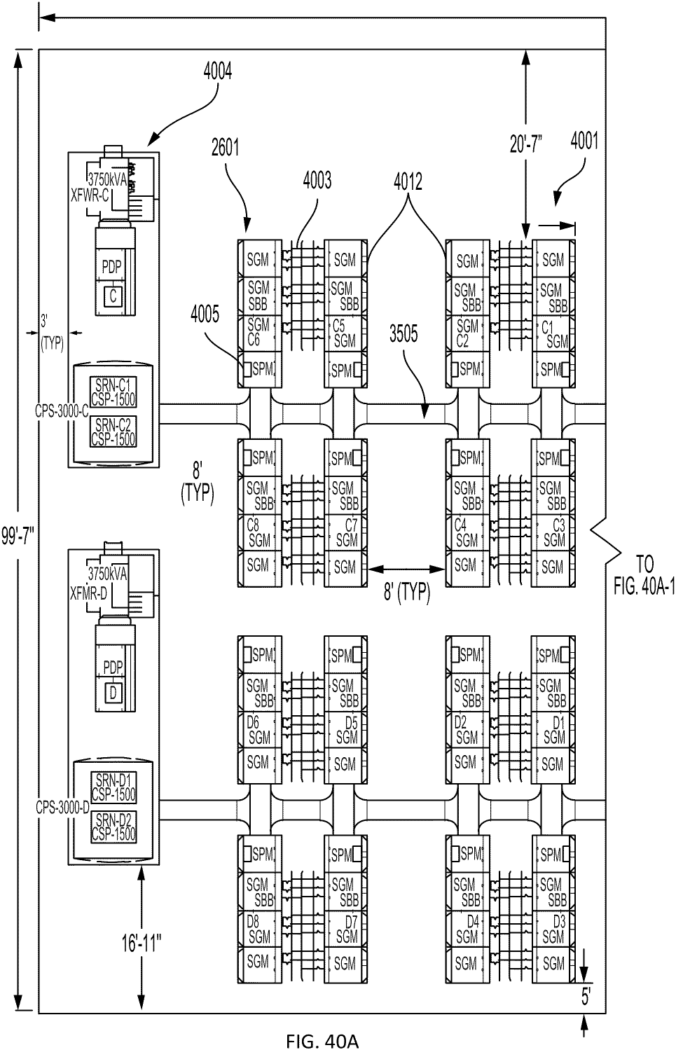

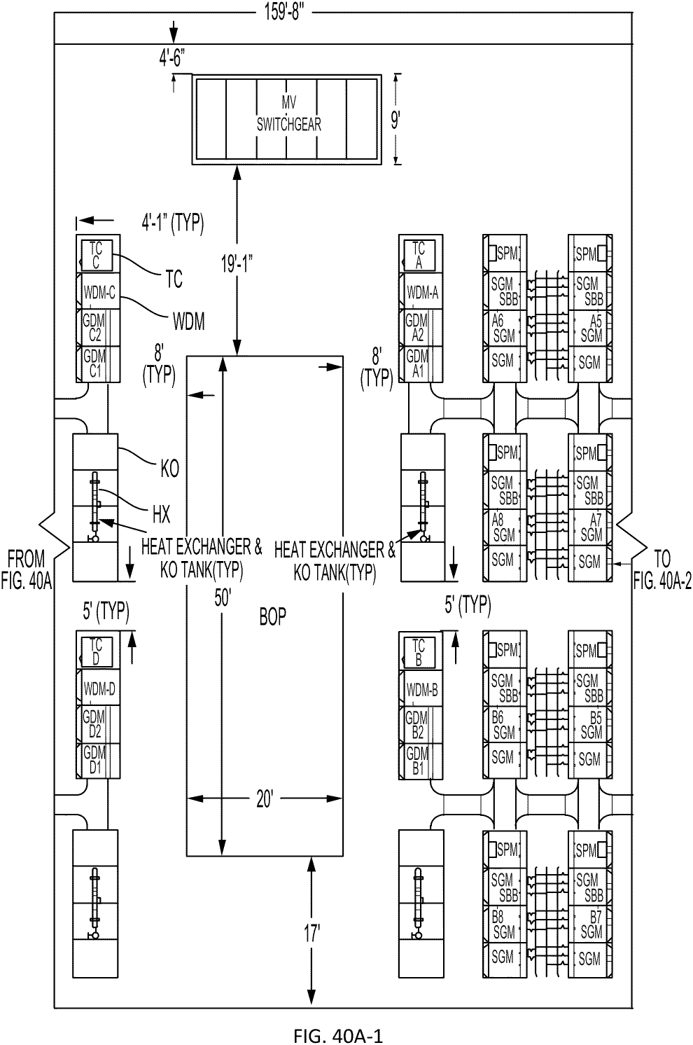

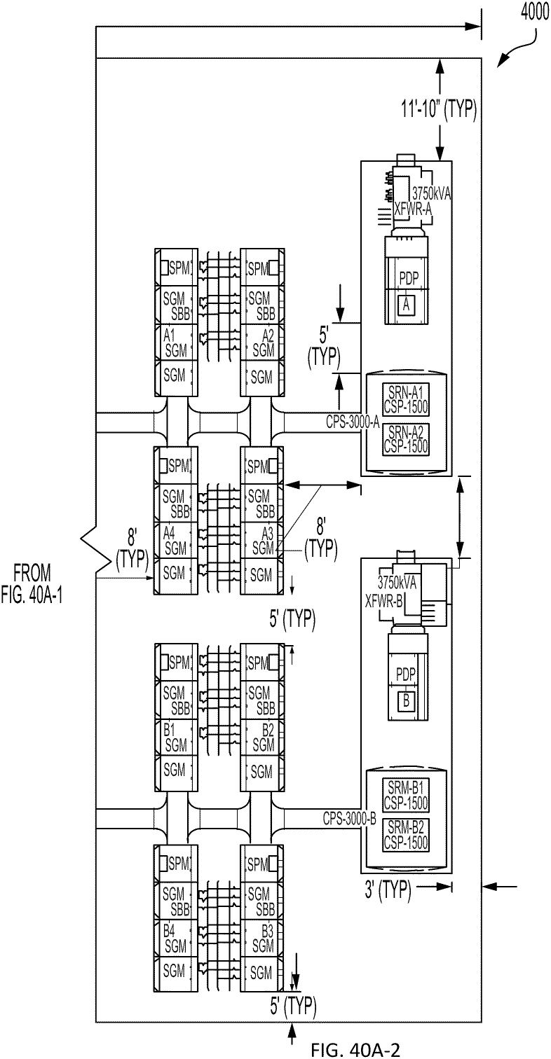

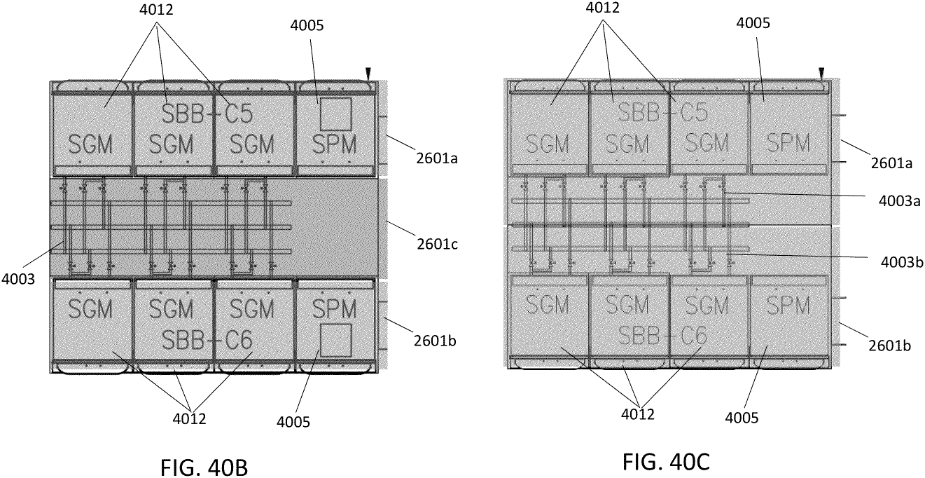

FIG. 40A-A2 illustrates a large site hydrogen-generation system 4000 including a plurality of above-described electrolyzer modules 4012 located on skids 2601. The system 4000 may include one or more blocks 4001 including multiple rows of electrolyzer modules 4012 (e.g., SOEC modules) disposed on skids 2601. An above-ground cable tray 3505 as described above may extend between the rows of electrolyzer modules 4012 in each block 4001. Electrical connections to the rows of electrolyzer modules 4012 may be located within a housing of the cable tray 3505 as described above. Plumbing connections (e.g., water and hydrogen plumbing connections) to and from the rows of electrolyzer modules 4012 may optionally be mounted below the housing of the cable tray 3505. In the embodiment shown in FIG. 40A-A2, each block 4001 may include rows of electrolyzer modules 4012 arranged in two columns of rows of electrolyzer modules 4012 with a cable tray 3505 extending between the columns and abutting the ends of each row of electrolyzer modules 4012. Within each column of electrolyzer modules 4012, adjacent pairs of rows of electrolyzer modules 4012 may be connected by plumbing interconnections 4003. As discussed in further detail below, the adjacent pairs of rows of electrolyzer modules 4012 may be mounted on a common skid 2601, or may be mounted on separate skids 2601.

Each block 4001 may also include ancillary equipment, such as a system power distribution unit 4004 that may be configured to provide electrical power to the rows of electrolyzer modules 4012 to support hydrogen generation via electrolysis of water (i.e., steam). The system power distribution unit 4004 may be electrically coupled to a separate power distribution module 4005 within each row by electrical connections located within the housing of the cable tray 3505. The system power distribution unit 4004 may be located on a separate skid, or may be located on a separate pad (e.g., a concrete pad). Each block 4001 may include additional ancillary equipment for supporting the hydrogen generation process, such as a water distribution module (WDM), a telemetry module (TC), one or more heat exchangers (HX) and/or water knockout tanks (KO). The additional ancillary equipment may be located on separate skids 2601 that may be coupled to the rows of electrolyzer modules 4012 by the cable tray 3505. Balance of plant (BOP) equipment may be located between the blocks 4001.

FIG. 40B is a top schematic view of a pair of adjacent rows of electrolyzer modules 4012 according to an embodiment of the present disclosure. In this embodiment, each of the rows of electrolyzer modules 4012 is located on a separate skid 2601a, 2601b. A middle skid 2601c containing plumbing interconnections between 4003 the respective rows of electrolyzer modules 4012 is located between skids 2601a and 2601b. FIG. 40C is a top schematic view of a pair of adjacent rows of electrolyzer modules 4012 according to an alternative embodiment. In this embodiment, the rows of electrolyzer modules 4012 and portions of the plumbing interconnections 4003a, 4003b are located on respective skids 2601a, 2601b that are disposed adjacent to one another in a back-to-back configuration. The two portions of the plumbing interconnections 4003a, 40043 may be connected during installation of the skids 2601a and 2601b. In both the embodiments of FIGS. 40B and 40C, the skids 2601a, 2601b containing the rows of electrolyzer modules 4012 and the plumbing interconnections 4003 between the rows may be built and tested at the factory and then shipped as modular units that can be easily assembled on-site.

Additional embodiments include the use of close out panels, which may enhance skid aesthetics. The panels may be located on the sides of the support pedestals 2609 to shield the area under the deck 2603 from view.

Additional embodiments include use of a skid-mounted fuel cell power system and/or electrolyzer system 2600 for marine applications. A skid-mounted system may enable rapid deployment and simple integration into marine vessels and/or for marine applications. Additional supporting equipment may be integrated onto the skid. Thus, the skid-mounted system may be transported to and then mounted on a marine vessel (e.g., ship) as a single unit.

Additional embodiments include use of a skid-mounted fuel cell power system and/or electrolyzer system 2600 for transportation applications. A skid-mounted system may enable rapid deployment and simple integration into ground transportation vehicles and/or transportation applications. Additional supporting equipment may be integrated onto the skid. Thus, the skid-mounted system may be transported to and then mounted on transportation vehicle (e.g., train) as a single unit.

Additional embodiments include skid-mounted fuel cell power systems 2600 utilizing a biogas fuel source. Additional supporting equipment may be integrated onto the skid.

Additional embodiments include skid-mounted electrolyzer hydrogen generation systems 2600. Additional supporting equipment may be integrated onto the skid.

Additional embodiments include skid-mounted fuel cell power systems 2600 utilizing a hydrogen (H₂) fuel source. In some embodiments, a hydrogen-fueled fuel cell power system 2600 may utilize solid oxide fuel cells (SOFCs). Additional supporting equipment may be integrated onto the skid.

Additional embodiments include skid-mounted fuel cell power and/or electrolyzer systems 2600 for utility scale applications. A skid-mounted fuel cell power systems 2600 may be utilized for utility scale applications for reduced cost and speed of deployment/installation.

Additional embodiments include skid-mounted fuel cell power and/or electrolyzer systems 2600 having different skid 2601 configurations. Skids 2601 may have classic or modular configurations. With a modular configuration, various modules, such as power modules, fuel processing modules, power conditioning modules, electrolyzer modules, etc., can be arranged back-to-back, in a linear configuration, in an inside configuration (e.g., power modules and/or electrolyzer modules surrounded on two sides by supporting equipment), an outside configuration (e.g., power modules and/or electrolyzer modules located on an end of the skid), or in any other suitable configuration.

Additional embodiments include rigging for skid-mounted a fuel cell power and/or electrolyzer systems 2600. In various embodiments, an entire skid-mounted system 2600 may be forklifted with fork pockets 2611 and/or lifted via crane lift points 2613.

Additional embodiments include skid-mounted fuel cell power systems 2600 having an on-board fuel injector/regulator apparatus 2620. An on-board fuel injector/regulator apparatus 2620 may allow for quick and easier installation as the fuel injector/regulator apparatus 2620 does not have to be set during construction.

Additional embodiments include skid-mounted fuel cell power and/or electrolyzer systems 2600 having an on-board disconnect and/or backup power supply (BPS) system 2612. An on-board disconnect/BPS system 2612 may allow for quick and easier installation as a disconnect/BPS system 2612 does not have to be set during construction.

Additional embodiments include skid-mounted fuel cell power and/or electrolyzer systems 2600 having an EDS system that may combine power distribution, telemetry and disconnect/BPS functionality. This may allow for further reduction in skid 2601 footprint and may enable quicker and cheaper installation.

Additional embodiments include quick deploy applications. A skid-mounted fuel cell power and/or electrolyzer system 2600 may be used for quick deployments for temporary or emergency power solutions. Additional embodiments include temporary applications. A skid-mounted fuel cell power and/or electrolyzer systems 2600 may be deployed as a temporary power and/or hydrogen generation solution and may be moved from site to site or facility to facility easily as the system may be completely contained in a single skid assembly. Additional embodiments include permanent applications. A skid-mounted fuel cell power and/or electrolyzer systems 2600 may be a permanent installation and may remain in place for a prolonged time period, such as at least six months, one year, or more, including 5, 10, 15, or 20 years, such as between 0.5 and 20 years, or longer.

Fuel cell systems of the embodiments of the present disclosure are designed to reduce greenhouse gas emissions and have a positive impact on the climate.

The arrangements of the fuel cell and/or electrolyzer system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein.

Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present disclosure. Any one or more features of any embodiment may be used in any combination with any one or more other features of one or more other embodiments.

1. An electrochemical system, comprising:
a skid comprising a deck and at least one pedestal connected to and supporting the deck; and
a plurality of modules comprising at least one electrochemical module located on the deck of the skid.

2. The electrochemical system of claim 1, wherein the electrochemical system comprises a fuel cell power generating system and the at least one electrochemical module comprises at least one fuel cell power module.

3. The electrochemical system of claim 2, wherein the plurality of modules comprises:
a plurality of the fuel cell power modules, each containing a hot box;
a fuel processing module fluidly coupled to the plurality of fuel cell power modules; and
a power conditioning module electrically coupled to the plurality of fuel cell modules.

4. The electrochemical system of claim 2, wherein the plurality of fuel cell power modules comprise multiple rows of fuel cell power modules extending along a length of the skid, and the fuel processing module and the power conditioning module are located adjacent to the multiple rows of fuel cell power modules.

5. The electrochemical system of claim 4, further comprising ancillary equipment located on the skid, wherein the ancillary equipment comprises at least one of:
a water distribution module;
a step load module;
a telemetry cabinet;
a power distribution system;
a disconnect system;
a backup power supply;
an EDS unit; or
a microgrid inverter unit.

6. The electrochemical system of claim 5, wherein the fuel cell power modules are located on a first side of the skid, the ancillary equipment is located on a second side of the skid, and the fuel processing module and the power conditioning module are located between the fuel cell power modules and the ancillary equipment.

7. The electrochemical system of claim 6, wherein the ancillary equipment includes a disconnect system mounted to a side surface of the skid.

8. The electrochemical system of claim 3, further comprising a fuel injector/regulator apparatus mounted to the skid.

9. The electrochemical system of claim 8, further comprising one or more bracket members extending between the skid and the fuel injector/regulator apparatus and supporting the fuel injector/regulator apparatus above ground-level and laterally-spaced away from the modules located on the skid.

10. The electrochemical system of claim 3, wherein the system comprises multiple skids, each skid including a plurality of fuel cell power modules, a fuel processing module, and a power conditioning module located on the deck of the respective skid, and the system further comprises inter-skid connections configured to share at least one of water, fuel and/or power between the respective skids.

11. The electrochemical system of claim 10, further comprising:
a fuel injector/regulator apparatus mounted to a first skid; and
a splitter coupled to the fuel injector/regulator apparatus and configured to direct a first portion of the fuel flow from an outlet of the fuel injector/regulator apparatus to the first skid and a second portion of the fuel flow from the outlet of the fuel injector/regulator apparatus to a second skid.

12. The electrochemical system of claim 1, wherein the skid comprises at least one fork pocket configured to receive forklift prongs for at least one of transport, installation or removal of the system.

13. The electrochemical system of claim 1, wherein the skid comprises lift points configured to facilitate engagement to a crane for at least one of lifting, lowering or moving the system.

14. The electrochemical system of claim 1, further comprising:
at least one L-bracket mounted to the skid; and
a concrete anchor or an earth anchor extending through the L-bracket to anchor the system to the ground.

15. The electrochemical system of claim 1, further comprising:
a Z-bracket including a first portion having a first surface configured to contact a surface of the skid and a second portion having a second surface contacting the ground; and
an anchor extending through the second portion of the Z-bracket and into the ground such that the first surface of the first portion of the Z-bracket clamps against the surface of the skid.

16. The electrochemical system of claim 1, further comprising a second skid, wherein the skid and the second skid comprise a pair of skids, wherein at least one outrigger is mounted to and extends between the pair of skids.

17. The electrochemical system of claim 1, further comprising:
a docking station comprising a housing containing at least one utility stub within the interior of the housing, and at least one opening in a surface of the housing; and
at least one cable or fluid conduit coupled to the at least one utility stub contained within the interior of the housing and extending from the opening in the surface of the housing to the skid.

18. The electrochemical system of claim 2, wherein the plurality of modules comprises:
a plurality of the fuel cell power modules, each containing a hot box; and
a power conditioning module electrically coupled to the plurality of fuel cell modules.

19. The electrochemical system of claim 18, wherein the skid comprises one of multiple skids that each include a row of fuel cell power modules and a power conditioning module on the deck of a respective one of the multiple skids.

20. The electrochemical system of claim 19, wherein each of the multiple skids further comprises a fuel processing module.

21. The electrochemical system of claim 19, wherein the electrochemical system further comprises a centralized desulfurization unit and at least one gas and water distribution module (GDM) fluidly coupled to the centralized desulfurization unit, wherein the at least one GDM is fluidly coupled to the multiple skids.

22. The electrochemical system of claim 19, wherein the electrochemical system further comprises a system power distribution unit electrically coupled to the multiple skids.

23. The electrochemical system of claim 22, wherein the system power distribution unit comprises at least one transformer.

24. The electrochemical system of claim 22, further comprising an above-ground cable tray extending between the system power distribution unit and the multiple skids, the cable tray comprising a housing containing electrical connections between the multiple skids and the system power distribution unit.

25. The electrochemical system of claim 24, wherein at least one above-ground plumbing connection to the multiple skids is mounted to the cable tray.

26. The electrochemical system of claim 25, wherein the at least one above-ground plumbing connection comprises at least one of a water conduit, a fuel conduit, or a conduit for removal of carbon-containing exhaust from the fuel cell power modules.

27. The electrochemical system of claim 24, wherein the electrochemical system further comprises a microgrid system that is coupled to the system power distribution unit and the multiple skids by the above-ground cable tray.

28. The electrochemical system of claim 27, wherein a first housing of the cable tray includes AC power connections between the multiple skids, and a second housing of the cable tray that is vertically stacked above or below the first housing of the cable tray includes DC power connections between the rows of power modules and the microgrid system.

29. The electrochemical system of claim 27, wherein the cable tray further comprises:
first DC power connections between the multiple skids and a centralized inverter of the system power distribution unit, and
second DC power connections between the system power distribution unit and the microgrid system.

30. The electrochemical system of claim 19, wherein the multiple skids are mounted directly onto a continuous surface comprising at least one of asphalt, compacted aggregate or permeable pavers.

31. The electrochemical system of claim 1, wherein the electrochemical system comprises a hydrogen generation system, and the at least one electrochemical module comprises at least one electrolyzer module.

32. The electrochemical system of claim 31, wherein the skid comprises one of multiple skids that each include a plurality of electrolyzer modules on the deck of the respective skid.

33. The electrochemical system of claim 32, wherein the multiple skids comprise pairs of adjacent skids, wherein plumbing interconnections extend between the electrolyzer modules on the pairs of adjacent skids.

34. The electrochemical system of claim 33, wherein the plumbing interconnections are located on separate plumbing skids located between the pairs of adjacent skids including the plurality of electrolyzer modules.

35. The electrochemical system of claim 33, wherein the pairs of adjacent skids abut one another, and a first portion of the plumbing interconnections is located on a first skid of the pair of adjacent skids and a second portion of the plumbing interconnections is located on a second skid of the pair of adjacent skids.

36. The electrochemical system of claim 31, further comprising an above-ground cable tray extending between a system power distribution unit and the multiple skids, the cable tray comprising a housing containing electrical connections between the system power distribution unit and the multiple skids.

37. A method of installing an electrochemical system, comprising:
providing a plurality of modules comprising at least one electrochemical module on a skid;
transporting the skid with the plurality of modules disposed thereon to an installation site; and
providing at least one utility hook-up to the electrochemical system at the installation site.

38. The method of claim 37, further comprising providing all inter-module plumbing and wiring connections for the plurality of modules on the skid prior to transporting the skid to the installation site.

39. The method of claim 37, further comprising securing the skid on the installation site using at least one of a shim, an outrigger, an L-bracket, a Z-bracket, a concrete anchor or an earth anchor.

40. The method of claim 37, further comprising:
preparing a surface comprising at least one of asphalt, compacted aggregate or permeable pavers at the installation site; and
placing multiple skids each including a plurality of modules disposed thereon onto the surface.

41. The method of claim 40, wherein providing the at least one utility hook-up comprises coupling at least one skid to underground gas and water utility lines via flexible conduits.

42. The method of claim 40, further comprising installing an above-ground cable tray on the surface extending between the multiple skids, wherein electrical connections to each skid are made via the cable tray.

43. The method of claim 40, wherein at least one plumbing conduit is mounted to the cable tray, wherein a plumbing connection to at least one of the skids is made via the at least one plumbing conduit mounted to the cable tray.

44. A docking station for a skid-mounted electrochemical system, comprising:
a housing containing at least one utility stub within an interior of the housing, and at least one opening in a surface of the housing through which at least one utility connection between the at least one utility stub and a skid-mounted electrochemical system may be made.

45. The docking station of claim 44, wherein the at least one opening is located in a side surface of the housing, and the housing includes at least one second opening in a bottom surface of the housing, wherein the utility stubs enter the interior of the housing through the at least one second opening from underground.

46. The docking station of claim 45, wherein the utility stubs comprise utility stubs for fuel, water and electricity, and the housing comprises an interior divider between the utility stubs for fuel and water and at least one utility stub for electricity.

47. The docking station of claim 45, further comprising a chase coupled to the side surface of the housing and enclosing at least one conduit or cable extending between the at least one opening in the side surface of the housing and a skid-mounted electrochemical system.
